(19) United States
(12) Patent Application Publication
(10) Pub. No.: US 2020/0030737 A1
(43) Pub. Date: Jan. 30, 2020

(54) WATER CAPTURE METHODS, DEVICES, AND COMPOUNDS

(71) Applicant: University of Limerick, Limerick (IE)

(72) Inventors: Michael John Zaworotko, Parteen (IE); Victoria Gascón Pérez, Limerick (IE); Andrey Alexandrovich Bezrukov, Limerick (IE); Daniel J. O'Hearn, Limerick (IE); Shiqiang Wang, Limerick (IE)

(21) Appl. No.: 16/523,206

(22) Filed: Jul. 26, 2019

(30) Foreign Application Priority Data
Jul. 26, 2018 (EP) 18185922.4

(51) Int. Cl. B01D 53/02; C07F 1/08

(52) U.S. Cl. CPC B01D 53/02; C07F 1/08; B01D 2253/30; B01D 2253/204; B01D 2257/80

(57) ABSTRACT

A method of capturing water from a gaseous composition comprising water vapour (e.g., air), the method comprising:
(a) providing a metal-organic material; and
(b) contacting the metal-organic material with water and/or water vapour;
   wherein upon contact with water and/or water vapour the material switches from a first state to a second state wherein the second state is able to retain a higher amount of water than the first state.

### CROSS-REFERENCE TO RELATED APPLICATIONS

The present application claims the priority benefit of European Application No. 18185922.4, filed Jul. 26, 2018. This application is hereby incorporated by reference in its entirety for all purposes.

### FIELD

Some embodiments disclosed herein relate to compounds and devices for harvesting atmospheric water vapour. Some embodiments pertain to methods for making and using those devices and compounds.

### BACKGROUND

As the global population grows, there is an increasing need to balance all of the competing commercial demands on water resources so that communities have enough for their needs. According to the United Nations, 2.1 billion people lack access to safely managed drinking water services.

Large amounts of energy are expended on a daily basis in industrial processes and in residential and commercial buildings to adjust the humidity of ambient air by removing some or all of the water from the air. A more efficient process for accomplishing water capture could yield significant energy savings across the globe and help diminish global pollution.

### SUMMARY

Disclosed herein are compounds, compositions, devices, and methods of capturing water from gaseous sources.

Some embodiments pertain to a method of capturing water from a gaseous composition comprising water vapour. In some embodiments, the gaseous composition is air. In some embodiments, the method comprises providing a metal-organic material. In some embodiments, the method comprises contacting the metal-organic material with a gas (e.g., air or other gases that may include water and/or water vapour). In some embodiments, the method comprises contacting the metal-organic material with water and/or water vapour. In some embodiments, upon contact with water and/or water vapour the material switches from a first state to a second state wherein the second state is able to retain a higher amount of water than the first state.

Some embodiments pertain to the use of a metal-organic material to capture water from a gaseous composition. In some embodiments, the gaseous composition comprises water or water vapour (e.g., air, or other gases and/or mixtures of gases, including but not limited to oxygen, nitrogen, carbon dioxide, carbon monoxide, methane, ethane, propane, etc.).

Some embodiments pertain to a metal-organic material. In some embodiments, the material can exist in a first state and a second state. In some embodiments, switching from said first state to said second state occurs upon contact of the material with water and/or water vapour. In some embodiments, when in the second state, the material is able to retain a higher amount of water than said first state.

Some embodiments pertain to a device for capturing water from a gaseous composition (air, a pure gas, etc.). In some embodiments, the gaseous composition (or a pure gas) comprises water vapour. In some embodiments, the device comprises a metal-organic material. In some embodiments, the device comprises a support. In some embodiments, the metal-organic material can exist in a first state and a second state. In some embodiments, switching from the first state to the second state occurs upon contact of the material with water and/or water vapour. In some embodiments, the second state retains a higher amount of water than said first state.

Some embodiments pertain to a method, use, material or device as disclosed above or elsewhere herein, wherein the metal-organic material comprises metal species and ligands.

Some embodiments pertain to a method, use, material or device as disclosed above or elsewhere herein, wherein the metal species is selected from copper, cobalt, nickel, iron, zinc, cadmium, zirconium, magnesium, calcium and aluminium.

Some embodiments pertain to a method, use, material or device as disclosed above or elsewhere herein, wherein the ligands are selected from bidentate nitrogen ligands, nitrogen-carboxylate ligands and polycarboxylate ligands.

Some embodiments pertain to a method, use, material or device as disclosed above or elsewhere herein, wherein the ligands are selected from 4,4′-bipyridine (L1), 1,4-bis(4-pyridyl)benzene (L2), 4,4′-(2,5-dimethyl-1,4-phenylene)dipyridine (L3), 1,4-bis(4-pyridyl)biphenyl (L4), 1,2-di(pyridine-4-yl)-ethene (L5), benzotriazole-5-carboxylic acid (L128), 2,4-pyridinedicarboxylic acid (L80), glutaric acid (L141), benzene-1,4-dicarboxylic acid (L156) and benzene tetracarboxylic acid (L160).

Some embodiments pertain to a method, use, material or device as disclosed above or elsewhere herein, wherein the metal-organic material further comprises one or more anions.

Some embodiments pertain to a method, use, material or device as disclosed above or elsewhere herein, wherein the anions are selected from BF₄⁻, NO₃⁻, CF₃SO₃⁻ and glutarate.

Some embodiments pertain to a method, use, material or device as disclosed above or elsewhere herein, wherein switching from a first state to a second state occurs when a threshold humidity is reached.

Some embodiments pertain to a method, use, material or device as disclosed above or elsewhere herein, wherein the metal-organic material is a porous metal-organic framework material comprising pores which have a hydrophobic pore window and a hydrophilic internal pore surface.

Some embodiments pertain to a method, use, material or device as disclosed above or elsewhere herein, wherein the metal-organic material which is a microporous material.

Some embodiments pertain to a method, use, material or device as disclosed above or elsewhere herein, wherein the porous metal-organic framework material is selected from [Cu₂(glutarate)₂(4,4′-bipyridine)], [Cu₂(glutarate)₂(1,2-di(pyridine-4-yl)-ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)₂] and [Zr₁₂O₈(μ₃-OH)₈(μ₂-OH)₆(benzene-1,4-dicarboxylate)₉].

Some embodiments pertain to a method, use, material or device as disclosed above or elsewhere herein, wherein the porous metal-organic framework material is [Cu₂(glutarate)₂(4,4′-bipyridine)].

Some embodiments pertain to a method, use, material or device as disclosed above or elsewhere herein, wherein the metal-organic material is a two-dimensional layered material.

Some embodiments pertain to a method, use, material or device as disclosed above or elsewhere herein, wherein the two-dimensional layered material is selected from sql-3-Cu—BF₄, sql-2-Cu—BF₄, sql-2-Cu—OTf, sql-1-Cu—NO₃, sql-A14-Cu—NO₃, sql-1-Co—NO₃ and sql-1-Ni—NO₃.

Some embodiments pertain to a method as disclosed above or elsewhere herein wherein the contacting step involves contacting the metal-organic material with ambient air of sufficient humidity to cause an increase in the amount of water the material is able to hold within its structure.

Some embodiments pertain to a method of delivering water to a locus from water vapour in a gas (e.g., the air). In some embodiments, the method comprises providing a metal-organic material. In some embodiments, the method comprises contacting the metal-organic material with water and/or water vapour. In some embodiments, upon contacting the metal-organic material with water and/or water vapour the material is configured to switch from a first state to a second state. In some embodiments, the second state is configured to and/or is able to retain a higher amount of water than the first state. In some embodiments, the method comprises transporting and/or storing the metal-organic material. In some embodiments, the method comprises applying a stimulus to the metal-organic material to effect desorption of water retained therein. In some embodiments, the method comprises collecting desorbed water at the locus.

Some embodiments pertain to use of a metal-organic material in a device as disclosed above or elsewhere herein, to deliver water to a locus.

Not all objectives mentioned in this specification are achieved nor are all shortcomings of the prior art remedied in all embodiments disclosed and/or claimed herein.

### BRIEF DESCRIPTION OF THE DRAWINGS

FIG. 1 depicts isotherms indicating an amount of water absorbed on a surface.

FIG. 2A depicts an embodiment of a square lattice.

FIG. 2B depicts stacking of lattice layers.

FIG. 3A and 3B depict water sorption isotherms for sql-2-Cu—BF₄ at 25° C. and 35° C., respectively.

FIGS. 4A and 4B depict water sorption kinetic data was collected for sql-2-Cu—BF4 at 25° C. and 35° C., respectively.

FIG. 5 depicts reversibility tests on sql-2-Cu—BF4 performed at 25° C.

FIG. 6 depicts water sorption isotherms for sql-3-Cu—BF4 were collected at 25° C., 30° C. and 35° C.

FIG. 7A-7C depict water sorption kinetic data collected for sql-3-Cu—BF4 at 25° C., 30° C. and 35° C., respectively, over a 0% to 95% relative humidity range.

FIG. 8 depicts a work capacity diagram for sql-3-Cu—BF4 and shows a high working capacity in the low partial pressure range.

FIG. 9 depicts sql-2-Co—NO3 in a two-dimensional layered network with Co²⁺ ions connected in one and two dimensions by 4,4′-bipyridine to form a square lattice, with NO₃⁻ also coordinated at the axial positions.

FIG. 10 depicts water sorption isotherms collected on sql-1-Co—NO3 at 25° C.

FIG. 11 depicts water sorption and desorption kinetics for sql-1-Co—NO3 were studied at 25° C.

FIG. 12 depicts 10 cycle isotherms for sql-1-Co—NO3.

FIG. 13 depicts a sql-1-Ni—NO3 layered network with Ni²⁺ ions connected in one and two dimensions by 4,4′-bipyridine to form a square lattice, with NO₃⁻ also coordinated at the axial positions.

FIG. 14 depicts water sorption isotherms were collected on sql-1-Ni—NO3 at 25° C.

FIG. 15 depicts water sorption and desorption kinetics for sql-1-Ni—NO3 were studied at 25° C.

FIG. 16 depicts reversibility tests results for sql-1-Ni—NO3 performed to calculate working capacity.

FIG. 17 depicts sql-1-Cu—NO3 in a two-dimensional layered network with Cu²⁺ ions connected in one and two dimensions by 4,4′-bipyridine to form a square lattice, with NO₃⁻ also coordinated at the axial positions.

FIG. 18 depicts water sorption isotherms were collected on sql-1-Cu—NO3 at 25° C.

FIG. 19 depicts water vapour sorption kinetics for sql-1-Cu—NO3 were collected at 25° C.

FIG. 20 depicts reversibility tests for sql-1-Cu—NO3 conducted at 25° C. for ten adsorption-desorption cycles.

FIG. 21 depicts sql-2-Cu—OTf as a two-dimensional layered network with Cu²⁺ ions connected in one and two dimensions by 1,4-bis(4-pyridyl)benzene to form a square lattice.

FIG. 22 depicts a water vapour sorption isotherm for sql-2-Cu—OTf collected at 25° C.

FIG. 23 depicts kinetic data for water sorption and desorption for sql-2-Cu—OTf obtained at 25° C.

FIG. 24 depicts data for sql-2-Cu—OTf as it was subjected to a 0% to 30% to 0% relative humidity sequence 37 times.

FIG. 25 depicts sql-2-Cu—OTf in a two-dimensional layered network with Cu²⁺ ions connected in one and two dimensions by 4,4′-(2,5-dimethyl-1,4-phenylene)dipyridine forming a square lattice.

FIG. 26A and 26B depict vapour sorption studies for sql-A14-Cu—NO₃ performed at 25° C. and 30° C., respectively.

FIGS. 27A and 27B depict sorption and desorption kinetics for sql-A14-Cu—NO₃ obtained at 25° C. and 30° C., respectively.

FIG. 28 depicts working capacity data for sql-A14-Cu—NO₃.

FIGS. 29A and 29B depict the crystallographic structure of ROS037.

FIG. 30 depicts data from water vapour sorption studies for [Cu₂(glutarate)2(4,4′-bipyridine)] performed at 25° C.

FIG. 31 depicts water sorption and desorption kinetic data for [Cu₂(glutarate)₂(4,4′-bipyridine)] obtained at 25° C.

FIG. 32 depicts data for [Cu₂(glutarate)₂(4,4′-bipyridine)] adsorption and desorption cycles at 25° C.

FIG. 33 is a diagram illustrating a way of determining pore window size.

FIG. 34 depicts water sorption and desorption data for ROS-037.

FIG. 35 shows data pertaining to kinetics of adsorption for ROS-037.

FIG. 36 depicts a vapour sorption isotherm for the material of Example 12.

FIG. 37 depicts a vapour sorption isotherm for the material of Example 13.

FIG. 38 depicts a vapour sorption isotherm for the material of Example 14.

FIG. 39 depicts a vapour sorption isotherm for the material of Example 15.

FIG. 40 depicts a vapour sorption isotherm for the material of Example 16.

FIG. 41 shows the Powder X-ray diffraction spectrum of the paper composite (top line) in comparison with as synthesized powder (middle line) and calculated powder (bottom line).

FIGS. 42 and 43 show respectively flat section and cross section SEM images of the paper composite.

FIG. 44 shows experimental isotherms for water vapour sorption at 27° C. on [Cu₂(glutarate)₂(4,4′-bipyridine)] powder and its paper composite.

### DETAILED DESCRIPTION

Atmospheric water vapour is an underexploited natural water resource. Water captured from air has many potential uses. For example, it could be used to provide access to clean drinking water, be used in agriculture in arid environments or be used to provide high-purity water for medical and industrial applications.

The control of humidity in heating, ventilation and air conditioning (HVAC) systems also involves water capture. HVAC systems use substantial amounts of energy and thus even a small reduction in energy consumption can be highly beneficial.

Research in this area has focused on molecular sieve materials such as zeolites and mesoporous silica. These porous materials contain many cavities for the adsorption of small molecules, and are also used in related applications for example carbon dioxide capture and gas separation. However, water capture and delivery using these materials is too energy intensive to be economically viable, as desorption requires significant heating. Therefore, there is a need for new classes of sorbent materials that are able to capture water vapour over a range of humidities and offer low energy footprints for recycling.

Metal-organic materials are a class of materials in which cages or networks are formed by the linking of metal clusters or metal cations by organic linker ligands. Recently, a class of metal-organic materials known as metal-organic frameworks (MOFs) have received attention for use in water capture devices. However, like zeolites and mesoporous silica, many of these materials possess a rigid three-dimensional framework, which is often highly strained, affording poor recyclability, with structures collapsing when subjected to reversibility tests due to low thermal and/or hydrolytic stabilities. Consequently many such materials have a low working capacity, caused by poor water uptake and/or unsuitable adsorption profiles.

Certain embodiments pertain to new metal organic materials. It has been surprisingly found that, in some embodiments, these metal-organic materials have excellent water adsorption properties.

Some embodiments provide improved means for capturing water vapour from air.

Some embodiments provide a method of capturing water from a gaseous composition comprising water vapour. In some embodiments, the method includes one or more of the following steps:
(a) providing a metal-organic material; and
(b) contacting the metal-organic material with water and/or water vapour;
   wherein upon contact with water and/or water vapour the material switches from a first state to a second state wherein the second state is able to retain a higher amount of water than the first state.

Some embodiments provide the use of a metal-organic material to capture water from a gaseous composition comprising water vapour.

Some embodiments provide a metal-organic material. In some embodiments, said material can exist in a first state and a second state. In some embodiments, switching from said first state to said second state occurs upon contact of the material with water and/or water vapour. In some embodiments, said second state is able to retain a higher amount of water than said first state.

Some embodiments provide a device for capturing water from a gaseous composition (e.g., air) comprising water vapour. In some embodiments, the device comprises a metal-organic material. In some embodiments, the device further comprises a support. In some embodiments, the metal-organic material can exist in a first state and a second state; wherein switching from said first state to said second state occurs upon contact of the material with water and/or water vapour.

In some embodiments, said second state is able to retain a higher amount of water than said first state.

Whenever a group is described as being “optionally substituted,” or any similar language, that group may be unsubstituted or substituted with one or more of the indicated substituents. Likewise, when a group is described as being “unsubstituted or substituted,” or any similar language, if substituted, the substituent(s) may be selected from one or more of the indicated substituents. If no substituents are indicated, it is meant that the indicated “optionally substituted” or “substituted” group may be substituted with one or more group(s) individually and independently selected from alkyl, alkenyl, alkynyl, cycloalkyl, cycloalkenyl, aryl, heteroaryl, heterocyclyl, aryl(alkyl), cycloalkyl(alkyl), heteroaryl(alkyl), heterocyclyl(alkyl), hydroxy, alkoxy, acyl, cyano, halogen, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, nitro, sulfenyl, sulfinyl, sulfonyl, haloalkyl, haloalkoxy, an amino, a mono-substituted amine group, a di-substituted amine group, a mono-substituted amine(alkyl), a di-substituted amine(alkyl), a diamino-group, a polyamino, a diether-group, and a polyether-.

As used herein, “Ca to Cb” in which “a” and “b” are integers refers to the number of carbon atoms in a group. The indicated group can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated, the broadest range described in these definitions is to be assumed.

If two “R” groups are described as being “taken together,” or any similar language, the R groups and the atoms they are attached to can form a cycloalkyl, cycloalkenyl, aryl, heteroaryl or heterocycle. For example, without limitation, if R^{a} and R^{b} of an NR^{a}R^{b} group are indicated to be “taken together,” it means that they are covalently bonded to one another to form a ring:

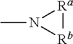

As used herein, the term “alkyl” refers to a fully saturated aliphatic hydrocarbon group. The alkyl moiety may be branched or straight chain. Examples of branched alkyl groups include, but are not limited to, iso-propyl, sec-butyl, t-butyl and the like. Examples of straight chain alkyl groups include, but are not limited to, methyl, ethyl, n-propyl, n-butyl, n-pentyl, n-hexyl, n-heptyl and the like. The alkyl group may have 1 to 30 carbon atoms (whenever it appears herein, a numerical range such as “1 to 30” refers to each integer in the given range; e.g., “1 to 30 carbon atoms” means that the alkyl group may consist of 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, although the present definition also covers the occurrence of the term “alkyl” where no numerical range is designated). The “alkyl” group may also be a medium size alkyl having 1 to 12 carbon atoms. The “alkyl” group could also be a lower alkyl having 1 to 6 carbon atoms. An alkyl group may be substituted or unsubstituted. By way of example only, “C₁-C₅ alkyl” indicates that there are one to five carbon atoms in the alkyl chain, i.e., the alkyl chain is selected from methyl, ethyl, n-propyl, isopropyl, n-butyl, isobutyl, tert-butyl, pentyl (branched and straight-chained), etc. Typical alkyl groups include, but are in no way limited to, methyl, ethyl, propyl, isopropyl, butyl, isobutyl, tertiary butyl, pentyl and hexyl.

As used herein, the term “alkylene” refers to a bivalent fully saturated straight chain aliphatic hydrocarbon group. Examples of alkylene groups include, but are not limited to, methylene, ethylene, propylene, butylene, pentylene, hexylene, heptylene and octylene. An alkylene group may be represented by , [symbol] ,followed by the number of carbon atoms, followed by a “*”. For example,

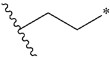 [SMILES: *CC*]

to represent ethylene. The alkylene group may have 1 to 30 carbon atoms (whenever it appears herein, a numerical range such as “1 to 30” refers to each integer in the given range; e.g., “1 to 30 carbon atoms” means that the alkyl group may consist of 1 carbon atom, 2 carbon atoms, 3 carbon atoms, etc., up to and including 30 carbon atoms, although the present definition also covers the occurrence of the term “alkylene” where no numerical range is designated). The alkylene group may also be a medium size alkyl having 1 to 12 carbon atoms. The alkylene group could also be a lower alkyl having 1 to 6 carbon atoms. An alkylene group may be substituted or unsubstituted. For example, a lower alkylene group can be substituted by replacing one or more hydrogen of the lower alkylene group and/or by substituting both hydrogens on the same carbon with a C₃₋₆ monocyclic cycloalkyl group (e.g.,

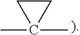

The term “alkenyl” used herein refers to a monovalent straight or branched chain radical of from two to twenty carbon atoms containing a carbon double bond(s) including, but not limited to, 1-propenyl, 2-propenyl, 2-methyl-1-propenyl, 1-butenyl, 2-butenyl and the like. An alkenyl group may be unsubstituted or substituted.

The term “alkynyl” used herein refers to a monovalent straight or branched chain radical of from two to twenty carbon atoms containing a carbon triple bond(s) including, but not limited to, 1-propynyl, 1-butynyl, 2-butynyl and the like. An alkynyl group may be unsubstituted or substituted.

As used herein, “cycloalkyl” refers to a completely saturated (no double or triple bonds) mono- or multi- cyclic (such as bicyclic) hydrocarbon ring system. When composed of two or more rings, the rings may be joined together in a fused, bridged or spiro fashion. As used herein, the term “fused” refers to two rings which have two atoms and one bond in common. As used herein, the term “bridged cycloalkyl” refers to compounds wherein the cycloalkyl contains a linkage of one or more atoms connecting non-adjacent atoms. As used herein, the term “spiro” refers to two rings which have one atom in common and the two rings are not linked by a bridge. Cycloalkyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). A cycloalkyl group may be unsubstituted or substituted. Examples of mono-cycloalkyl groups include, but are in no way limited to, cyclopropyl, cyclobutyl, cyclopentyl, cyclohexyl, cycloheptyl and cyclooctyl. Examples of fused cycloalkyl groups are decahydronaphthalenyl, dodecahydro-1 H-phenalenyl and tetradecahydroanthracenyl; examples of bridged cycloalkyl groups are bicyclo[1.1.1]pentyl, adamantanyl and norbornanyl; and examples of spiro cycloalkyl groups include spiro[3.3]heptane and spiro[4.5]decane.

As used herein, “cycloalkenyl” refers to a mono- or multi-cyclic (such as bicyclic) hydrocarbon ring system that contains one or more double bonds in at least one ring; although, if there is more than one, the double bonds cannot form a fully delocalized pi-electron system throughout all the rings (otherwise the group would be “aryl,” as defined herein). Cycloalkenyl groups can contain 3 to 10 atoms in the ring(s), 3 to 8 atoms in the ring(s) or 3 to 6 atoms in the ring(s). When composed of two or more rings, the rings may be connected together in a fused, bridged or spiro fashion. A cycloalkenyl group may be unsubstituted or substituted.

As used herein, “aryl” refers to a carbocyclic (all carbon) monocyclic or multicyclic (such as bicyclic) aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group or a C₆ aryl group. Examples of aryl groups include, but are not limited to, benzene, naphthalene and azulene. An aryl group may be substituted or unsubstituted. As used herein, “heteroaryl” refers to a monocyclic or multicyclic (such as bicyclic) aromatic ring system (a ring system with fully delocalized pi-electron system) that contain(s) one or more heteroatoms (for example, 1, 2 or 3 heteroatoms), that is, an element other than carbon, including but not limited to, nitrogen, oxygen and sulfur. The number of atoms in the ring(s) of a heteroaryl group can vary. For example, the heteroaryl group can contain 4 to 14 atoms in the ring(s), 5 to 10 atoms in the ring(s) or 5 to 6 atoms in the ring(s), such as nine carbon atoms and one heteroatom; eight carbon atoms and two heteroatoms; seven carbon atoms and three heteroatoms; eight carbon atoms and one heteroatom; seven carbon atoms and two heteroatoms; six carbon atoms and three heteroatoms; five carbon atoms and four heteroatoms; five carbon atoms and one heteroatom; four carbon atoms and two heteroatoms; three carbon atoms and three heteroatoms; four carbon atoms and one heteroatom; three carbon atoms and two heteroatoms; or two carbon atoms and three heteroatoms. Furthermore, the term “heteroaryl” includes fused ring systems where two rings, such as at least one aryl ring and at least one heteroaryl ring or at least two heteroaryl rings, share at least one chemical bond. Examples of heteroaryl rings include, but are not limited to, furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline and triazine. A heteroaryl group may be substituted or unsubstituted.

As used herein, “heterocyclyl” or “heteroalicyclyl” refers to three-, four-, five-, six-, seven-, eight-, nine-, ten-, up to 18-membered monocyclic, bicyclic and tricyclic ring system wherein carbon atoms together with from 1 to 5 heteroatoms constitute said ring system. A heterocycle may optionally contain one or more unsaturated bonds situated in such a way, however, that a fully delocalized pi-electron system does not occur throughout all the rings. The heteroatom(s) is an element other than carbon including, but not limited to, oxygen, sulfur and nitrogen. A heterocycle may further contain one or more carbonyl or thiocarbonyl functionalities, so as to make the definition include oxo-systems and thio-systems such as lactams, lactones, cyclic imides, cyclic thioimides and cyclic carbamates. When composed of two or more rings, the rings may be joined together in a fused, bridged or spiro fashion. As used herein, the term “fused” refers to two rings which have two atoms and one bond in common. As used herein, the term “bridged heterocyclyl” or “bridged heteroalicyclyl” refers to compounds wherein the heterocyclyl or heteroalicyclyl contains a linkage of one or more atoms connecting non-adjacent atoms. As used herein, the term “spiro” refers to two rings which have one atom in common and the two rings are not linked by a bridge. Heterocyclyl and heteroalicyclyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). For example, five carbon atoms and one heteroatom; four carbon atoms and two heteroatoms; three carbon atoms and three heteroatoms; four carbon atoms and one heteroatom; three carbon atoms and two heteroatoms; two carbon atoms and three heteroatoms; one carbon atom and four heteroatoms; three carbon atoms and one heteroatom; or two carbon atoms and one heteroatom. Additionally, any nitrogens in a heteroalicyclic may be quaternized. Heterocyclyl or heteroalicyclic groups may be unsubstituted or substituted. Examples of such “heterocyclyl” or “heteroalicyclyl” groups include but are not limited to, 1,3-dioxin, 1,3-dioxane, 1,4-dioxane, 1,2-dioxolane, 1,3-dioxolane, 1,4-dioxolane, 1,3-oxathiane, 1,4-oxathiin, 1,3-oxathiolane, 1,3-dithiole, 1,3-dithiolane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, trioxane, hexahydro-1,3,5-triazine, imidazoline, imidazolidine, isoxazoline, isoxazolidine, oxazoline, oxazolidine, oxazolidinone, thiazoline, thiazolidine, morpholine, oxirane, piperidine N-Oxide, piperidine, piperazine, pyrrolidine, azepane, pyrrolidone, pyrrolidione, 4-piperidone, pyrazoline, pyrazolidine, 2-oxopyrrolidine, tetrahydropyran, 4H-pyran, tetrahydrothiopyran, thiamorpholine, thiamorpholine sulfoxide, thiamorpholine sulfone and their benzo-fused analogs (e.g., benzimidazolidinone, tetrahydroquinoline and/or 3,4-methylenedioxyphenyl). Examples of spiro heterocyclyl groups include 2-azaspiro[3.3]heptane, 2-oxaspiro[3.3]heptane, 2-oxa-6-azaspiro[3.3]heptane, 2,6-diazaspiro[3.3]heptane, 2-oxaspiro[3.4]octane and 2-azaspiro[3.4]octane.

As used herein, “aralkyl” and “aryl(alkyl)” refer to an aryl group connected, as a substituent, via a lower alkylene group. The lower alkylene and aryl group of an aralkyl may be substituted or unsubstituted. Examples include but are not limited to benzyl, 2-phenylalkyl, 3-phenylalkyl and naphthylalkyl.

As used herein, “cycloalkyl(alkyl)” refer to an cycloalkyl group connected, as a substituent, via a lower alkylene group. The lower alkylene and cycloalkyl group of a cycloalkyl(alkyl) may be substituted or unsubstituted.

As used herein, “heteroaralkyl” and “heteroaryl(alkyl)” refer to a heteroaryl group connected, as a substituent, via a lower alkylene group. The lower alkylene and heteroaryl group of heteroaralkyl may be substituted or unsubstituted. Examples include but are not limited to 2-thienylalkyl, 3-thienylalkyl, furylalkyl, thienylalkyl, pyrrolylalkyl, pyridylalkyl, isoxazolylalkyl and imidazolylalkyl and their benzo-fused analogs.

A “heteroalicyclyl(alkyl)” and “heterocyclyl(alkyl)” refer to a heterocyclic or a heteroalicyclic group connected, as a substituent, via a lower alkylene group. The lower alkylene and heterocyclyl of a (heteroalicyclyl)alkyl may be substituted or unsubstituted. Examples include but are not limited tetrahydro-2H-pyran-4-yl(methyl), piperidin-4-yl(ethyl), piperidin-4-yl(propyl), tetrahydro-2H-thiopyran-4-yl(methyl) and 1,3-thiazinan-4-yl(methyl).

As used herein, the term “hydroxy” refers to a —OH group.

As used herein, “alkoxy” refers to the Formula —OR wherein R is an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl) is defined herein. A non-limiting list of alkoxys are methoxy, ethoxy, n-propoxy, 1-methylethoxy (isopropoxy), n-butoxy, iso-butoxy, sec-butoxy, tert-butoxy, phenoxy and benzoxy. An alkoxy may be substituted or unsubstituted.

As used herein, “acyl” refers to a hydrogen, alkyl, alkenyl, alkynyl, aryl, heteroaryl, heterocyclyl, aryl(alkyl), heteroaryl(alkyl) and heterocyclyl(alkyl) connected, as substituents, via a carbonyl group. Examples include formyl, acetyl, propanoyl, benzoyl and acryl. An acyl may be substituted or unsubstituted.

As used herein, a “cyano” group refers to a “—CN” group.

The term “halogen atom” or “halogen” as used herein, means any one of the radio-stable atoms of column 7 of the Periodic Table of the Elements, such as, fluorine, chlorine, bromine and iodine.

A “thiocarbonyl” group refers to a “—C(═S)R” group in which R can be the same as defined with respect to O-carboxy. A thiocarbonyl may be substituted or unsubstituted. An “O-carbamyl” group refers to a “—OC(═O)N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An O-carbamyl may be substituted or unsubstituted.

An “N-carbamyl” group refers to an “ROC(═O)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-carbamyl may be substituted or unsubstituted.

An “O-thiocarbamyl” group refers to a “—OC(═S)—N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An O-thiocarbamyl may be substituted or unsubstituted.

An “N-thiocarbamyl” group refers to an “ROC(═S)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-thiocarbamyl may be substituted or unsubstituted.

A “C-amido” group refers to a “—C(═O)N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). A C-amido may be substituted or unsubstituted.

An “N-amido” group refers to a “RC(═O)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-amido may be substituted or unsubstituted.

An “S-sulfonamido” group refers to a “—SO₂N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An S-sulfonamido may be substituted or unsubstituted.

An “N-sulfonamido” group refers to a “RSO₂N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-sulfonamido may be substituted or unsubstituted.

An “O-carboxy” group refers to a “RC(═O)O—” group in which R can be hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. An O-carboxy may be substituted or unsubstituted.

The terms “ester” and “C-carboxy” refer to a “—C(═O)OR” group in which R can be the same as defined with respect to O-carboxy. An ester and C-carboxy may be substituted or unsubstituted.

A “nitro” group refers to an “—NO₂” group.

A “sulfenyl” group refers to an “—SR” group in which R can be hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). A sulfenyl may be substituted or unsubstituted.

A “sulfinyl” group refers to an “—S(═O)—R” group in which R can be the same as defined with respect to sulfenyl. A sulfinyl may be substituted or unsubstituted.

A “sulfonyl” group refers to an “SO₂R” group in which R can be the same as defined with respect to sulfenyl. A sulfonyl may be substituted or unsubstituted.

As used herein, “haloalkyl” refers to an alkyl group in which one or more of the hydrogen atoms are replaced by a halogen (e.g., mono-haloalkyl, di-haloalkyl, tri-haloalkyl and polyhaloalkyl).

Such groups include but are not limited to, chloromethyl, fluoromethyl, difluoromethyl, trifluoromethyl, 1-chloro-2-fluoromethyl, 2-fluoroisobutyl and pentafluoroethyl. A haloalkyl may be substituted or unsubstituted.

As used herein, “haloalkoxy” refers to an alkoxy group in which one or more of the hydrogen atoms are replaced by a halogen (e.g., mono-haloalkoxy, di-haloalkoxy and tri-haloalkoxy). Such groups include but are not limited to, chloromethoxy, fluoromethoxy, difluoromethoxy, trifluoromethoxy, 1-chloro-2-fluoromethoxy and 2-fluoroisobutoxy. A haloalkoxy may be substituted or unsubstituted.

The terms “amino” and “unsubstituted amino” as used herein refer to a —NH₂ group.

A “mono-substituted amine” group refers to a “—NHR_{A}” group in which R_{A} can be an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. The R_{A} may be substituted or unsubstituted. A mono-substituted amine group can include, for example, a mono-alkylamine group, a mono-C₁-C₆ alkylamine group, a mono-arylamine group, a mono-C₆-C₁₀ arylamine group and the like. Examples of mono-substituted amine groups include, but are not limited to, —NH(methyl), —NH(phenyl) and the like.

A “di-substituted amine” group refers to a “—NR_{A}R_{B}” group in which R_{A} and R_{B} can be independently an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. R_{A} and R_{B} can independently be substituted or unsubstituted. A di-substituted amine group can include, for example, a di-alkylamine group, a di-C₁-C₆ alkylamine group, a di-arylamine group, a di-C₆-C₁₀ arylamine group and the like. Examples of di-substituted amine groups include, but are not limited to, —N(methyl)₂, —N(phenyl)(methyl), —N(ethyl)(methyl) and the like.

As used herein, “mono-substituted amine(alkyl)” group refers to a mono-substituted amine as provided herein connected, as a substituent, via a lower alkylene group. A mono-substituted amine(alkyl) may be substituted or unsubstituted. A mono-substituted amine(alkyl) group can include, for example, a mono-alkylamine(alkyl) group, a mono-C₁-C₆ alkylamine(C₁-C₆ alkyl) group, a mono-arylamine(alkyl group), a mono-C₆-C₁₀ arylamine(C₁-C₆ alkyl) group and the like. Examples of mono-substituted amine(alkyl) groups include, but are not limited to, —CH₂NH(methyl), —CH₂NH(phenyl), —CH₂CH₂NH(methyl), —CH₂CH₂NH(phenyl) and the like.

As used herein, “di-substituted amine(alkyl)” group refers to a di-substituted amine as provided herein connected, as a substituent, via a lower alkylene group. A di-substituted amine(alkyl) may be substituted or unsubstituted. A di-substituted amine(alkyl) group can include, for example, a dialkylamine(alkyl) group, a di-C₁-C₆ alkylamine(C₁-C₆ alkyl) group, a di-arylamine(alkyl) group, a di-C₆-C₁₀ arylamine(C₁-C₆ alkyl) group and the like. Examples of di-substituted amine(alkyl)groups include, but are not limited to, —CH₂N(methyl)₂, —CH₂N(phenyl)(methyl), —CH₂N(ethyl)(methyl), —CH₂CH₂N(methyl)₂, —CH₂CH₂N(phenyl)(methyl), —NCH₂CH₂(ethyl)(methyl) and the like.

As used herein, the term “diamino-” denotes an a “—N(R_{A})R_{B}—N(R_{C})(R_{D})” group in which R_{A}, R_{C}, and R_{D} can be independently a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “N” groups and can be (independently of R_{A}, R_{C}, and R_{D}) a substituted or unsubstituted alkylene group. R_{A}, R_{B}, R_{C}, and R_{D} can independently further be substituted or unsubstituted.

As used herein, the term “polyamino” denotes a “—(N(R_{A})R_{B}—)ₙ—N(R_{C})(R_{D})”. For illustration, the term polyamino can comprise —N(R_{A})alkyl-N(R_{A})alkyl-N(R_{A})alkyl-N(R_{A})alkyl-H. In some embodiments, the alkyl of the polyamino is as disclosed elsewhere herein. While this example has only 4 repeat units, the term “polyamino” may consist of 1, 2, 3, 4, 5, 6, 7, 8, 9, or 10 repeat units. R_{A}, R_{C}, and R_{D} can be independently a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “N” groups and can be (independently of R_{A}, R_{C}, and R_{D}) a substituted or unsubstituted alkylene group. R_{A}, R_{C}, and R_{D} can independently further be substituted or unsubstituted. As noted here, the polyamino comprises amine groups with intervening alkyl groups (where alkyl is as defined elsewhere herein).

As used herein, the term “diether-” denotes an a “—OR_{B}O—R_{A}” group in which R_{A} can be a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “O” groups and can be a substituted or unsubstituted alkylene group. R_{A} can independently further be substituted or unsubstituted.

As used herein, the term “polyether” denotes a repeating —(OR_{B}—)ₙOR_{A} group. For illustration, the term polyether can comprise —Oalkyl—Oalkyl—Oalkyl—Oalkyl—OR_{A}. In some embodiments, the alkyl of the polyether is as disclosed elsewhere herein. While this example has only 4 repeat units, the term “polyether” may consist of 1, 2, 3, 4, 5, 6, 7, 8, 9, or 10 repeat units. R_{A} can be a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. R_{B} can be a substituted or unsubstituted alkylene group. R_{A} can independently further be substituted or unsubstituted. As noted here, the polyether comprises ether groups with intervening alkyl groups (where alkyl is as defined elsewhere herein and can be optionally substituted).

Where the number of substituents is not specified (e.g. haloalkyl), there may be one or more substituents present. For example, “haloalkyl” may include one or more of the same or different halogens. As another example, “C₁-C₃ alkoxyphenyl” may include one or more of the same or different alkoxy groups containing one, two or three atoms.

As used herein, a radical indicates species with a single, unpaired electron such that the species containing the radical can be covalently bonded to another species. Hence, in this context, a radical is not necessarily a free radical. Rather, a radical indicates a specific portion of a larger molecule. The term “radical” can be used interchangeably with the term “group.”

Features of some embodiments are described herein.

Some embodiments provide the use of a metal-organic material to capture water from a gaseous composition comprising water vapour. In some embodiments, the gaseous composition comprising water vapour is air.

In some embodiments, a method of capturing water from air is provided. In some embodiments, the method comprises one or more of the following steps:
(a) providing a metal-organic material; and
(b) contacting the metal-organic material with water and/or water vapour.

In some embodiments, upon contact with water and/or water vapour the material is configured to switch from a first state to a second state. In some embodiments, the second state is able to retain a higher amount of water than the first state.

Some embodiments provide the use of a metal-organic material to capture water from air.

Some embodiments provide a device for capturing water from air comprising a metal-organic material and a support.

Some embodiments pertain to metal-organic materials. Metal-organic materials (or MOMs) is a term used to describe materials comprising metal moieties and organic ligands including a diverse group of discrete (e.g. metal-organic polyhedra, spheres or nanoballs, metal-organic polygons) or polymeric structures (e.g. porous coordination polymers (PCPs), metal-organic frameworks (MOFs) or hybrid inorganic-organic materials). In some embodiments, metal-organic materials encompass discrete as well as extended structures with periodicity in one, two, or three dimensions.

Some embodiments provide metal-organic materials which can exist in a first state and a second state. In some embodiments, the second state is able to retain a higher amount of water than the first state. In some embodiments, this change in state occurs upon exposure to water and/or water vapour. In some embodiments, the first state may be regarded as an empty state in which no water or very low levels of water are retained in the material. In some embodiments, the second state may be regarded as a loaded state in which water is retained within the material.

In some embodiments, the metal-organic materials comprise metal species and ligands. In some embodiments, these may be linked in substantially two-dimensions with weaker forces between two-dimensional layers. In some embodiments, the metal species and ligands are linked in three dimensions to provide a metal-organic framework material or MOF.

The term metal species as used herein may refer to a metal cation or metal cluster that serves as a node in a metal-organic species.

In some embodiments, the metal species for use herein are d-block metals, for example transition metal species. In some embodiments, these are suitably present as transition metal ions. Other metal species that may be useful herein are magnesium, calcium and aluminium. In some embodiments, metals that are not transition metals are used.

In some embodiments, the metal species is selected from copper, cobalt, nickel, iron, zinc, cadmium, zirconium, magnesium, calcium and aluminium.

In some embodiments, the metal species is selected from Cu²⁺, Co²⁺, Ni²⁺, Fe²⁺, Fe³⁺, Zn²⁺, Cd²⁺, Zr⁴⁺, Mg²⁺, Ca²⁺ and Al³⁺.

In some embodiments, the metal-organic material may comprise a mixture of two or more metal species. In some embodiments, all of the metal species in the metal-organic material are the same.

In some embodiments, the metal-organic materials defined herein suitably comprise ligands. Unless otherwise specified linker ligands provide a link between two or more metal species.

In some embodiments, the ligand is a multidentate ligand.

In some embodiments, the metal-organic material may comprise a mixture of two or more different ligands. In some embodiments, all of the ligands in the metal-organic material are the same.

In some embodiments, the ligand is a bidentate ligand.

In some embodiments, the ligand is an organic bidentate ligand.

In some embodiments, suitable organic bidentate ligands may be aliphatic or aromatic in character.

In some embodiments, bidentate ligands suitably include at least two donor atoms. These are atoms that are able to donate an electron pair to form a coordinate bond, suitably a coordinate covalent bond.

In some embodiments, in the organic bidentate ligands used in the present invention, the two donor atoms may be selected from halogens, sulphur, oxygen and nitrogen. In some embodiments, the two donor atoms may each be the same or different.

In some embodiments, the donor atoms are selected from oxygen and nitrogen.

In some embodiments, ligands for use herein are compounds including one or more nitrogen atoms and/or one or more carboxylic acid (COOH) groups. In some embodiments, when incorporated into the metal-organic material carboxylic acid groups may be configured to bind to a metal species as a carboxylate anion.

In some embodiments, ligands for use herein are compounds including one or more aromatic nitrogen atoms and/or one or more carboxylic acid groups.

In some embodiments, the metal-organic material comprises an optionally substituted organic bidentate ligand having two donor nitrogen atoms. In some embodiments, these are bidentate nitrogen ligands.

In some embodiments, optionally substituted bidentate nitrogen ligands may comprise at least one nitrogen-containing heterocycle. In some embodiments, the bidentate nitrogen ligand may be a nitrogen-containing heterocycle comprising two nitrogen atoms each having a lone pair of electrons, for example pyrazine. In some embodiments, the bidentate ligand may comprise multiple optionally substituted aromatic rings including multiple nitrogen containing aromatic heterocycles, which may contain one or more nitrogen atoms and optionally one or more further heteroatoms. In some embodiments, these may include optionally substituted aromatic moieties based on pyridine, pyrazine, imidazole, pyrimidine, pyrrole, pyrazole, isoxazole and oxazole. In some embodiments, also suitable are compounds based on optionally substituted bicyclic aromatic heterocycles, for example indole, purine, isoindole, pteridine, quinoline, benzotriazole and isoquinoline.

Nitrogen containing aromatic heterocyclic ligands may be incorporated into the metal-organic material in protonated or deprotonated form.

In some embodiments the bidentate nitrogen ligand comprises two nitrogen-containing heterocycles, which may be linked by a bond. One such bidentate ligand is 4,4′-bipyridine (L1):

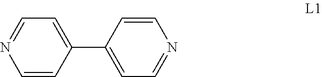 [SMILES: c1cc(-c2ccncc2)ccn1]

In some embodiments L1 may be optionally substituted.

Alternatively, in some embodiments, the two nitrogen-containing heterocycles may be linked together by a spacer group. Suitably the bidentate nitrogen ligand has the formula (L2N):

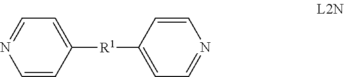

wherein R¹ is an optionally substituted spacer group. In some embodiments L2N may be optionally substituted.

In some embodiments, R¹ may be a heteroatom, a group of connected heteroatoms or a group comprising heteroatoms. In some embodiments, R¹ may be a —N═N— group.

In some embodiments, R¹ may be an optionally substituted hydrocarbyl group. In some embodiments, the hydrocarbyl group may comprise a cyclic group. In some embodiments, the hydrocarbyl group may comprise an aromatic cyclic group. In some embodiments, the hydrocarbyl group may comprise a heterocyclic group.

As used herein, the term “hydrocarbyl” is used in its ordinary sense, which is well-known to those skilled in the art. Specifically, it refers to a group having predominantly hydrocarbon character.

Examples of hydrocarbyl groups include:

(i) hydrocarbon groups, that is, aliphatic (which may be saturated or unsaturated, linear or branched, e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

(ii) substituted hydrocarbon groups, that is, substituents containing non-hydrocarbon groups which, in the context of this invention, do not alter the predominantly hydrocarbon nature of the substituent (e.g., halo (especially chloro and fluoro), hydroxy, alkoxy, keto, acyl, cyano, mercapto, alkylmercapto, amino, alkylamino, nitro, nitroso, and sulphoxy);

(iii) hetero substituents, that is, substituents which, while having a predominantly hydrocarbon character, in the context of this invention, contain other than carbon in a ring or chain otherwise composed of carbon atoms. Heteroatoms include sulphur, oxygen, nitrogen and encompass substituents such as pyridyl, furyl, thienyl and imidazolyl.

In some embodiments, suitable bidentate nitrogen ligands for use herein include compounds L1 to L68 (any one of which may be optionally substituted):

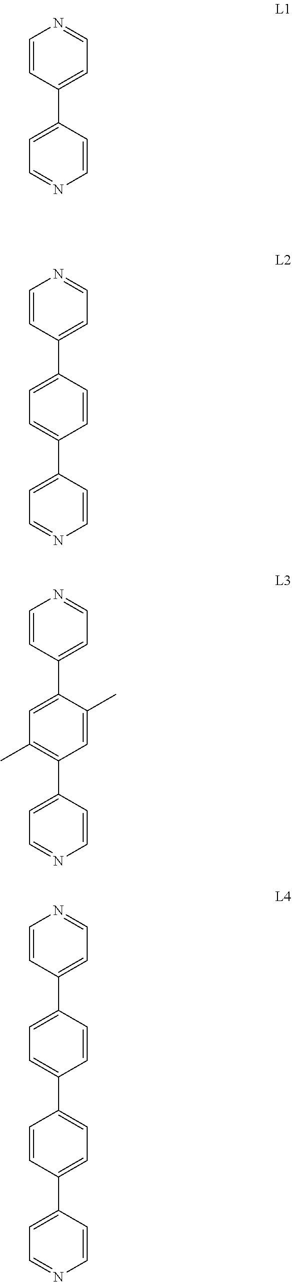

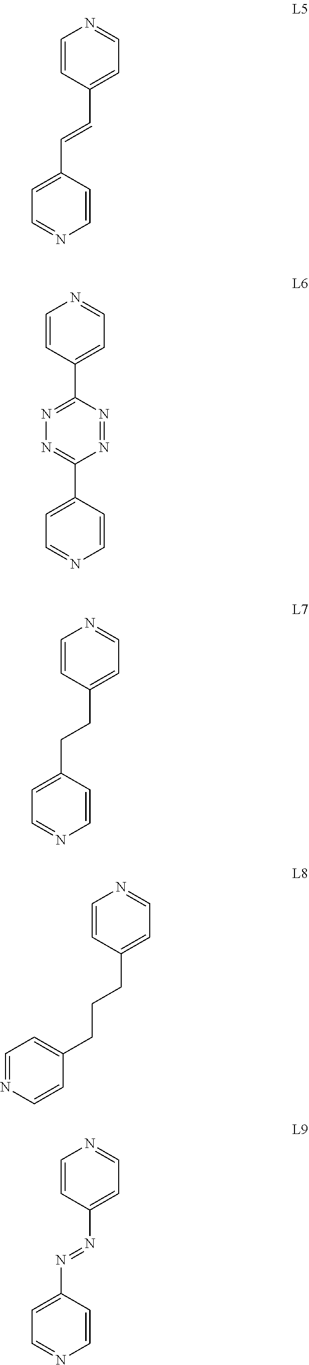 [SMILES: C(=C\c1ccncc1)/c1ccncc1 ; c1cc(-c2nnc(-c3ccncc3)nn2)ccn1 ; c1cc(CCc2ccncc2)ccn1 ; c1cc(CCCc2ccncc2)ccn1 ; c1cc(/N=N/c2ccncc2)ccn1]

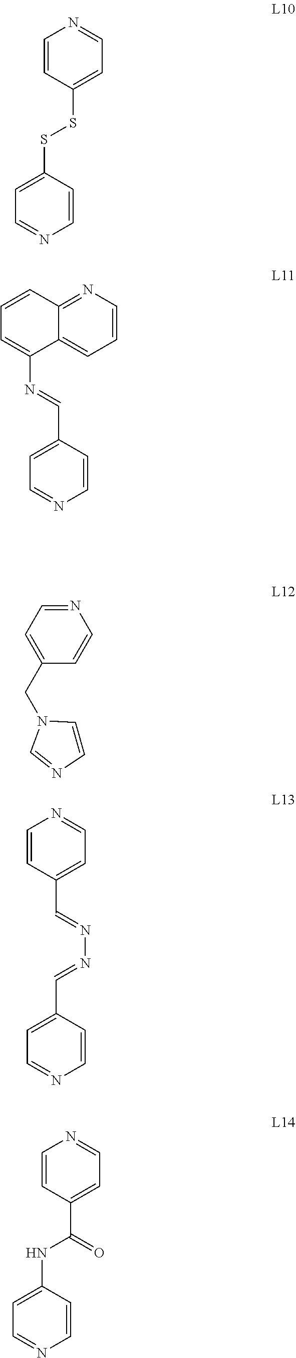

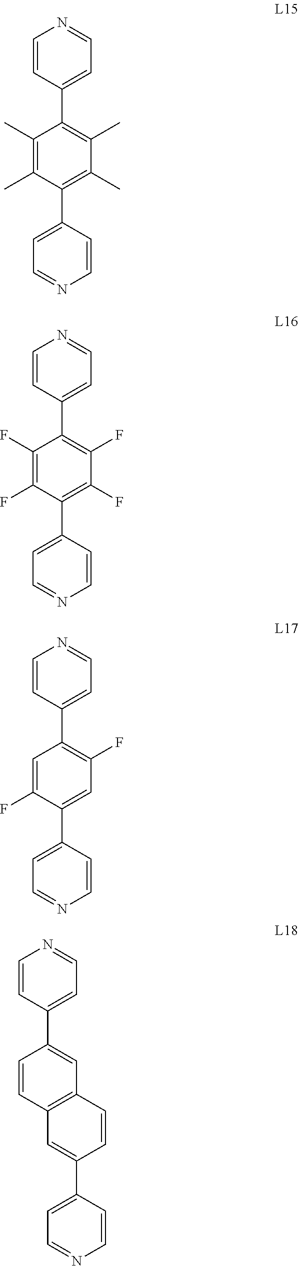

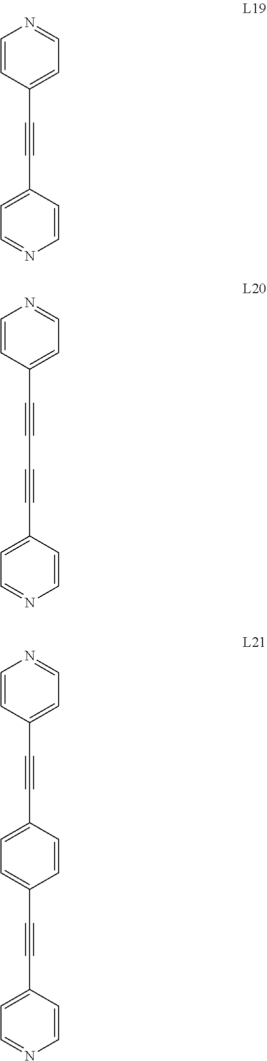 [SMILES: C(#Cc1ccncc1)c1ccncc1 ; C(C#Cc1ccncc1)#Cc1ccncc1 ; C(#Cc1ccc(C#Cc2ccncc2)cc1)c1ccncc1]

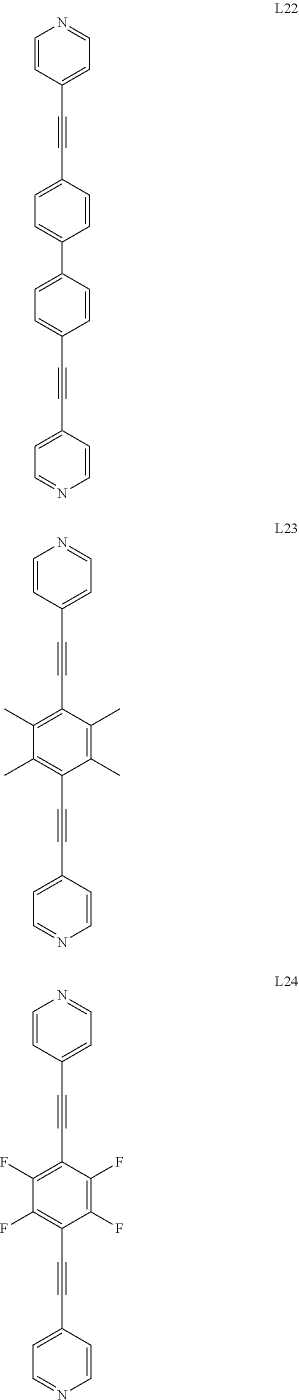

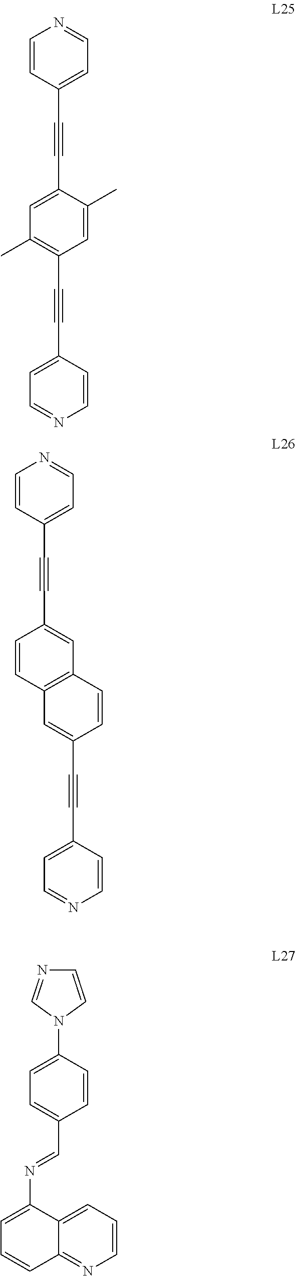

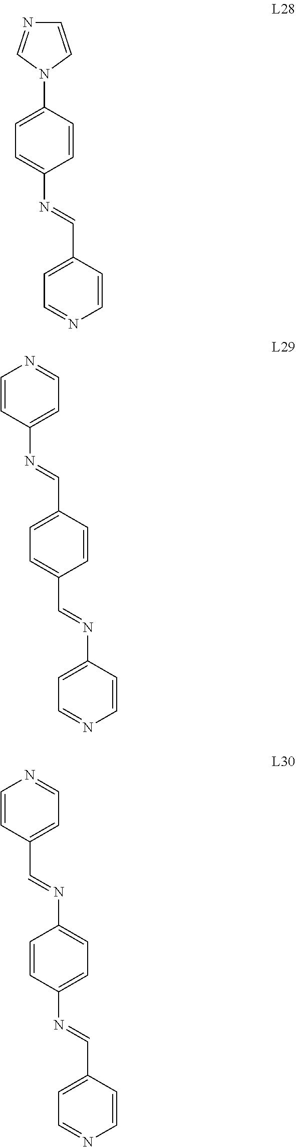 [SMILES: C(=N\c1ccc(-n2ccnc2)cc1)/c1ccncc1 ; C(=N\c1ccncc1)/c1ccc(/C=N/c2ccncc2)cc1 ; C(=N\c1ccc(/N=C/c2ccncc2)cc1)/c1ccncc1]

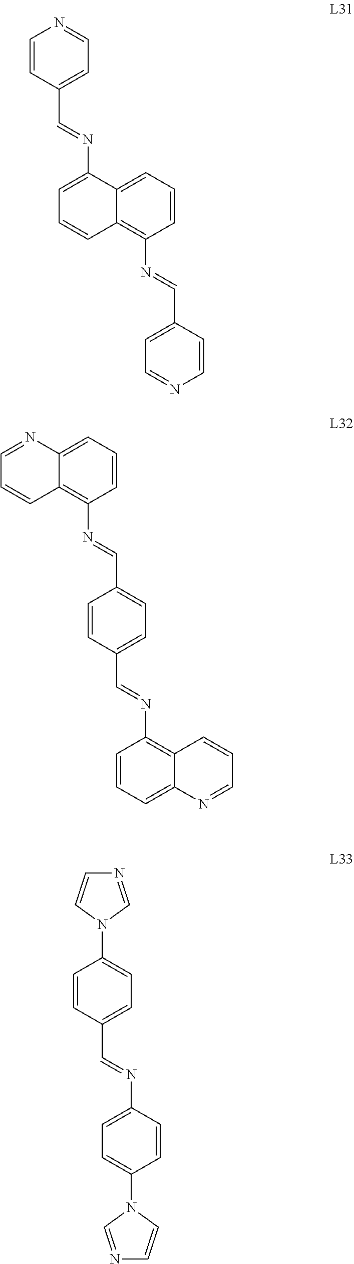 [SMILES: C(=N\c1cccc2c(/N=C/c3ccncc3)cccc12)/c1ccncc1 ; C(=N\c1cccc2ncccc12)/c1ccc(/C=N/c2cccc3ncccc23)cc1 ; C(=N\c1ccc(-n2ccnc2)cc1)/c1ccc(-n2ccnc2)cc1]

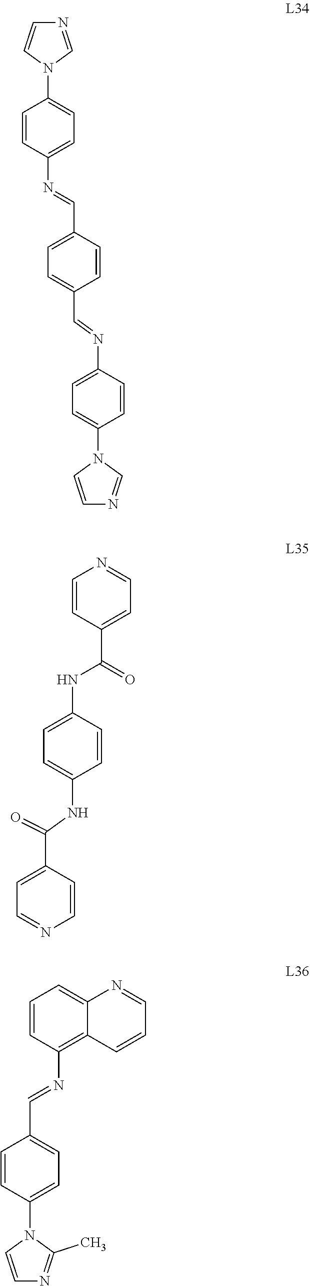 [SMILES: C(=N\c1ccc(-n2ccnc2)cc1)/c1ccc(/C=N/c2ccc(-n3ccnc3)cc2)cc1 ; O=C(Nc1ccc(NC(=O)c2ccncc2)cc1)c1ccncc1 ; Cc1nccn1-c1ccc(/C=N/c2cccc3ncccc23)cc1]

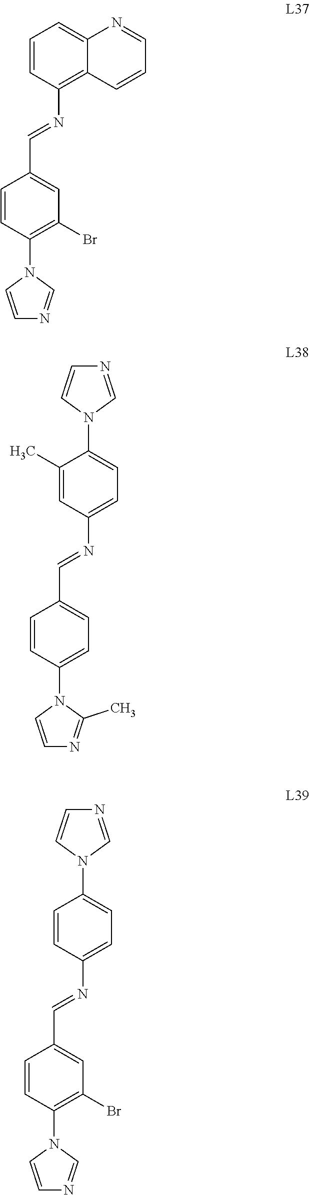 [SMILES: Brc1cc(/C=N/c2cccc3ncccc23)ccc1-n1ccnc1 ; Cc1cc(/N=C/c2ccc(-n3ccnc3C)cc2)ccc1-n1ccnc1 ; Brc1cc(/C=N/c2ccc(-n3ccnc3)cc2)ccc1-n1ccnc1]

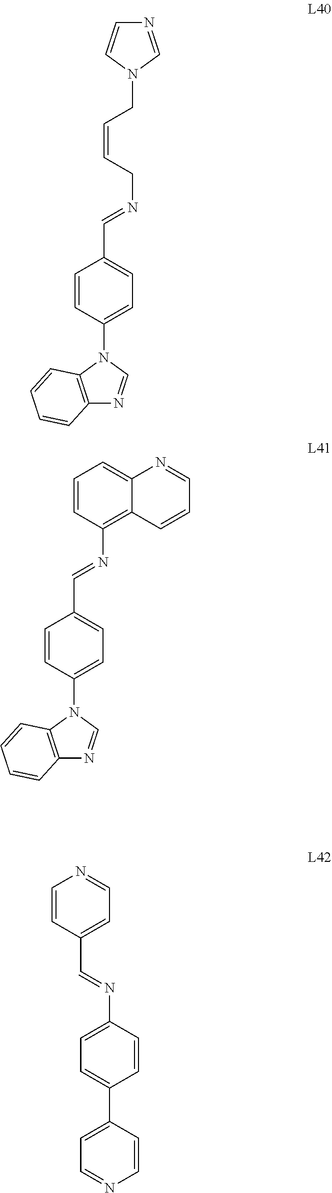 [SMILES: C(=C/Cn1ccnc1)/C/N=C/c1ccc(-n2cnc3ccccc32)cc1 ; C(=N\c1cccc2ncccc12)/c1ccc(-n2cnc3ccccc32)cc1 ; C(=N\c1ccc(-c2ccncc2)cc1)/c1ccncc1]

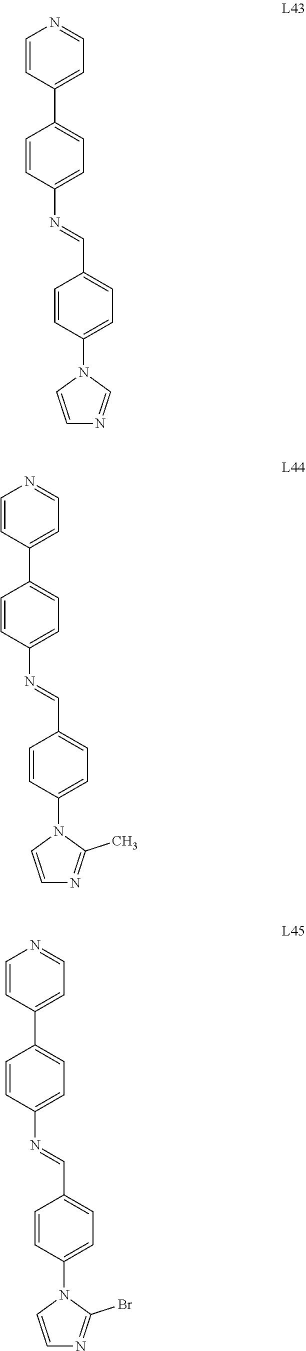 [SMILES: C(=N\c1ccc(-c2ccncc2)cc1)/c1ccc(-n2ccnc2)cc1 ; Cc1nccn1-c1ccc(/C=N/c2ccc(-c3ccncc3)cc2)cc1 ; Brc1nccn1-c1ccc(/C=N/c2ccc(-c3ccncc3)cc2)cc1]

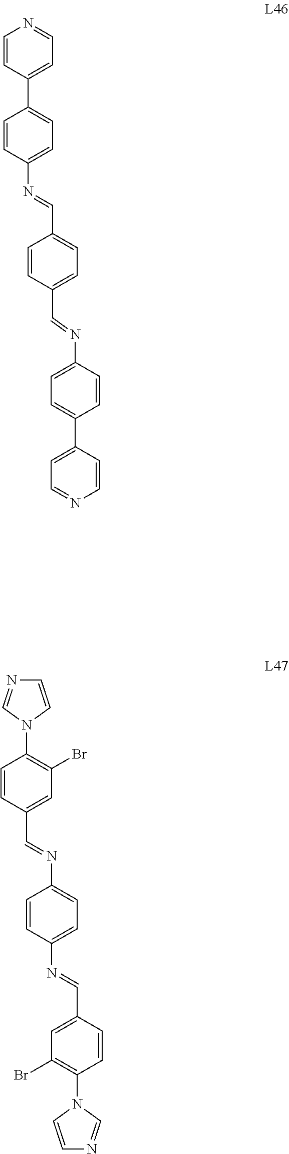 [SMILES: C(=N\c1ccc(-c2ccncc2)cc1)/c1ccc(/C=N/c2ccc(-c3ccncc3)cc2)cc1 ; Brc1cc(/C=N/c2ccc(/N=C/c3ccc(-n4ccnc4)c(Br)c3)cc2)ccc1-n1ccnc1]

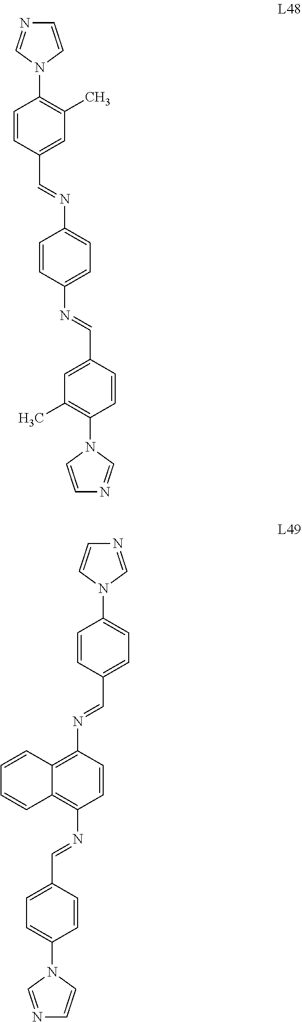 [SMILES: Cc1cc(/C=N/c2ccc(/N=C/c3ccc(-n4ccnc4)c(C)c3)cc2)ccc1-n1ccnc1 ; C(=N\c1ccc(/N=C/c2ccc(-n3ccnc3)cc2)c2ccccc12)/c1ccc(-n2ccnc2)cc1]

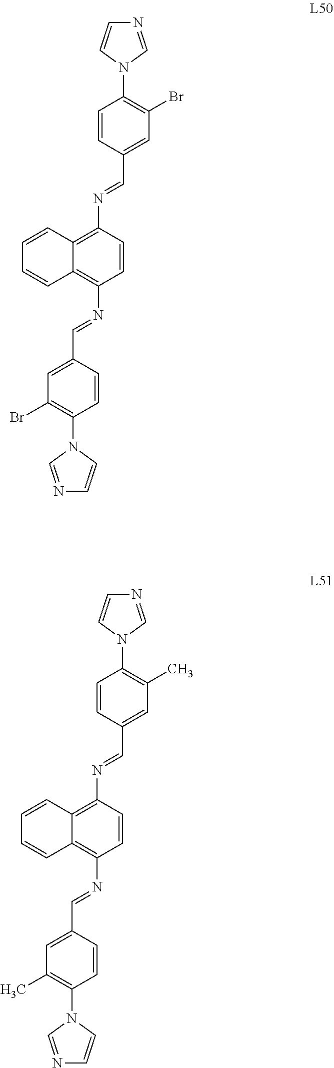 [SMILES: Brc1cc(/C=N/c2ccc(/N=C/c3ccc(-n4ccnc4)c(Br)c3)c3ccccc23)ccc1-n1ccnc1 ; Cc1cc(/C=N/c2ccc(/N=C/c3ccc(-n4ccnc4)c(C)c3)c3ccccc23)ccc1-n1ccnc1]

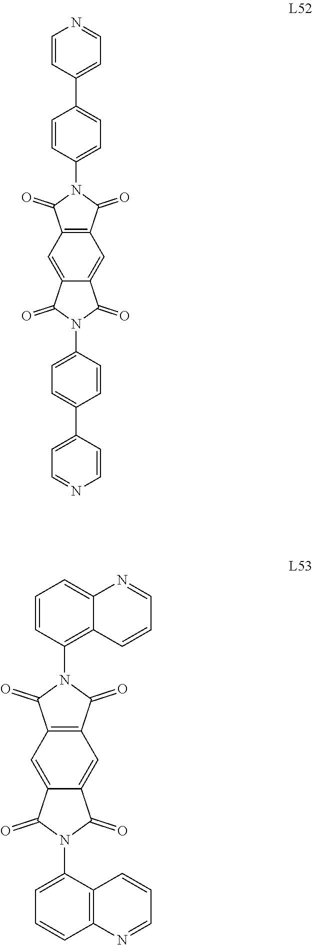 [SMILES: O=c1c2cc3c(=O)n(-c4ccc(-c5ccncc5)cc4)c(=O)c3cc2c(=O)n1-c1ccc(-c2ccncc2)cc1 ; O=c1c2cc3c(=O)n(-c4cccc5ncccc45)c(=O)c3cc2c(=O)n1-c1cccc2ncccc12]

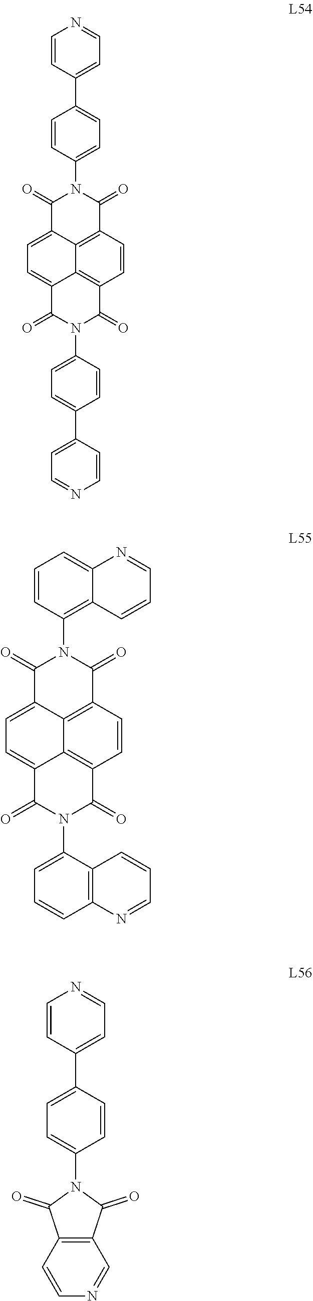 [SMILES: O=C1c2ccc3c4c(ccc(c24)C(=O)N1c1ccc(-c2ccncc2)cc1)C(=O)N(c1ccc(-c2ccncc2)cc1)C3=O ; O=C1c2ccc3c4c(ccc(c24)C(=O)N1c1cccc2ncccc12)C(=O)N(c1cccc2ncccc12)C3=O ; O=C1c2ccncc2C(=O)N1c1ccc(-c2ccncc2)cc1]

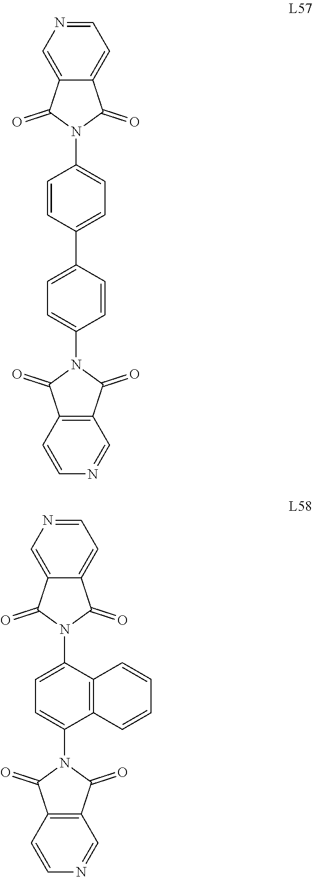 [SMILES: O=C1c2ccncc2C(=O)N1c1ccc(-c2ccc(N3C(=O)c4ccncc4C3=O)cc2)cc1 ; O=C1c2ccncc2C(=O)N1c1ccc(N2C(=O)c3ccncc3C2=O)c2ccccc12]

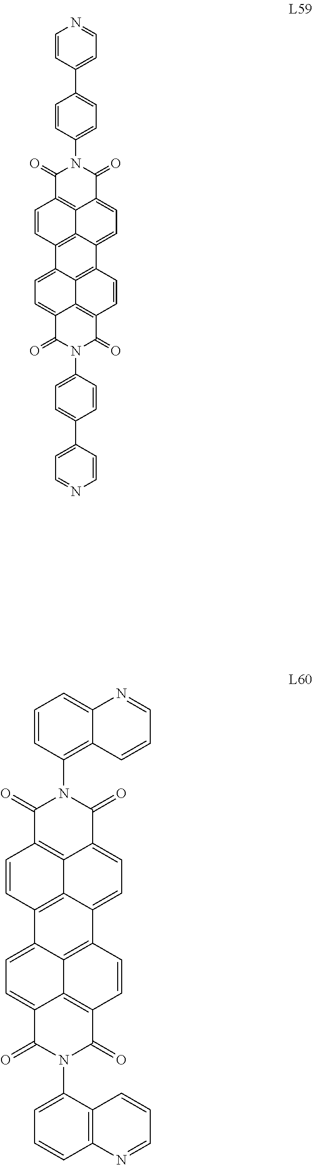 [SMILES: O=C1c2ccc3c4ccc5c6c(ccc(c7ccc(c2c37)C(=O)N1c1ccc(-c2ccncc2)cc1)c64)C(=O)N(c1ccc(-c2ccncc2)cc1)C5=O ; O=C1c2ccc3c4ccc5c6c(ccc(c7ccc(c2c37)C(=O)N1c1cccc2ncccc12)c64)C(=O)N(c1cccc2ncccc12)C5=O]

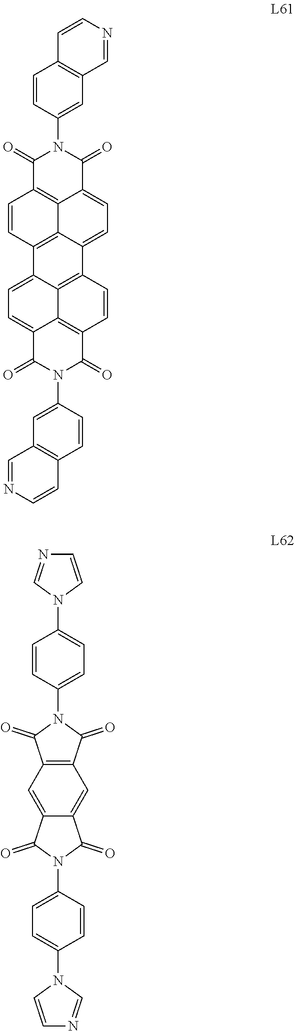 [SMILES: O=C1c2ccc3c4ccc5c6c(ccc(c7ccc(c2c37)C(=O)N1c1ccc2ccncc2c1)c64)C(=O)N(c1ccc2ccncc2c1)C5=O ; O=c1c2cc3c(=O)n(-c4ccc(-n5ccnc5)cc4)c(=O)c3cc2c(=O)n1-c1ccc(-n2ccnc2)cc1]

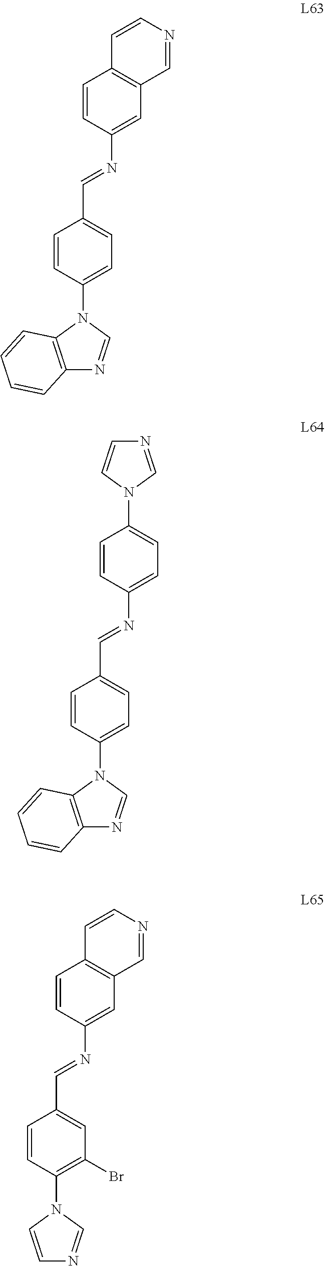 [SMILES: C(=N\c1ccc2ccncc2c1)/c1ccc(-n2cnc3ccccc32)cc1 ; C(=N\c1ccc(-n2ccnc2)cc1)/c1ccc(-n2cnc3ccccc32)cc1 ; Brc1cc(/C=N/c2ccc3ccncc3c2)ccc1-n1ccnc1]

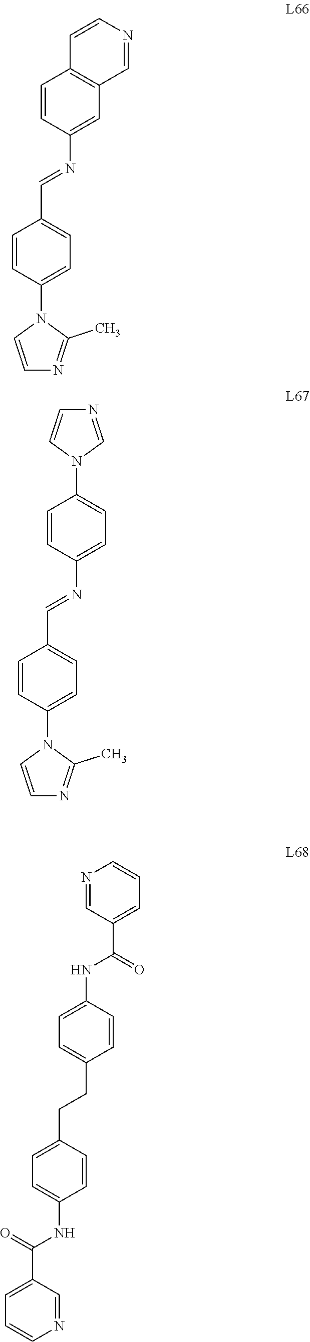

In some embodiments, L1 to L68 may be optionally substituted with one or more of C₁₋₆alkyl, C₁₋₆alkoxy, hydroxyl, halogen, cyano, or amino (e.g., unsubstituted, mono, or disubstituted with C₁₋₆alkyl).

In some embodiments, bidentate ligands for use herein include optionally substituted compounds (L1) to (L10) listed above.

In some embodiments, bidentate nitrogen ligands for use herein include 4,4′-bipyridine (L1), 1,4-bis(4-pyridyl)benzene (L2), 4,4′-(2,5-dimethyl-1,4-phenylene)dipyridine (L3), 1,4-bis(4-pyridyl)biphenyl (L4) and 1,2-di(pyridine-4-yl)-ethene (L5).

In some embodiments, bidentate nitrogen ligands for use herein include 4,4′-bipyridine (L1), 1,4-bis(4-pyridyl)benzene (L2), 4,4′-(2,5-dimethyl-1,4-phenylene)dipyridine (L3) and 1,4-bis(4-pyridyl)biphenyl (L4).

In some embodiments, the bidentate nitrogen ligand is 4,4′-bipyridine (L1) or 1,4-bis(4-(L4).

In some embodiments, the metal-organic material comprises an organic multidentate ligand having at least one donor nitrogen atom and one or more carboxylic acid residues. In some embodiments, compounds of this type include at least one nitrogen containing aromatic ring. Such compounds may be referred to herein as nitrogen-carboxylate ligands.

In some embodiments, other suitable compounds of this type include those based on other nitrogen containing aromatic heterocycles, which may contain one or more nitrogen atoms and optionally one or more further heteroatoms, for example, imidazole, pyrimidine, pyrrole, pyrazole, isoxazole and oxazole. Also suitable are compounds based on bicyclic aromatic heterocycles, for example indole, purine, isoindole, pteridine, quinoline, benzotriazole and isoquinoline. In some embodiments, these structures may be optionally substituted. In some embodiments, these structures may be optionally substituted with one or more of C₁₋₆alkyl, C₁₋₆alkoxy, hydroxyl, halogen, cyano, or amino (e.g., unsubstituted, mono, or disubstituted with 6alkyl).

In some embodiments, suitable nitrogen-carboxylate ligands include compounds of formula

L69 to L128 (any one of which may be optionally substituted):

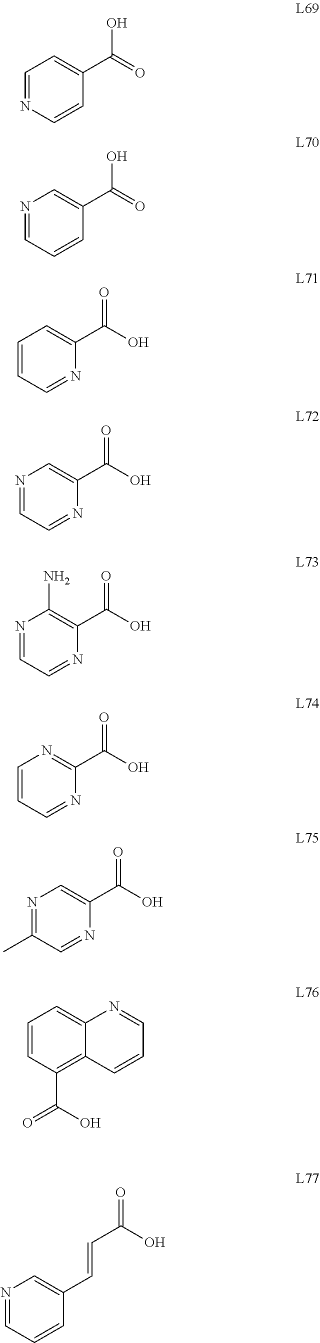

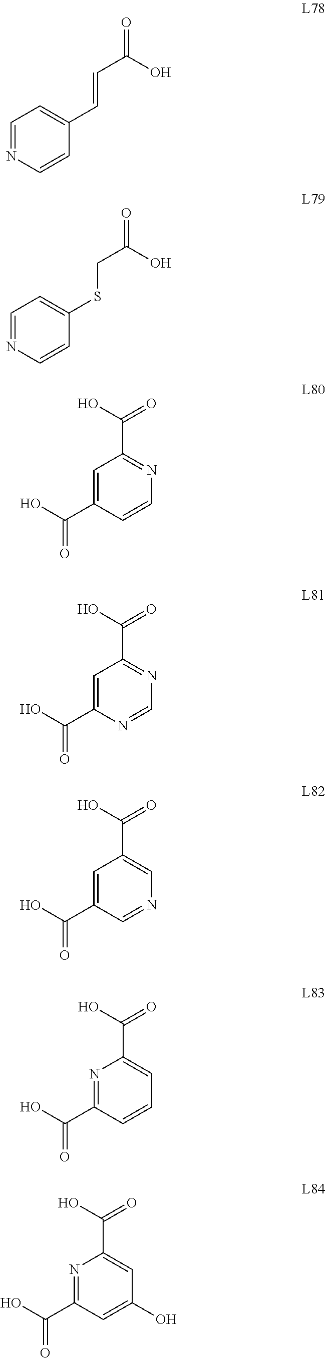

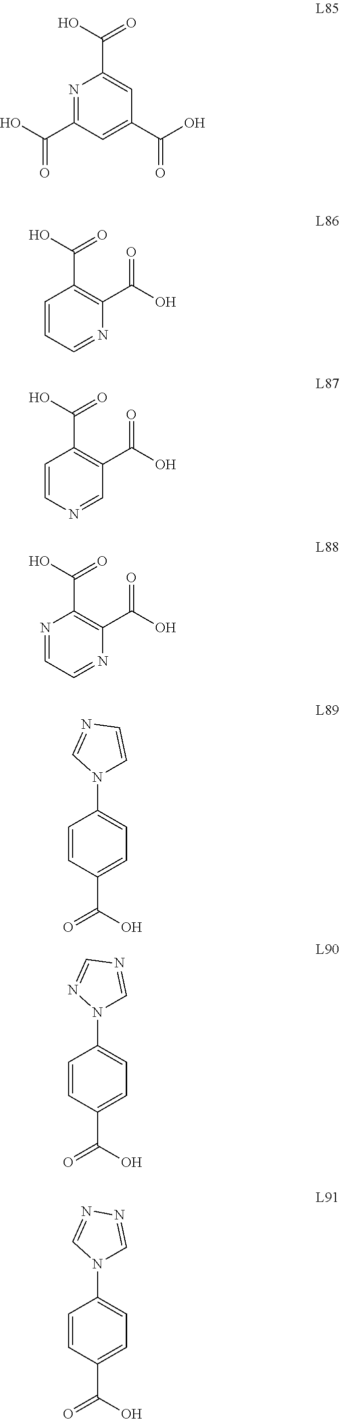

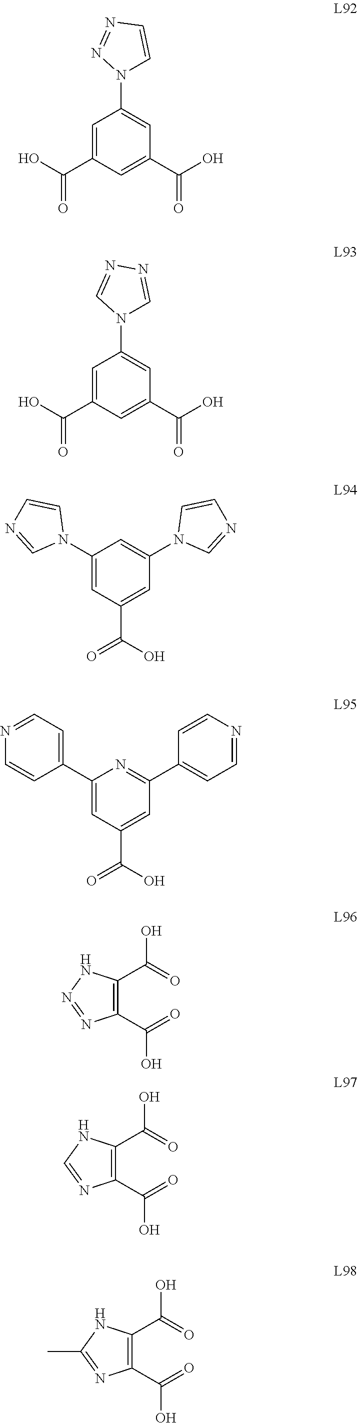

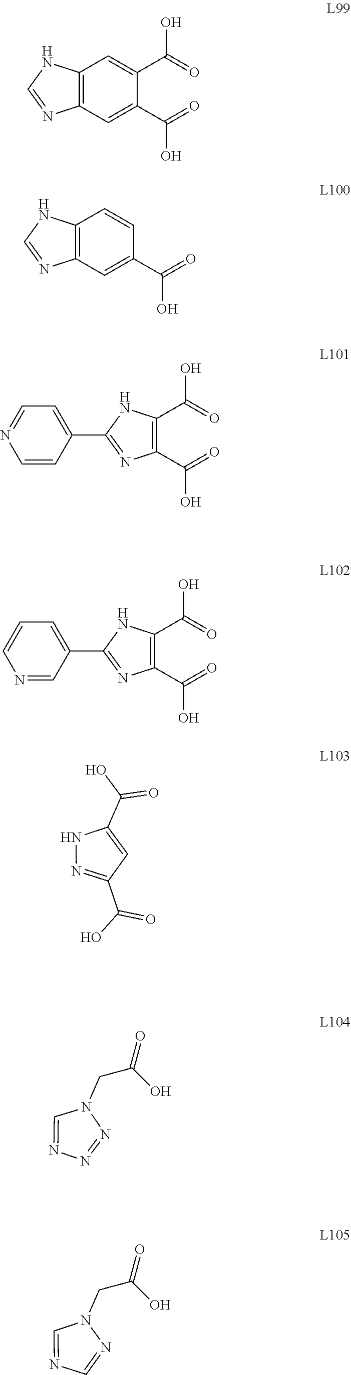

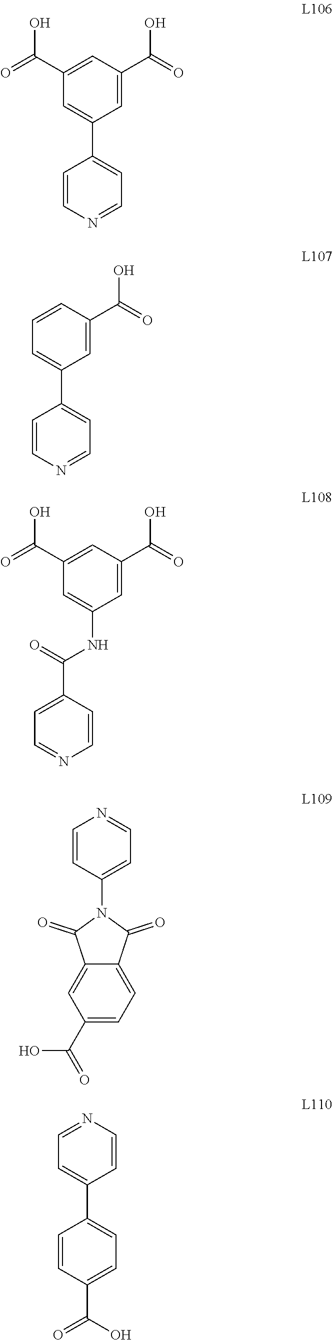

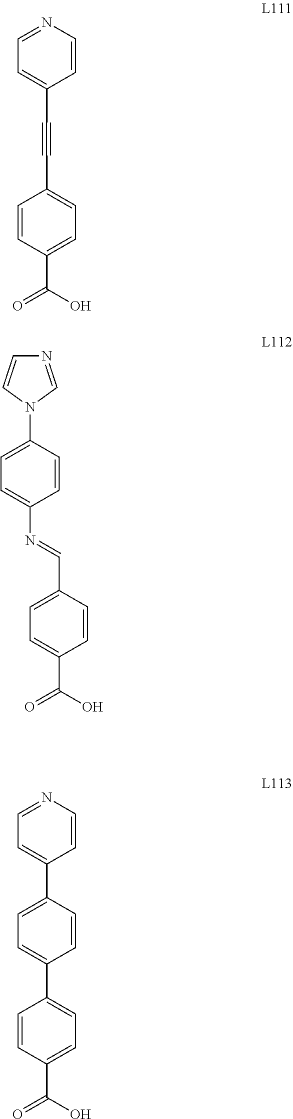 [SMILES: O=C(O)c1ccc(C#Cc2ccncc2)cc1 ; O=C(O)c1ccc(/C=N/c2ccc(-n3ccnc3)cc2)cc1 ; O=C(O)c1ccc(-c2ccc(-c3ccncc3)cc2)cc1]

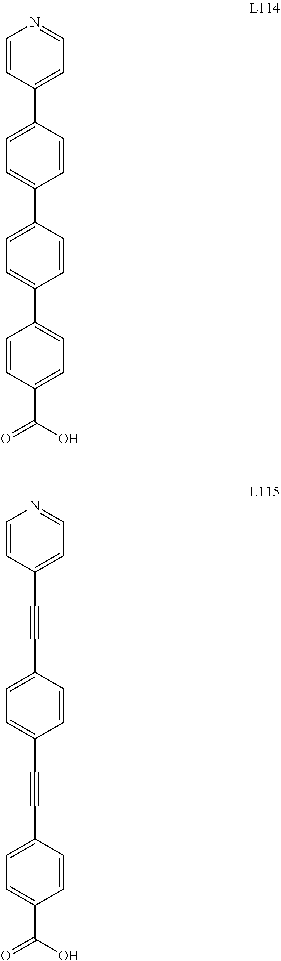 [SMILES: O=C(O)c1ccc(-c2ccc(-c3ccc(-c4ccncc4)cc3)cc2)cc1 ; O=C(O)c1ccc(C#Cc2ccc(C#Cc3ccncc3)cc2)cc1]

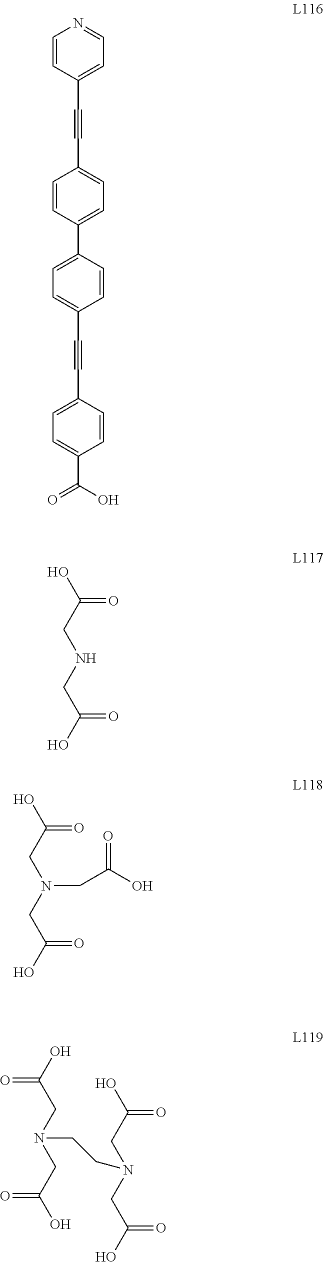 [SMILES: O=C(O)c1ccc(C#Cc2ccc(-c3ccc(C#Cc4ccncc4)cc3)cc2)cc1 ; O=C(O)CNCC(=O)O ; O=C(O)CN(CC(=O)O)CC(=O)O ; O=C(O)CN(CCN(CC(=O)O)CC(=O)O)CC(=O)O]

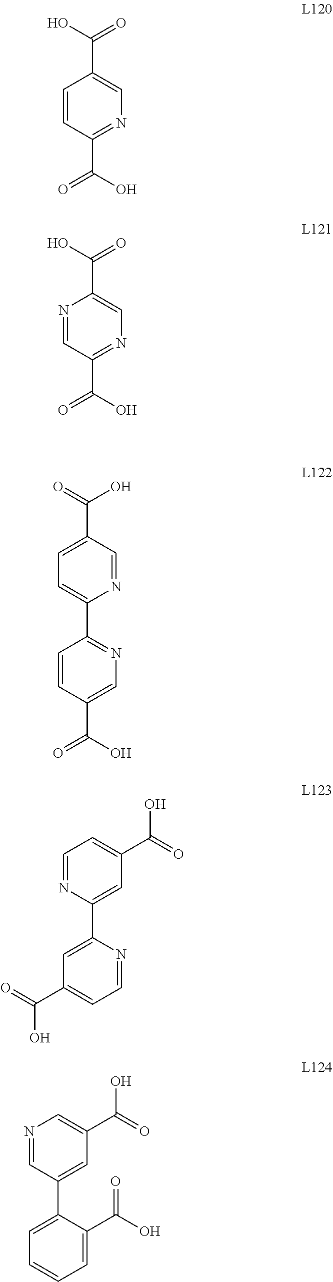 [SMILES: O=C(O)c1ccc(C(=O)O)nc1 ; O=C(O)c1cnc(C(=O)O)cn1 ; O=C(O)c1ccc(-c2ccc(C(=O)O)cn2)nc1 ; O=C(O)c1ccnc(-c2cc(C(=O)O)ccn2)c1 ; O=C(O)c1cncc(-c2ccccc2C(=O)O)c1]

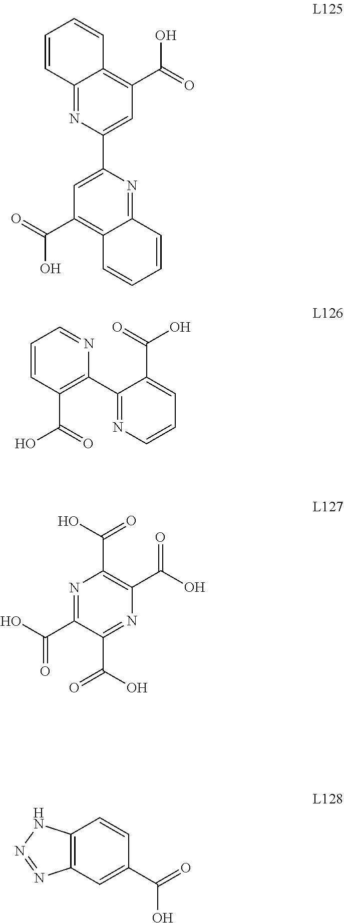

In some embodiments, structures L69 to L128 may be optionally substituted with one or more of C₁₋₆alkyl, C₁₋₆alkoxy, hydroxyl, halogen, cyano, or amino (e.g., unsubstituted, mono, or disubstituted with C₁₋₆alkyl).

In some embodiments, ligands of this type include benzotriazole-5-carboxylic acid (L128) and 2,4-pyridinedicarboxylic acid (L80).

In some embodiments, the metal-organic material comprises an organic multidentate ligand having at least two carboxylic acid residues. These compounds may be referred to herein as polycarboxylate ligands.

In some embodiments, suitable polycarboxylate ligands include compounds of formula L129 to L198 (any one of which may be optionally substituted):

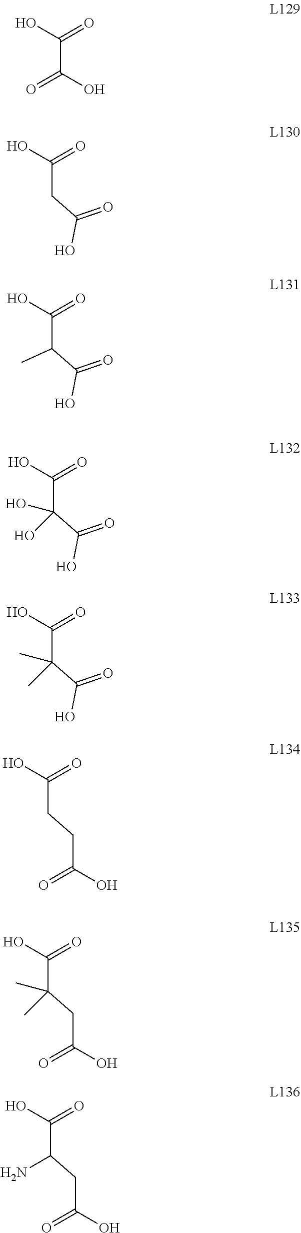

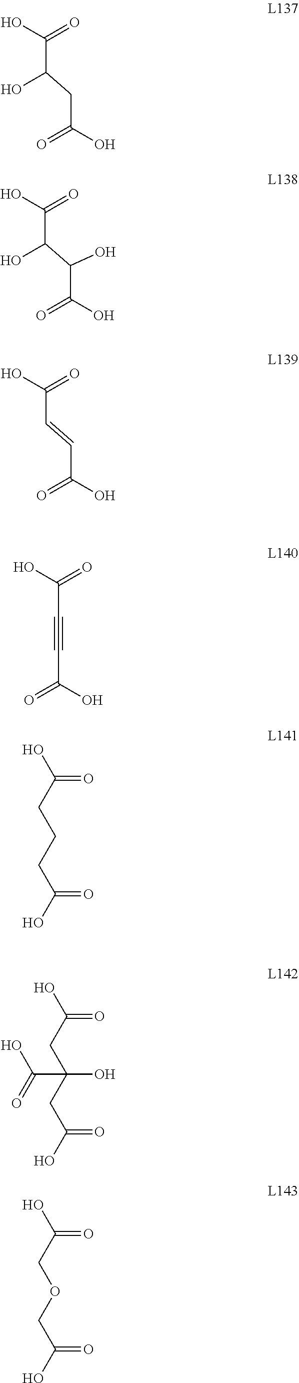

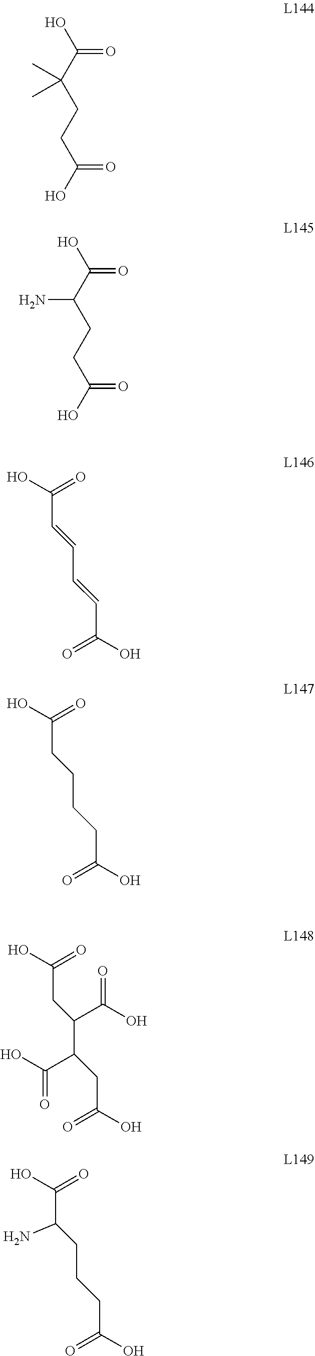 [SMILES: CC(C)(CCC(=O)O)C(=O)O ; NC(CCC(=O)O)C(=O)O ; O=C(O)/C=C/C=C/C(=O)O ; O=C(O)CCCCC(=O)O ; O=C(O)CC(C(=O)O)C(CC(=O)O)C(=O)O ; NC(CCCC(=O)O)C(=O)O]

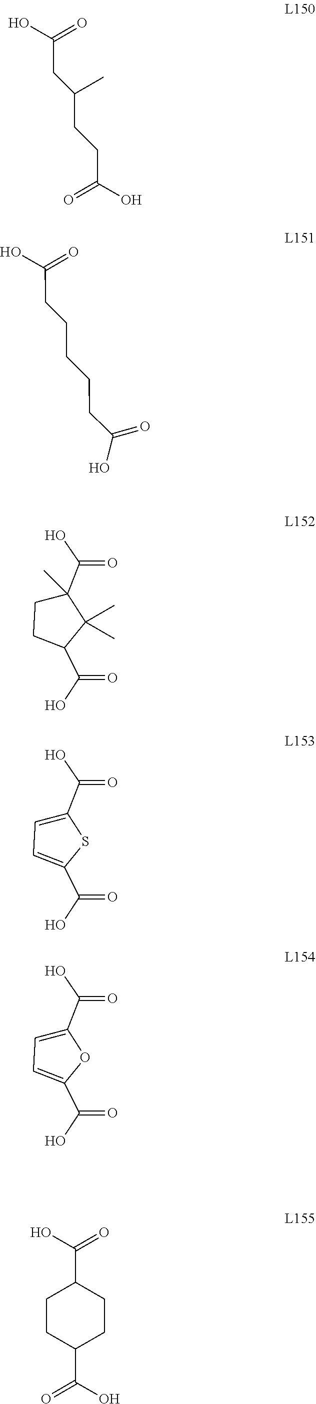

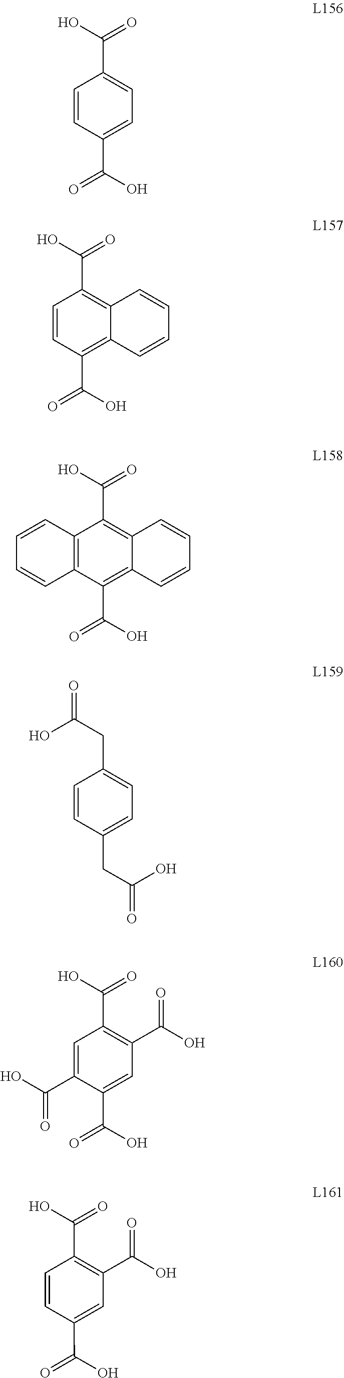 [SMILES: O=C(O)c1ccc(C(=O)O)cc1 ; O=C(O)c1ccc(C(=O)O)c2ccccc12 ; O=C(O)c1c2ccccc2c(C(=O)O)c2ccccc12 ; O=C(O)Cc1ccc(CC(=O)O)cc1 ; O=C(O)c1cc(C(=O)O)c(C(=O)O)cc1C(=O)O ; O=C(O)c1ccc(C(=O)O)c(C(=O)O)c1]

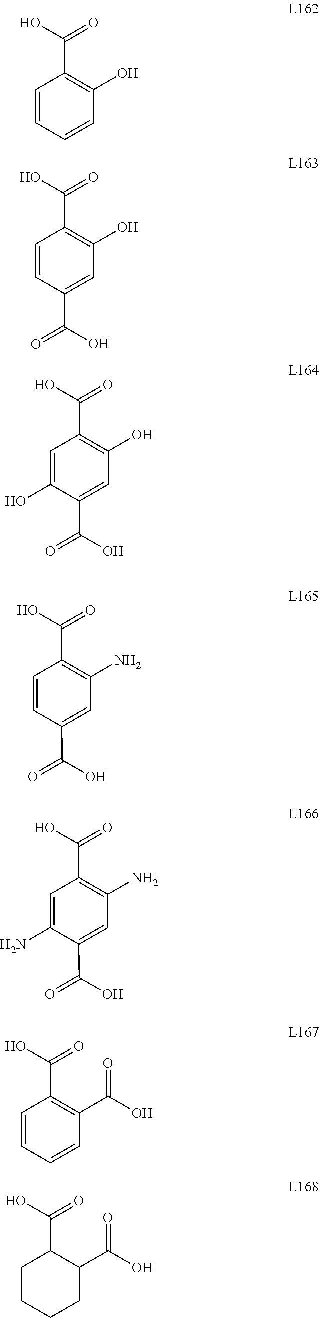

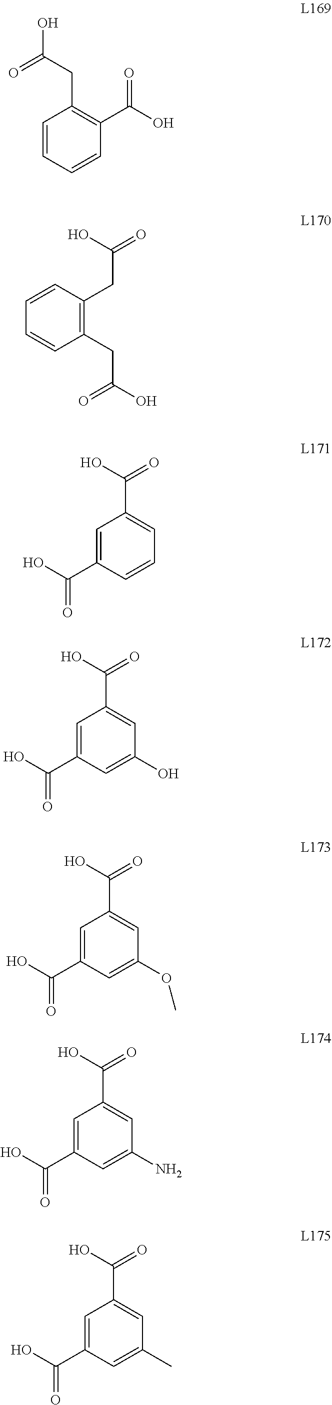

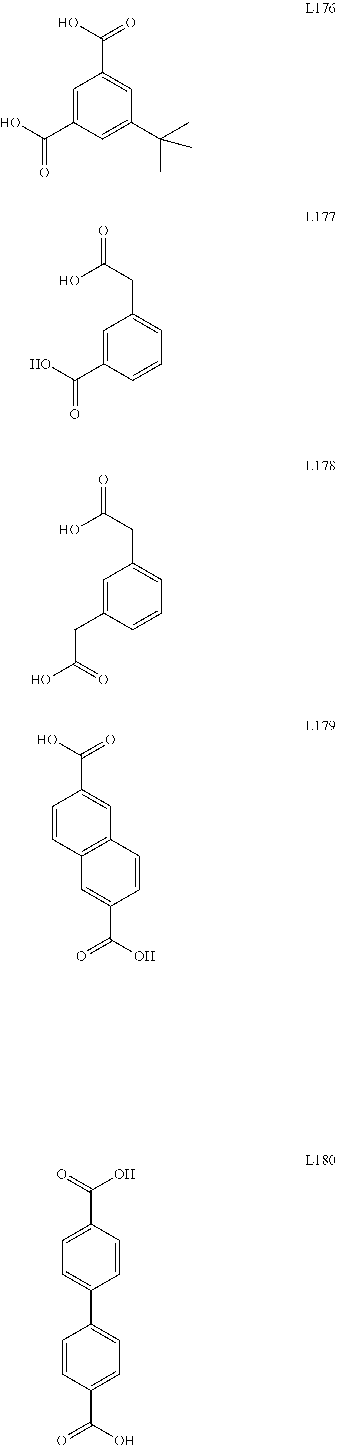 [SMILES: CC(C)(C)c1cc(C(=O)O)cc(C(=O)O)c1 ; O=C(O)Cc1cccc(C(=O)O)c1 ; O=C(O)Cc1cccc(CC(=O)O)c1 ; O=C(O)c1ccc2cc(C(=O)O)ccc2c1 ; O=C(O)c1ccc(-c2ccc(C(=O)O)cc2)cc1]

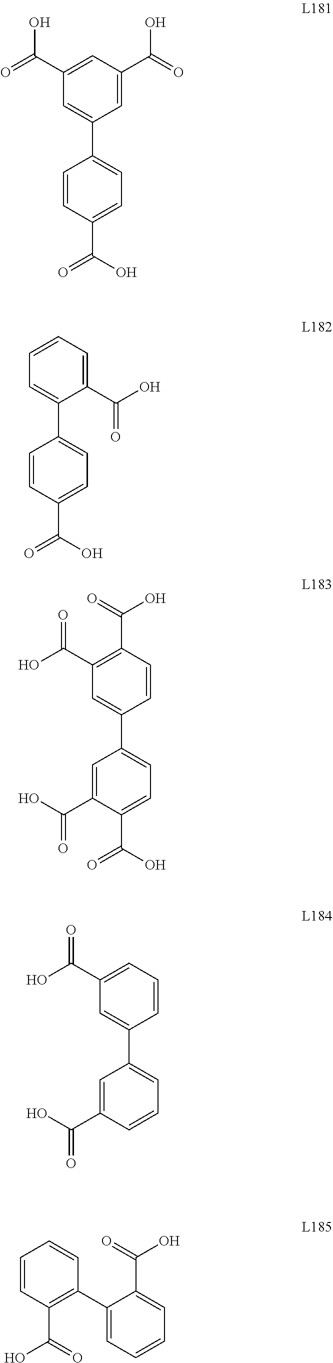

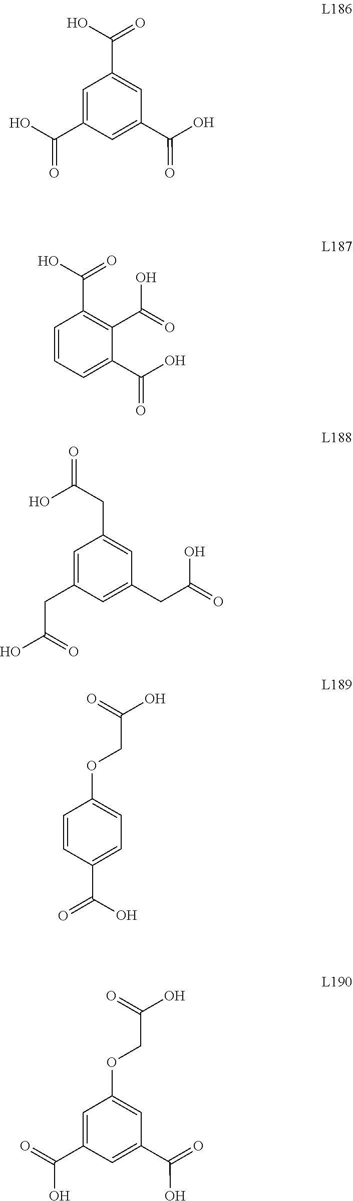 [SMILES: O=C(O)c1cc(C(=O)O)cc(C(=O)O)c1 ; O=C(O)c1cccc(C(=O)O)c1C(=O)O ; O=C(O)Cc1cc(CC(=O)O)cc(CC(=O)O)c1 ; O=C(O)COc1ccc(C(=O)O)cc1 ; O=C(O)COc1cc(C(=O)O)cc(C(=O)O)c1]

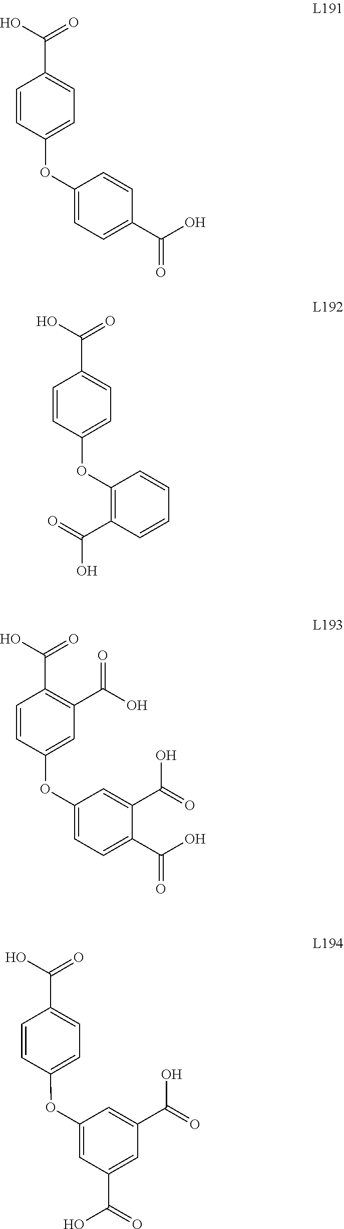 [SMILES: O=C(O)c1ccc(Oc2ccc(C(=O)O)cc2)cc1 ; O=C(O)c1ccc(Oc2ccccc2C(=O)O)cc1 ; O=C(O)c1ccc(Oc2ccc(C(=O)O)c(C(=O)O)c2)cc1C(=O)O ; O=C(O)c1ccc(Oc2cc(C(=O)O)cc(C(=O)O)c2)cc1]

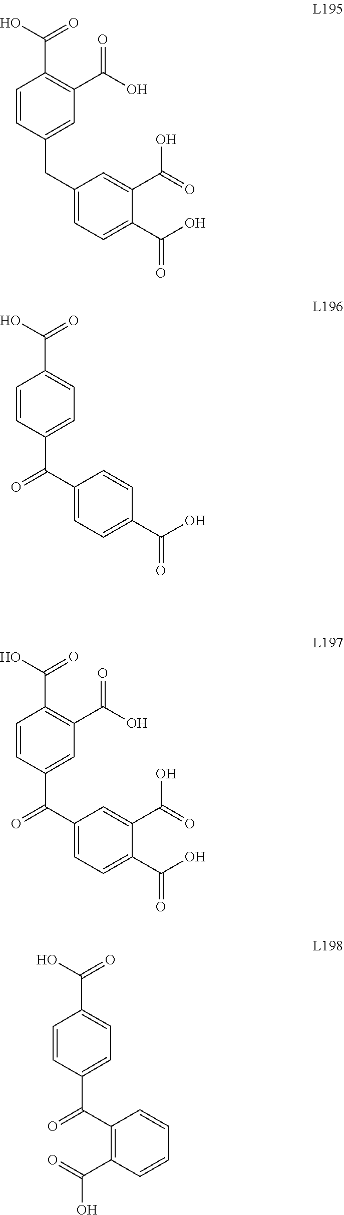 [SMILES: O=C(O)c1ccc(Cc2ccc(C(=O)O)c(C(=O)O)c2)cc1C(=O)O ; O=C(O)c1ccc(C(=O)c2ccc(C(=O)O)cc2)cc1 ; O=C(c1ccc(C(=O)O)c(C(=O)O)c1)c1ccc(C(=O)O)c(C(=O)O)c1 ; O=C(O)c1ccc(C(=O)c2ccccc2C(=O)O)cc1]

In some embodiments, structures L129 to L198 may be optionally substituted with one or more of C₁₋₆alkyl, C₁₋₆alkoxy, hydroxyl, halogen, cyano, or amino (e.g., unsubstituted, mono, or disubstituted with C₁₋₆alkyl).

In some embodiments, ligands of this type include glutaric acid (L141) and benzene-1,4-dicarboxylic acid (L156).

In some embodiments, Step (a) of the method involves providing a metal-organic material.

In some embodiments, the metal-organic material suitably comprises metal species and ligands.

In some embodiments, It may further comprise one or more anions.

In some embodiments, the metal-organic material comprises metal species, ligands and anions.

In some embodiments, the anions may be coordinated to the metal species (as ligands) or may be incorporated elsewhere in the lattice.

In some embodiments, any suitable anions may be included. In some embodiments, in view of the disclosure herein, suitable anions will be known to the person skilled in the art and include, for example, hydroxide, halide, carboxylate, nitrate, nitrite, sulfate, sulfite, phosphate, phosphite, borate, oxide, fluro oxyanion, triflate, complex oxyanion, chlorate, bromate, iodate, nitride, tetrafluoroborate, hexafluorophosphate, cyanate and isocyanate.

In some embodiments, the metal-organic material may optionally comprise in one of its structural forms one or more solvent moieties. In some embodiments, the solvent moiety may be water, an alcohol or other small organic molecule, for example a hydrocarbon compound, an oxygenated hydrocarbon or a halogenated carbon. In some embodiments, the solvent moieties include water, methanol, ethanol and α,α,α-trifluorotoluene.

In some embodiments, the solvent species may form a coordination bond such as a coordinate covalent bond with the metal species or may be incorporated elsewhere in the lattice.

In some embodiments, solvent molecules may be present in the crystal structure of the metal-organic material as a result of its preparation process. In some embodiments, the active material used to capture water does not contain any solvent molecules within its crystal structure and/or is substantially devoid of solvent molecules.

In some embodiments, two classes of metal-organic materials have been found to yield surprising results for capturing water from air. The first class of materials are porous metal-organic framework materials comprising pores which have a hydrophobic pore window and a hydrophilic internal pore surface. The second class of materials are two-dimensional layered materials. Each of these classes of material will now be further described.

### Porous Metal-Organic Framework Materials

Some embodiments pertain to the use of porous metal-organic framework materials comprising pores which have a hydrophobic pore window and a hydrophilic internal pore surface. Some embodiments may suitably provide the use of a porous metal-organic framework material comprising pores which have a hydrophobic pore window and a hydrophilic internal pore surface to capture water from air.

In some embodiments, hydrophobic atoms have absolute value of δ charge close to 0. In some embodiments, hydrophilic atoms have large absolute value of ϵ charge. Examples of hydrophobic atoms are H and C atoms in aliphatic or aromatic hydrocarbons. Examples of hydrophilic moieties are —OH, —NH₂ groups.

In some embodiments, pore shapes of porous materials are generally complex and cannot be fitted to simple geometric shapes (e.g. cube, sphere). In some embodiments, one of the possible approximations to describe the pore shapes is to use sizes of the spheres that could be inscribed into the pores. In some embodiments, using this approach, the pore diameter 2 can be determined as the diameter of the largest included sphere that can fit in the pore. The pore window size 1 can be determined as the diameter of the largest free sphere that can be inscribed in the pore. This is illustrated in FIG. 33, which also shows the internal surface of the pore 3 (the pore wall). In some embodiments, for the porous materials disclosed herein, the internal surface is substantially hydrophilic in nature and the outer surface 4 of the pore window is substantially hydrophobic in nature.

In some embodiments, the porous metal-organic framework materials suitable for use herein are microporous materials. In some embodiments, the microporous materials have pore diameters of less than or equal to about: 5 nm, 2 nm, 10 Å, 8 Å, 7.5 Å or ranges spanning and/or including the aforementioned values. In some embodiments, the porous metal-organic framework materials have a pore diameter of less than or equal to about: 10 Å, 8 Å, or 7.5 Å.

In some embodiments, the porous metal-organic framework materials for use herein comprise metal species and ligands as previously described.

In some embodiments, the porous metal-organic framework materials comprise a metal species and one or more ligands.

In some embodiments, the metal species is selected from copper, cobalt, nickel, iron, zinc, cadmium, zirconium, magnesium, calcium and aluminium.

In some embodiments, the metal species is selected from Cu²⁺, Co²⁺, Ni²⁺, Fe²⁺, Fe³⁺, Zn²⁺, Cd²⁺, Zr⁴⁺, Mg²⁺, Ca²⁺ and Al³⁺.

In some embodiments, the metal species for the porous metal-organic framework material is selected from transition metals and magnesium.

In some embodiments, the metal species for the porous metal-organic framework material is selected from copper, cobalt, zirconium, zinc and magnesium.

In some embodiments, ligands for forming the porous metal-organic framework materials have one or more nitrogen donor atoms and/or one or more carboxylic acid (COOH) groups.

In some embodiments, the porous metal-organic framework materials comprise two or more types of ligand.

In some embodiments, the porous metal-organic framework materials include at least one ligand including a carboxylic acid residue.

In some embodiments, the porous metal-organic framework material includes a ligand including a nitrogen donor atom and a ligand including a COOH group. In some embodiments, the nitrogen donor atom and the COOH group may be part of the same ligand or they may be provided by two different ligands.

In some embodiments, the ligands of the porous metal-organic framework material are suitably selected from bidentate nitrogen ligands, nitrogen-carboxylate ligands and polycarboxylate ligands.

In some embodiments, the bidentate nitrogen ligands are selected from compounds L1 to L68.

In some embodiments, the bidentate nitrogen ligands are selected from compounds compounds L1 to L5.

In some embodiments, the nitrogen-carboxylate ligands are selected from the compounds having the structures L69 to L128. In some embodiments, the nitrogen-carboxylate ligands are selected from the compounds having the structures benzotriazole-5-carboxylic acid (L128) and 2,4-pyridinedicarboxylic acid (L80).

In some embodiments, the polycarboxylate ligands are selected from the compounds having the structures L129 to L198 and especially glutaric acid (L141) and benzene-1,4-dicarboxylic acid (L156). Pp In some embodiments, the porous metal-organic framework materials include one or more ligands selected from 4,4′-bipyridine (L1), 1,2-di(pyridine-4-yl)-ethene (L5), glutaric acid (L141), benzotriazole-5-carboxylic acid (L128), 2,4-pyridinedicarboxylic acid (L80) and benzene-1,4-dicarboxylic acid (L156).

In some embodiments, the porous metal-organic framework materials used in the present invention include one or more ligands selected from 4,4′-bipyridine (L1), 1,2-di(pyridine-4-yl)-ethene (L5), glutaric acid (L141), benzotriazole-5-carboxylic acid (L128), benzene-1,4-dicarboxylic acid (L156) and 2,4-pyridinedicarboxylic acid (L80).

In some embodiments, the porous metal-organic framework material comprises a metal species selected from copper, zirconium, magnesium and cobalt and one or more ligands selected from 4,4′-bipyridine (L1), 1,2-di(pyridine-4-yl)-ethene (L5), glutaric acid (L141), benzotriazole-5-carboxylic acid (L128), benzene-1,4-dicarboxylic acid (L156) and 2,4-pyridinedicarboxylic acid (L80).

In some embodiments, the porous metal-organic framework material comprises a metal species selected from copper and cobalt and one or more ligands selected from 4,4′-bipyridine (L1), 1,2-di(pyridine-4-yl)-ethene (L5), glutaric acid (L141), benzotriazole-5-carboxylic acid (L128) and 2,4-pyridinedicarboxylic acid (L80).

In some embodiments, the porous metal-organic framework material comprises Cu²⁺, 4,4′-bipyridine and glutarate. In some embodiments, water may be present in some crystal forms. In some embodiments, this compound may be referred to herein as [Cu₂(glutarate)₂(4,4′-bipyridine)] or ROS-037.

In some embodiments, the porous metal-organic framework material comprises Cu²⁺, 1,2-di(pyridine-4-yl)-ethene and glutarate. In some embodiments, water may be present in some crystal forms. In some embodiments, this compound may be referred to herein as [Cu₂(glutarate)₂(1,2-di(pyridine-4-yl)-ethene)] or AMK-059.

In some embodiments, the porous metal-organic framework material comprises Co²⁺, 2,4-pyridinedicarboxylic acid and hydroxide. In some embodiments, water may be present in some crystal forms. In some embodiments, this compound may be referred to herein as [Co₃(μ₃-OH)₂(2,4-pyridinedicarboxylate)₂] or Co—CUK-1.

In some embodiments, the the porous metal-organic framework material comprises Mg²⁺, 2,4-pyridinedicarboxylic acid and hydroxide. In some embodiments, water may be present in some crystal forms. In some embodiments, this compound may be referred to herein as [Mg₃(μ₃-OH)₂(2,4-pyridinedicarboxylate)₂] or Mg—CUK-1.

In some embodiments, the porous metal-organic framework material comprises Co²⁺, benzotriazole-5-carboxylic acid (H₂btca) and hydroxide. In some embodiments, water may be present in some crystal forms. In some embodiments, this compound may be referred to herein as [Co₃(μ₃-OH)₂(benzotriazolate-5-carboxylate)₂].

In some embodiments, the porous metal-organic framework material comprises Zr⁴⁺, benzene-1,4-dicarboxylic acid and hydroxide. In some embodiments, water may be present in some crystal forms. In some embodiments, this compound may be referred to herein as [Zr₁₂O₈(μ₃-OH)₈(μ₂-OH)₆(benzene-1,4-dicarboxylate)₉] or hcp-UiO-66.

In some embodiments, the porous metal-organic framework material is selected from [Cu₂(glutarate)₂(4,4′-bipyridine)], [Cu₂(glutarate)₂(1,2-di(pyridine-4-yl)-ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)₂] and [Zr₁₂O₈(μ₃-OH)₈(μ_{b 2}-OH)₆(benzene-1,4-dicarboxylate)₉], or combinations thereof.

### Two-Dimensional Layered Materials

A further class of metal-organic materials suitable for use in the present invention are two-dimensional layered materials. In some embodiments, the two-dimensional layered materials of the invention comprise metal species and ligands as previously described elsewhere herein.

By two-dimensional layered material what is meant is materials in which atoms, ions or molecules are chemically bonded in two dimensions to form layers.

In some embodiments, the material will include multiple layers and weak intermolecular forces will exist between the layers. In some embodiments, strong bonding, such as coordinate covalent bonding, suitably is present in only two dimensions.

In some embodiments, the two-dimensional layered material comprises metal species and ligands.

In some embodiments, the metal species are suitably linked together by ligands in a first dimension and a second dimension.

In some embodiments, the ligands link the metal species to form a two-dimensional layered framework.

In some embodiments the layers of the two-dimensional material are in the form of a honeycomb lattice.

In some embodiments, the first and second dimensions are substantially perpendicular to one another. In some embodiments, the two-dimensional material comprises layers arranged in a square lattice.

In some embodiments, the square lattice comprises a unit of formula (I):

wherein M represents the metal species and L represents a ligand.

In some embodiments, the two-dimensional layered material comprises layers that are stacked on top of each other to create a three-dimensional lattice.

In some embodiments, there is no intramolecular bonding between said layers. By intramolecular bonding what is meant is bonding such as covalent bonding, including coordinate covalent bonding.

In some embodiments, there are intermolecular forces present between said layers. By intermolecular forces what is meant is forces such as hydrogen bonding, aromatic stacking interactions, permanent dipole-dipole interactions and London dispersion forces.

In some embodiments, the two-dimensional layered material may comprise layers that are stacked directly on top of one another such that the metal species lie directly on top of one another when viewed from above, comprising a unit cell of formula (II):

wherein M represents the metal species and L represents the ligand.

Alternatively the two-dimensional layered material may comprise layers that are stacked on top of one another such that the metal species are offset from one another when viewed from above.

In some embodiments, the metal species and ligands are in a square lattice arrangement.

In some embodiments, the two-dimensional layered material comprises a transition metal species and a bidentate nitrogen ligand (that may be optionally substituted).

In some embodiments, the two-dimensional layered material comprises a transition metal species and a bidentate nitrogen ligand selected from compounds L1 to L69 (that may be optionally substituted).

In some embodiments, the two-dimensional layered material comprises a transition metal species and a bidentate nitrogen ligand selected from compounds L1 to L4 (that may be optionally substituted).

In some embodiments, the two-dimensional layered material comprises a metal species selected from copper, cobalt, nickel, iron, zinc and cadmium and a bidentate nitrogen ligand.

In some embodiments, the two-dimensional layered material comprises a metal species selected from copper, cobalt and nickel and a bidentate nitrogen ligand.

In some embodiments, the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand.

In some embodiments, the two-dimensional layered material comprises a metal species selected from Cu²⁺, Co²⁺ and Ni²⁺ and a bidentate nitrogen ligand.

In some embodiments, the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand selected from compounds L1 to L69 (that may be optionally substituted).

In some embodiments, the two-dimensional layered material comprises a metal species selected from Cu²⁺, Co²⁺ and Ni²⁺ and a bidentate nitrogen ligand selected from compounds L1 to L69 (that may be optionally substituted).

In some embodiments, the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand selected from compounds L1 to L4 (that may be optionally substituted).

In some embodiments, the two-dimensional layered material comprises a metal species selected from Cu²⁺, Co²⁺ and Ni²⁺ and a bidentate nitrogen ligand selected from compounds L1 to L4.

In some embodiments, the two-dimensional layered material comprises Cu²⁺ and a bidentate nitrogen ligand selected from compounds L1 to L4.

In some embodiments, the two-dimensional layered material comprises Co²⁺and a bidentate nitrogen ligand selected from compounds L1 to L4.

In some embodiments, the two-dimensional layered material comprises Ni²⁺and a bidentate nitrogen ligand selected from compounds L1 to L4.

In some embodiments, the two-dimensional layered material further comprises one or more anions.

In some embodiments, the two-dimensional layered material suitably comprises metal species, ligands and anions. In preferred embodiments the metal species and ligands are in a square lattice arrangement.

In some embodiments, the anions may be coordinated to the metal species (e.g. as ligands) or may be incorporated elsewhere in the lattice (e.g. as extra framework counterions).

In some embodiments, any suitable anions may be included. In some embodiments, in view of the specification as filed, suitable anions will be known to the person skilled in the art and include, for example, halide, carboxylate, nitrate, nitrite, sulfate, sulfite, phosphate, phosphite, borate, oxide, fluro oxyanion, triflate, complex oxyanion, chlorate, bromate, iodate, nitride, tetrafluoroborate, hexafluorophosphate, cyanate and isocyanate.

In some embodiments, the anions are selected from BF₄⁻, NO₃⁻, CF₃SO₃⁻ and glutarate.

In some embodiments, the two-dimensional layered material comprises a metal species selected from Cu²⁺, Co²⁺ and Ni²⁺, a bidentate nitrogen ligand selected from compounds L1 to L4 and an anion selected from BF₄⁻, NO₃⁻, CF₃SO₃⁻ and glutarate.

In some embodiments, the two-dimensional layered material comprises Cu²⁺, 1,4-bis(4-pyridyl)biphenyl and BF₄⁻. In some embodiments, this material may be referred to herein as sql-3-Cu—BF₄.

In some embodiments, the two-dimensional layered material comprises Cu²⁺, 1,4-bis(4-pyridyl)benzene and BF₄⁻. In some embodiments, water and ethanol may be included in some crystal forms. In some embodiments, this material may be referred to herein as sql-2-Cu—BF₄.

In some embodiments, the two-dimensional layered material comprises Cu²⁺, 1,4-bis(4-pyridyl)benzene and CF₃SO₃⁻. In some embodiments, water and ethanol may be present in some crystal forms. In some embodiments, this material may be referred to herein as sql-2-Cu—OTf.

In some embodiments, the two-dimensional layered material comprises Cu²⁺, 4,4′-bipyridine and NO₃⁻. In some embodiments, TFT may be present in some crystal forms. In some embodiments, this compound may be referred to herein as sql-1-Cu—NO₃.

In some embodiments, the two-dimensional layered material comprises Cu²⁺, 4,4′-(2,5-dimethyl-1,4-phenylene)dipyridine and NO₃. In some embodiments, water may be present in some crystal forms. In some embodiments, this compound may be referred to herein as sql-A14-Cu—NO₃.

In some embodiments, the two-dimensional layered material comprises Co²⁺, 4,4′-bipyridine and NO₃. In some embodiments, TFT may be present in some crystal forms. In some embodiments, this material may be referred to herein as sql-1-Co—NO₃.

In some embodiments, the two-dimensional layered material comprises Ni²⁺, 4,4′-bipyridine and NO₃. In some embodiments, TFT may be present in some crystal forms. In some embodiments, this material may be referred to herein as sql-1-Ni—NO₃.

In some embodiments, the two-dimensional layered material is selected from sql-3-Cu—BF₄, sql-2-Cu—BF₄, sql-2-Cu—OTf, sql-1-Cu—NO₃, sql-A14-Cu—NO₃, sql-1-Co—NO₃ and sql-1-Ni—NO₃.

Some embodiments relate to the use of metal-organic materials to capture water from air. In some embodiments, these materials are suitably selected from porous metal-organic framework materials comprising pores which have a hydrophobic pore window and a hydrophilic internal pore surface and two-dimensional layered materials.

In some embodiments, metal-organic materials for use herein include [Cu₂(glutarate)₂(4,4′-bipyridine)], [Cu₂(glutarate)₂(1,2-di(pyridine-4-yl)-ethene)], [Co₃(μ₃-OH)₂(2,4-pyridinedicarboxylate)_{2], [}Mg₃(μ₃-OH)₂(2,4-pyridinedicarboxylate)₂], [Co₃(μ₃-OH)₂(benzotriazolate-5-carboxylate)₂], [Zr₁₂O₈(μ₃-OH)₈(μ₂-OH)₆(benzene-1,4-dicarboxylate)₉], sql-3-Cu—BF₄, sql-2-Cu—BF₄, sql-2-Cu—OTf, sql-1-Cu—NO₃, sql-A14-Cu—NO₃, sql-1-Co—NO₃ and sql-1-Ni—NO₃.

Some embodiments are characterised by metal-organic materials which switch from a first state to a second state upon contact with water and/or water vapour wherein the second state is able to retain a higher amount of water than the second state.

In some embodiments the switch from the first state to the second state may involve a change in the structure of the material. In other embodiments there is no change in the structure of the material itself, only in the amount of water it is able to hold.

In some embodiments, Step (b) of the method of the first aspect of the present invention involves contacting the metal-organic material with water and/or water vapour.

In some embodiments, by water we mean to refer to liquid water.

In some embodiments, by water vapour we mean to refer to water in vapour form.

Atmospheric air typically comprises water vapour. This is present in various humidities depending on the environment.

Suitably the content of water vapour in the air may be defined in terms of absolute humidity (AH) or relative humidity (RH). Absolute humidity refers to the measure of water vapour in the air regardless of the temperature of the air. Relative humidity refers to the measure of water vapour in the air relative to the temperature of the air. Relative humidity is expressed as the amount of water vapour in the air as a percentage of the total maximum amount that could be held at a particular temperature.

Relative humidities (RH) of 0 to 30% are considered herein to be low, those of 30 to 60% are considered to be medium and those of greater than 60% are considered to be high.

In some embodiments, step (b) involves providing sufficient water and/or water vapour to cause the metal-organic material to switch between the first state and the second state.

In some embodiments, step (b) involves contacting the metal-organic material with water vapour.

In some embodiments, step (b) involves contacting the metal-organic material with ambient air.

In some embodiments, step (b) involves contacting the metal-organic material with ambient air of sufficient humidity to cause the material to switch between the first state and the second state.

In some embodiments, the level of humidity needed to cause the material to switch between the first state and the second state will depend on the specific material.

In some embodiments, in its second state, the metal-organic material is able to retain a higher amount of water than in its first state.

In some embodiments, switching from the first state to the second state increases the amount of water the material can retain.

In some embodiments, by the amount of water the material is able to retain it is meant to refer to the amount of water the material is able to hold within its structure.

In some embodiments, switching between the first state and the second state does not involve a change in the structure of the material but does involve a change in the amount of water that can be retained by the material. Thus, in some embodiments, the material may switch from an empty state to a loaded state.

For example, without being bound by theory, in embodiments in which the metal-organic material is a porous metal-organic framework material comprising pores having a hydrophobic window and a hydrophilic internal pore surface, it is believed that the presence of the hydrophobic pore windows prevents water uptake at low humidity. However once a threshold humidity is reached, water is freely able to enter the pores and the hydrophilic pore walls permit a significant increase in the amount of water the material is able to retain.

In some embodiments switching from the first state to the second state may lead to an increase in the porosity of the metal-organic material.

In embodiments in which the metal-organic material is a two-dimensional layered material, switching from the first state to the second state may involve a change in the structure of the material. In some embodiments, when switching from the first state to the second state the two-dimensional layered material changes to a more open structure. In some embodiments, the first state may be regarded as a closed state or a closed phase and the second state may be regarded as an open state or an open phase.

In some embodiments the first state may be regarded as a closed state and the second state may be regarded as an open state.

In some embodiments the first state may be regarded as a lower porosity state and the second state may be regarded as a higher porosity state.

Porosity is a measure of empty space or voids in a material.

In some embodiments, the two-dimensional layered material is able to sorb water in cavities within the layer, herein referred to as intrinsic porosity.

In some embodiments, alternatively the two-dimensional layered material is able to sorb water between said layers, herein referred to as extrinsic porosity.

In some embodiments, the two-dimensional layered material displays both intrinsic and extrinsic porosity.

In some embodiments, the two-dimensional layered materials of the present invention comprise pores with an area about 7.5 Å×7.5 Å.

In some embodiments, the two-dimensional layered material has an interlayer distance of less than 5 Å.

In some embodiments switching between the first and second states of the metal-organic material occurs at low RH.

In some embodiments switching between the first and second states of the metal-organic material occurs at medium RH.

In some embodiments switching between the first and second states of the metal-organic material occurs at high RH.

In some embodiments, the metal-organic material is able to retain a higher amount of water in its second state than in its first state. In some embodiments, the water content retained by the metal-organic material may be measured as a percentage by weight relative to the weight of the material.

In some embodiments, in its second state the metal-organic material can hold about 5% (by weight) more water than in its first state, or at least about 10% more, or at least about 15% more.

In some embodiments the increase in the amount of water able to be retained by the metal-organic material is gradual. In other embodiments the increase is sudden.

In some embodiments, the sorption time required to reach 90% of the maximum capacity of water for the metal-organic material is greater than or equal to about: 2 hours, 8 hours, 12 hours, 1 day, or ranges spanning and/or including the aforementioned values. In some embodiments, the sorption time required to reach 90% of the maximum capacity of water for the metal-organic material is less than or equal to about: 2 hours, 1 hour, 30 minutes, 15 minutes, 10 minutes, 5 minutes, or ranges spanning and/or including the aforementioned values. In some embodiments, the desorption time required to reach 90% of water released from the metal-organic material is less than or equal to about: 1 day, 12 hours, 2 hours, 1 hour, 30 minutes, 15 minutes, 10 minutes, 5 minutes, or ranges spanning and/or including the aforementioned values.

In some embodiments, a significant increase in the amount of water able to be retained by the metal-organic material occurs once a threshold humidity is reached. In some embodiments, the amount of water able to be retained increases by at least about 10%, at least about 20%, or at least about 30% upon contact with water vapour of a threshold humidity, compared with the amount initially able to be retained.

In some embodiments, threshold humidity will depend on the particular metal-organic material.

Some embodiments may involve the use of a metal-organic material in a very dry environment (e.g. <10% RH). In some embodiments, the RH is less than or equal to: 20%, 15%, 10%, 5%, 2%, or ranges spanning and/or including the aforementioned values. Suitable materials for use in such environments include embodiments as disclosed elsewhere herein, including, sql-3-Cu—BF₄ and ROS-037.

In some embodiments, the metal-organic material of the present invention can be used to capture water from air. In some embodiments it can be used to store water.

In some embodiments, water is suitably stored by the metal-organic material in its second state.

In some embodiments, the metal-organic material may be able to store water for an extended period of time. For example the metal-organic material may be able to store water for several minutes. In some embodiments, the metal-organic material may be able to store water for several hours. In some embodiments, the metal-organic material may store water for a period of greater than or equal to 5 minutes, 10 minutes, 30 minutes, 1 hour, 2 hours, 4 hours, 6 hours, 24 hours, or ranges spanning and/or including the aforementioned values.

In some embodiments, water can be desorbed from the metal-organic material.

In some embodiments, the metal-organic material can switch from the first state to the second state and from the second state to the first state.

In some embodiments, the sorption and desorption processes occur at similar rates and follow a similar pathway. In some embodiments, the sorption and desorption processes occur at rates having differences of no more than about: 50%, 25%, 10%, 5%, or ranges spanning and/or including the aforementioned values. In some embodiments, the hysteresis in the system is suitably small and there is little difference between the adsorption threshold pressure and the desorption threshold pressure. In some embodiments, the adsorption-desorption process is thus suitably reversible.

In some embodiments, desorption occurs when the metal-organic material is subjected to a stimulus, for example a change in relative humidity or a change in temperature. In some embodiments, desorption occurs upon subjecting the metal-organic material to reduced relative humidity and/or increased temperature.

In some embodiments, desorption is reversible.

In some embodiments, sorption and desorption are reversible over several cycles.

In some embodiments, the metal-organic material of the present invention has favourable kinetics of adsorption at or above the threshold humidity.

In some embodiments, the metal-organic material of the present invention reaches at least about 50% of its maximum capacity within 5 minutes under ambient conditions of temperature and humidity (27° C., 1 atm). In some embodiments, the metal-organic material reaches at least about 80%, for example about 90%, of its maximum capacity within 10 minutes under ambient conditions of temperature and humidity. In some embodiments, the metal-organic material may reach its capacity within 10 minutes under ambient conditions of temperature and humidity.

In some embodiments, the metal-organic material has a water sorption capacity of at least 120 cm³ of water vapour at STP per cm³ of material. In some embodiments, the metal-organic material has a water uptake of at least 130 cm³ of water vapour at STP per cm³ of material, for example at least 140 cm³ of water vapour at STP per cm³ of material. In some embodiments, the metal-organic material has a water uptake of at least 150 cm³ of water vapour at STP per cm³ of material. In some embodiments, the metal-organic material has a water sorption capacity of at least about 120 cm³, 130 cm³, 140 cm³, or 150 cm³, (or ranges spanning and/or including the aforementioned values) of water vapour/cm³ material under ambient conditions of temperature and humidity (27° C., 1 atm).

In some embodiments, the water uptake may be determined using standard vacuum dynamic vapour sorption (DVS) or intrinsic dynamic vapour sorption methods. Such methods are well known to those skilled in the art.

In some embodiments, the metal-organic material has favourable kinetics of adsorption below the threshold humidity.

In some embodiments, the metal-organic material releases at least about 120 cm³ water vapour/cm³ material when subjected to a stimulus such as a change in temperature or change in relative humidity. In some embodiments, the metal-organic material releases at least about 130 cm³ water vapour/cm³ material, for example at least about 140 cm³ water vapour/cm³ material when subjected to a stimulus. In some embodiments, the metal-organic material releases at least about 150 cm³ water vapour/cm³ material when subjected to a stimulus.

In some embodiments, the desorption occurs at a temperature of below 75° C. In some embodiments, the desorption occurs at a temperature of below 70° C., for example below 65° C. In some embodiments, the desorption occurs at a temperature of below 60° C.

In some embodiments, water provided by the present invention is suitably highly pure.

Some embodiments pertain to a device for capturing water from air comprising a metal-organic material as previously defined herein and a support.

In some embodiments, the material is suitably arranged on the support in a configuration to ensure maximum sorption.

In some embodiments, the metal-organic material may be arranged on the surface of the support or incorporated within the body of the support.

In some embodiments, the support may be selected from any suitable polymeric, plastic, metal, resin and/or composite material. In view of the disclosure herein, a person skilled in the art will be familiar with these types of material and will be able to select the most appropriate support for the device.

In some embodiments the support is a polymer material. In some embodiments, the support comprises an acrylic polymer. In some embodiments, suitable acrylic polymers include commercially available HYCAR® 26410 from the Lubrizol Corporation.

In some embodiments, the support comprises a cellulosic material, for example paper. In some embodiments, the support may comprise a composite material of paper and another polymer.

In some embodiments, the device comprises means for directing air flow through or across the metal-organic material.

In some embodiments, the device may be electrically powered. In some embodiments, it may be powered by renewable resources, for example solar power.

In some embodiments, the device may optionally be used for water storage.

In some embodiments, the device may optionally be used for water delivery.

In some embodiments, the device may further comprise means for desorbing water from the metal-organic material.

In some embodiments, such means may suitably comprise means for exposing the metal-organic material to a temperature change and/or a pressure change.

In some embodiments, the water delivered from the metal-organic material is suitably ultra-high purity water.

By ultra-high purity water what is meant is water without any contaminant species or substantially no contaminant species, such as organic and inorganic compounds and dissolved gases.

In some embodiments the water delivered from the metal-organic material may be gaseous ultra-high purity water.

In some embodiments, the water delivered from the metal-organic material is liquid ultra-high purity water.

In some embodiments, the water delivered from the metal-organic material may undergo treatment to make the water suitable for its specific use.

In some embodiments, the water delivered from the metal-organic material may be used for drinking water. In such use, the water may involve a treatment step to make the water suitable for human consumption.

In some embodiments, water delivered from the metal-organic material may be used in agriculture.

In some embodiments, water delivered from the metal-organic material may be used in medical applications.

In some embodiments, water delivered from the metal-organic material may be used in industrial applications.

Some embodiments provide a method of delivering water to a locus from water vapour in the air. In some embodiments, the method comprises one or more steps selected from:
(a) providing a metal-organic material;
(b) contacting the metal-organic material with water and/or water vapour such that the material switches from a first state to a second state wherein the second state is able to retain a higher amount of water than the first state;
(c) optionally transporting and/or storing the metal-organic material;
(d) applying a stimulus to the metal-organic material to effect desorption of water retained therein; and
(e) collecting desorbed water at the locus.

Some embodiments provide a method of harvesting water involving capture and then release.

Some embodiments provide the use of a metal-organic material as disclosed herein or a device as disclosed herein to deliver water to a locus.

In some embodiments, the metal-organic materials can also be used to capture water from liquid compositions comprising water and one or more further components. In some embodiments, such liquid compositions include aqueous compositions comprising dissolved solids, for example sea water. In some embodiments, the metal-organic materials of the present invention can also be used in desalination methods.

In some embodiments, the material is [Cu₂(glutarate)₂(4,4′-bipyridine)].

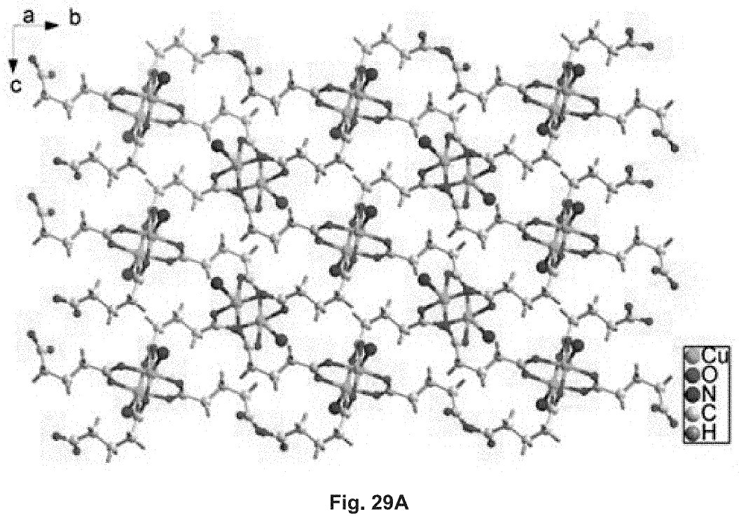

In some embodiments, this material can be prepared in a number of ways. Some methods of preparing this material are described in Examples 8, 9, 10 and 11 and its crystallographic structure is shown in FIGS. 29A and 29B.

In some embodiments, this material is highly advantageous because it has favourable adsorption and desorption kinetics, under typical vacuum, temperature or humidity swing tests; suitable thermodynamics (desorption occurs below 75° C. at atmospheric pressure) and suitable working capacity (water vapour uptake of at least about 150 cm³ water vapour/cm³ material).

Some embodiments may therefore provide a method of capturing water from air, the method comprising contacting [Cu₂(glutarate)₂(4,4′-bipyridine)] with water and/or water vapour.

In some embodiments, provided herein is the use of [Cu₂(glutarate)₂(4,4′-bipyridine)] to capture water from air.

Embodiments of invention will now be further described by reference to the accompanying figures and examples.

In the following examples, powder X-ray diffraction (PXRD) measurements were taken using microcrystalline samples using a PANalytical Empyrean™ diffractometer equipped with a PIXcel3D detector. The variable temperature powder X-ray diffraction (VT-PXRD) measurements were collected using a Panalytical X'Pert diffractometer.

Single crystal X-ray diffraction (SCXRD) measurements were also collected on a number of compounds. The data was collected using a Bruker D8 Quest diffractometer.

Thermogravimetric analysis (TGA) was carried out under nitrogen using the instrument TA Q50 V20.13 Build 39 and data was collected in the high resolution dynamic mode.

Fourier Transform Infrared (FT-IR) spectra were measured on a Perkin Elmer spectrum 200 spectrometer.

Low-pressure N2 adsorption measurements were performed on approximately 200 mg of sample using ultra-high purity grade N₂. The measurements were collected using a Micrometrics TriStar II PLUS and a Micrometrics 3 Flex was used to analyse the surface area and pore size.

Vacuum dynamic vapour sorption (DVS) studies made use of a Surface Measurement Systems DVS Vacuum, which gravimetrically measures the uptake and loss of vapour. The DVS methods were used for the determination of water vapour sorption isotherms using approximately 15 to 30 mg of sample. Pure water was used as the adsorbate for these measurements and temperature was maintained by enclosing the system in a temperature-controlled incubator.

### Water Adsorption Isotherm Classification

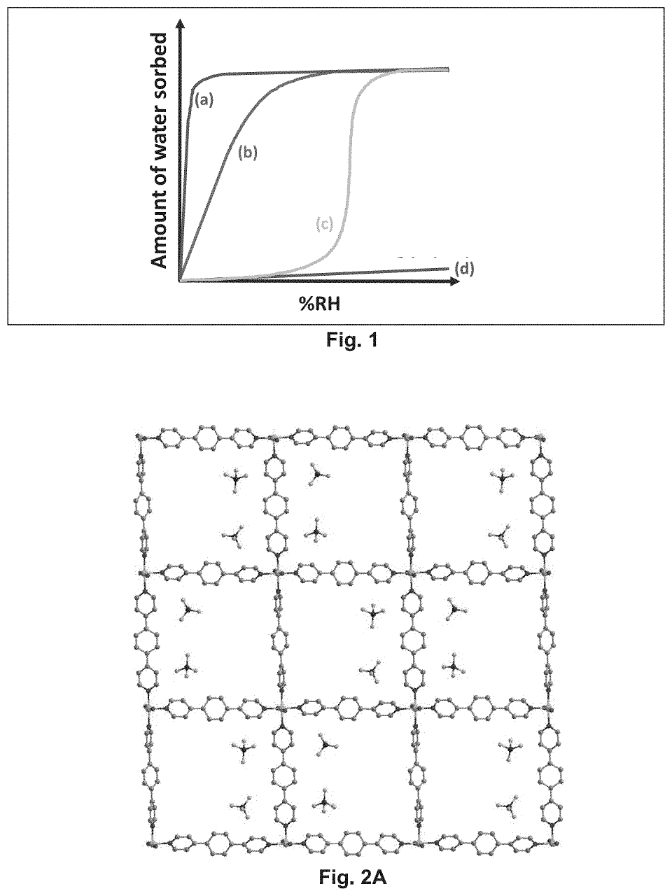

Preliminary evaluation of sorption performance in either adsorption or desorption events of sorbents is conducted by obtaining sorption isotherms. The isotherm reveals the amount of adsorbate (in this case water vapour) adsorbed and/or desorbed across a range of relative humidities (RHs) at a given temperature. Error! Reference source not found. FIG. 1 illustrates four types of water sorption. Such isotherms can be obtained using the instruments and methods known to those skilled in the art. Metal-organic materials for use in the present invention desirably have an isotherm as shown by line (c) of FIG. 1.

Examples 1 to 7 which follow are examples two-dimensional layered materials of the present invention.

The remaining examples relate to embodiments in which the metal-organic materials are porous metal-organic framework material comprising pores which have a hydrophobic pore window and a hydrophilic internal pore surface.

### EXAMPLE 1: sql-2-Cu—BF₄

### Synthesis of sql-2-Cu—BF₄

An ethanol solution (3.0 ml) containing 1,4-bis(4-pyridyl)benzene (11.6 mg, 0.05 mmol) was slowly layered on an aqueous solution (3.0 ml) of copper(II) tetrafluoroborate (6 mg, 0.025 mmol) at room temperature. The resulting green crystals were collected by filtration with a yield of approximately 60%.

### Structure of sql-2-Cu—BF₄

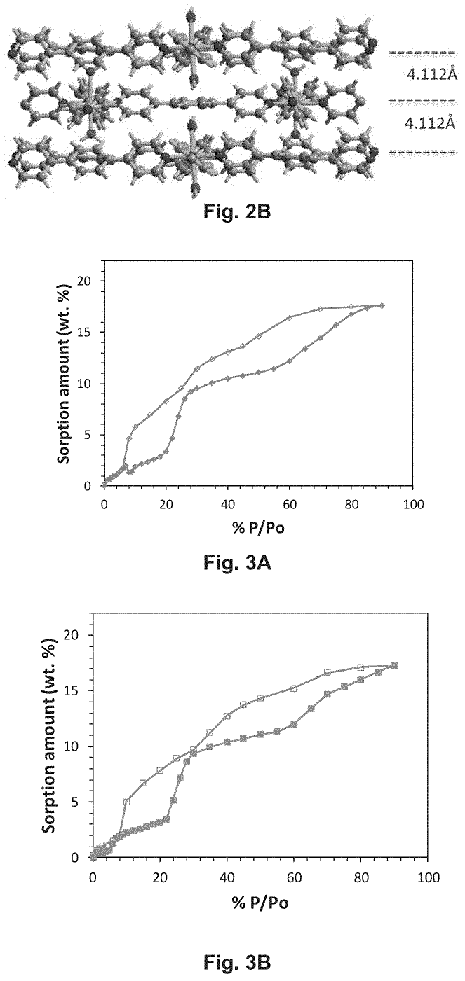

sql-2-Cu—BF₄ forms a two-dimensional layered network with Cu²⁺ ions connected in one and two dimensions by 1,4-bis(4-pyridyl)benzene to form a square lattice shown in FIG. 2A. The square lattice layers are stacked above one another with an interlayer separation of 4.112 Åshown in FIG. 2B. The guest accessible volume was found to be 16%. The synthesised phase contained two ethanol molecules and two water molecules in the lattice, and two coordinated water molecules.

### Water Vapour Sorption Studies of sql-2-Cu—BF₄

Water sorption isotherms for sql-2-Cu—BF₄ were collected at 25° C. and 35° C., shown in FIG. 3A and FIG. 3B respectively. The isotherms demonstrated Type F-I isotherm characteristics, pointing to gradual adsorption behaviour from an open to more open phase. Sorption isotherms for both temperatures were repeated and the second sorption isotherm was found to be nearly identical to the first sorption isotherm, indicating that repetitive isotherms on the same sample at different temperatures does not alter the structure of the material. There is a large hysteresis at higher humidity which is not present at lower humidities, demonstrating that the process of switching between a non-porous phase and a porous phase is completely reversible.

### Kinetic studies of sql-2-Cu—BF₄

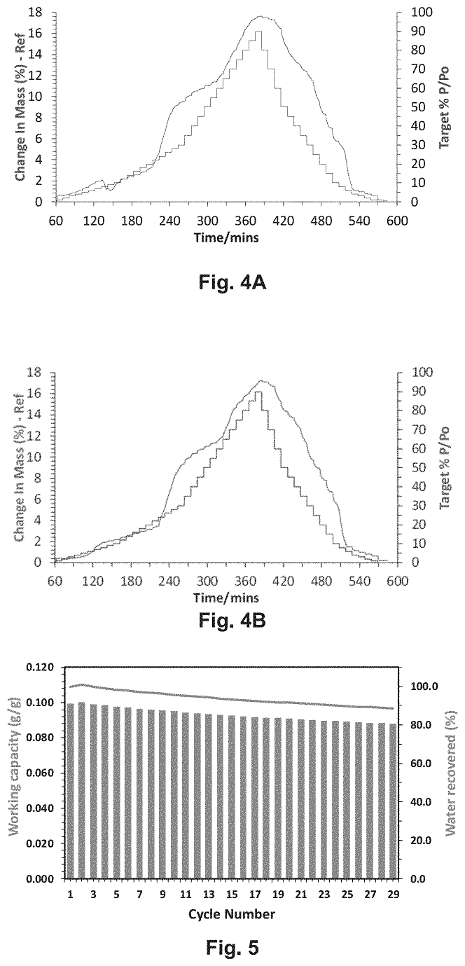

Water sorption kinetic data was collected for sql-2-Cu—BF₄ at 25° C. and 35° C., shown in FIG. 4A and FIG. 4B respectively. The adsorption and desorption mechanism profiles are similar at 25° C. and 35° C., with a total uptake of 18 wt % observed. The sample adsorbed water molecules in small increments, with considerably fast adsorption and desorption kinetics.

### Reversibility Studies of sql-2-Cu—BF₄

Reversibility tests on sql-2-Cu—BF₄ were performed at 25° C. to calculate the working capacity in g/g and are shown in FIG. 5.

### EXAMPLE 2: sql-3-Cu—BF₄

### Synthesis of sql-3-Cu—BF₄

Cu(BF₄).6H₂O (0.237 g, 1 mmol), 1,4-bis(4-pyridyl)biphenyl (0.616 g, 2 mmol) and a few drops of methanol were grinded together for 30 minutes using a ball mill with a frequency of 25 Hz. The resulting powder was washed three times with methanol.

### Water Vapour Sorption Studies of sql-3-Cu—BF₄

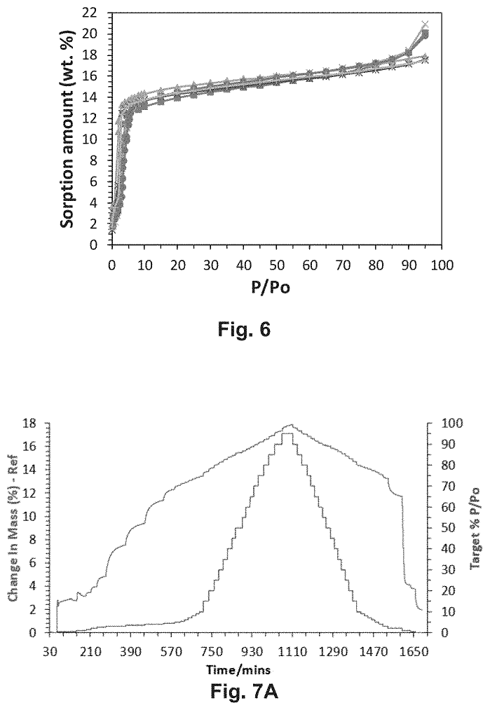

Water sorption isotherms for sql-3-Cu—BF₄ were collected at 25° C., 30° C. and 35° C., shown in FIG. 6. The hysteresis gap for this material is narrow, which indicates that water desorption is not restricted. Below 80% relative humidity, water uptake remains unchanged and is independent of temperature, while above 80% relative humidity the water uptake is lower at 35° C. compared to 25° C. and 30° C. The lower water uptakes at higher temperature are expected for a surface adsorption mechanism. All isotherms show type F-IV behaviour, which indicates a sudden switching from a closed phase to an open phase.

The heat of sorption was calculated from the linear region of the isotherms collected for sql-3-Cu—BF₄ at 25° C., 30° C. and 35° C. using a Virial model. The average heat of sorption for sql-3-Cu—BF₄ was found to be lower than the heat of vaporisation for water at 25° C. This demonstrates the intrinsic heat management offered by square lattice networks, reducing the amount of heat released during adsorption and the impact of cooling during desorption.

### Kinetic Studies of sql-3-Cu—BF₄

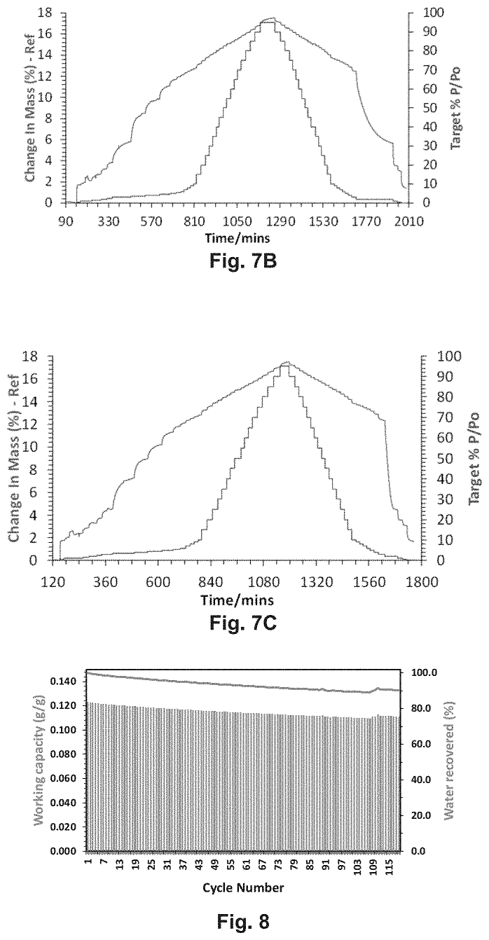

Water sorption kinetic data was collected for sql-3-Cu—BF₄ at 25° C., 30° C. and 35° C. over a 0% to 95% relative humidity range, demonstrated in FIGS. 7A, 7B and 7C, respectively. Some water (approximately 10%) is found to remain in the material when desorption steps have completed, illustrated by the mass not returning to its original value at 0% relative humidity. Therefore the structure requires heating or high vacuum in order for the water to be completely removed.

### Reversibility Studies of sql-3-Cu—BF₄

sql-3-Cu—BF₄ was subjected to a 0% to 10% to 0% relative humidity sequence 119 times, and all isotherms were taken on the same sample. Reversible switching isotherms are observed, showing that this material has a robust flexible structure and behaves predictably.

sql-3-Cu—BF₄ shows a high working capacity in the low partial pressure range as demonstrated in FIG. 8, making sql-3-Cu—BF₄ a potential candidate for water capture in arid conditions.

### EXAMPLE 3: sql-1-Co—NO₃

### Synthesis of sql-1-Co—NO₃

sql-1-Co—NO₃ was prepared by solvent diffusion. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Co(NO₃)₂.6H₂O (0.3 mmol, 87.3 mg) in 5 ml methanol was layered over the methanol/TFT layer. The red brick crystals were collected by filtration and washed with TFT three times.

### Structure of sql-1-Co—NO₃

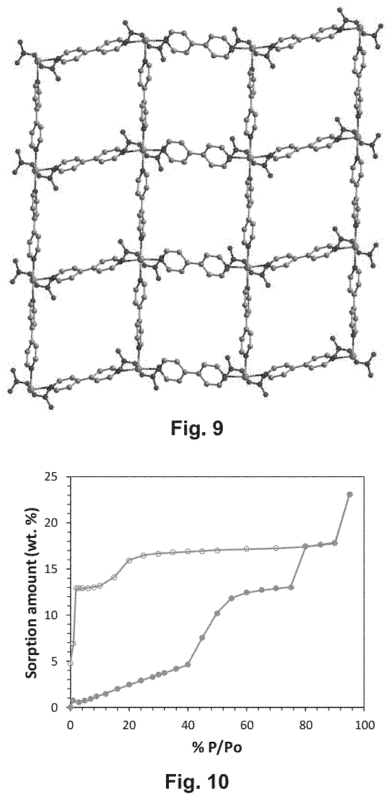

sql-2-Co—NO₃ forms a two-dimensional layered network with Co²⁺ ions connected in one and two dimensions by 4,4′-bipyridine to form a square lattice, with NO3⁻ also coordinated at the axial positions. The structure can be seen in FIG. 9. This material has an effective pore size of approximately 7.5 Å×7.5 Å.

### Water Vapour Sorption Studies of sql-1-Co—NO₃

Water sorption isotherms were collected on sql-1-Co—NO₃ at 25° C., shown in FIG. 10. The isotherm demonstrates mixed Type F-I and Type F-II behaviour, indicated by a low initial adsorption and substantial uptake at higher relative humidity. The isotherm also shows that the material switches from an open phase to a more open phase.

The sample retains approximately 4.7% water vapour mass at 0% relative humidity, resulting in an open hysteresis loop. This indicates the sql-1-Co—NO₃ requires heating or high vacuum in order to fully vacate the structure at low partial pressures.

### Kinetic Studies of sql-1-Co—NO₃

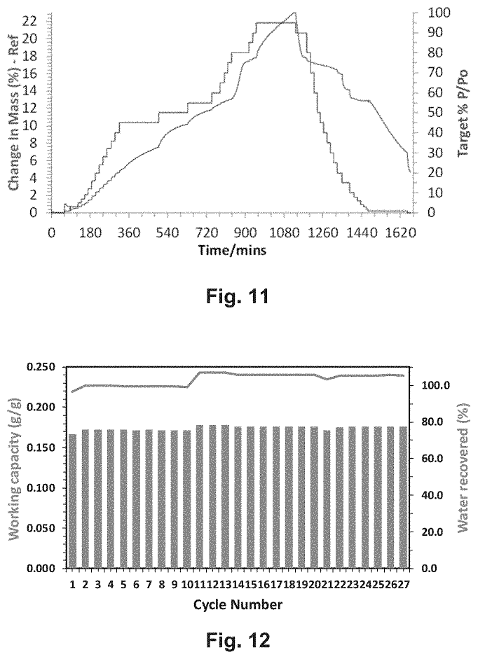

Water sorption and desorption kinetics for sql-1-Co—NO₃ were studied at 25° C. and summarised in FIG. 11.

### Reversibility Studies of sql-1-Co—NO₃

There is no discernible difference between the first and tenth cycle isotherms, as illustrated by FIG. 12. In addition, there is no hysteresis between the sorption and desorption isotherms. This indicates that the water sorption mechanism is completely reversible after slight heating at 40° C. between each cycle, and there are no sample history effects related to water sorption. In total, 27 complete adsorption and desorption cycles were collected and the working capacity is also almost constant across the cycles.

### EXAMPLE 4: sql-1-Ni—NO₃

### Synthesis of sql-1-Ni—NO₃

sql-1-Ni—NO₃ was also prepared using solvent diffusion. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Ni(NO₃)₂.6H₂O (0.3 mmol, 87.3 mg) in 5 ml methanol was layered over the methanol/TFT layer. The blue crystals were collected by filtration and washed with TFT three times.

### Structure of sql-1-Ni—NO₃

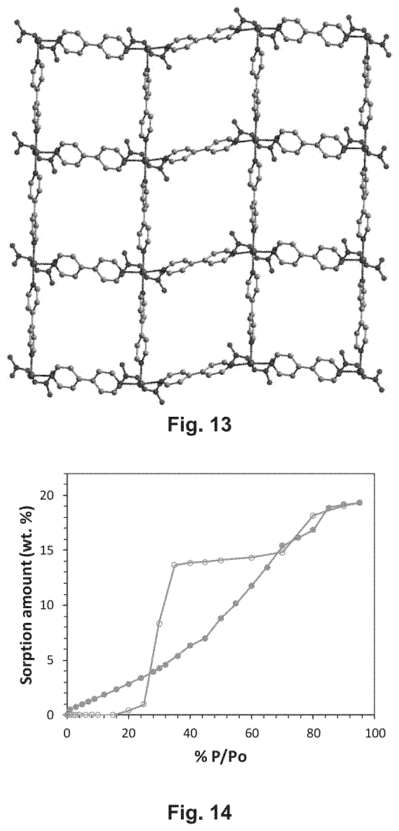

sql-1-Ni—NO₃ forms a two-dimensional layered network with Ni²⁺ ions connected in one and two dimensions by 4,4′-bipyridine to form a square lattice, with NO3⁻ also coordinated at the axial positions. The structure can be seen in FIG. 13. This material has an effective pore size of approximately 7.5 Å×7.5 Å.

### Water Vapour Sorption Studies of sql-1-Ni—NO₃

Water sorption isotherms were collected on sql-1-Ni—NO₃ at 25° C., shown in FIG. 14. This material has a broad hysteresis in the region between 30% and 70% relative humidity and the loss of water is dramatic during the desorption isotherm, indicating an imminent closed phase structure during dehydration. The isotherm can be characterised by a Type F-III isotherm that shows a gradual uptake from low to high partial pressure.

### Kinetic Studies of sql-1-Ni—NO₃

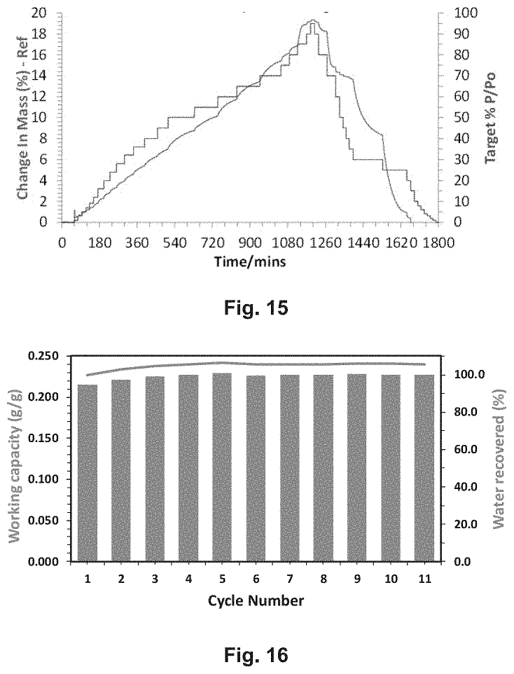

Water sorption and desorption kinetics for sql-1-Ni—NO₃ were studied at 25° C. and are summarised in FIG. 15.

### Reversibility Studies of sql-1-Ni—NO₃

Reversibility tests on sql-1-Ni—NO₃ were performed to calculate the working capacity and are shown in FIG. 16.

### EXAMPLE 5: sql-1-Cu—NO₃

### Synthesis of sql-1-Cu—NO₃

sql-1-Cu—NO₃ was again prepared by solvent diffusion, in a similar fashion to sql-1-Ni—NO₃ and sql-1-Co—NO₃. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Cu(NO₃)₂.6H₂O (0.3 mmol, 87.3 mg) in 5 ml methanol was layered over the methanol/TFT layer. The dark blue crystals were collected by filtration and washed with TFT three times.

### Structure of sql-1-Cu—NO₃

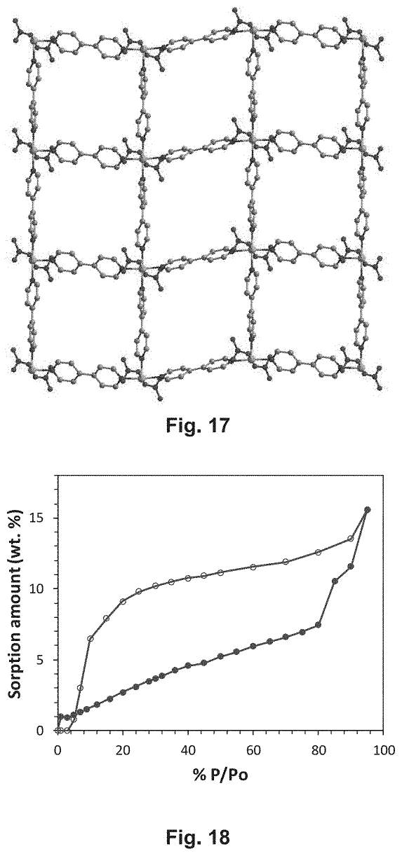

sql-1-Cu—NO₃ forms a two-dimensional layered network with Cu²⁺ ions connected in one and two dimensions by 4,4′-bipyridine to form a square lattice, with NO₃⁻ also coordinated at the axial positions. The structure can be seen in FIG. 17. This material has an effective pore size of approximately 7.5 Å×7.5 Å.

### Water Vapour Sorption Studies of sql-1-Cu—NO₃

Water sorption isotherms were collected on sql-1-Cu—NO₃ at 25° C. and are shown in FIG. 18. The sample progressively adsorbs water until 80% relative humidity, where a significant mass uptake is observed. During desorption, the sample loses a large amount of water, returning to the sorption 0% level at 3% relative humidity. This indicates that the sample returns to the initial form. This material can be characterised by a Type F-III isotherm, showing a gradual uptake from low or intermediate partial pressures and a high uptake at elevated partial pressure. In addition, the hysteresis gap presents shape memory.

### Kinetic studies of sql-1-Cu—NO₃

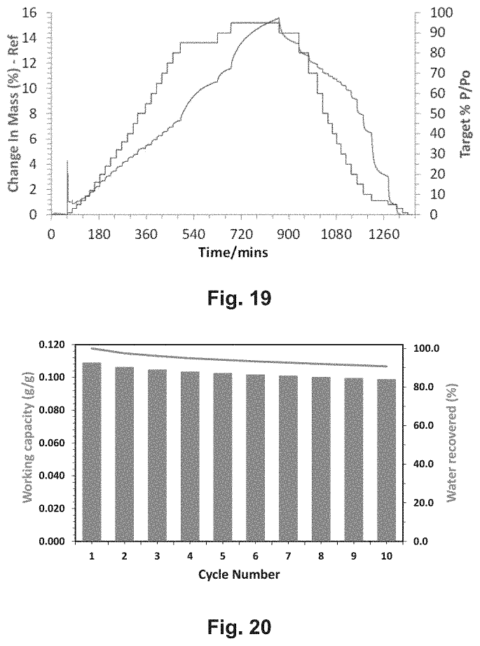

Water vapour sorption kinetics for sql-1-Cu—NO₃ were collected at 25° C. and are shown in FIG. 19. The sample mass increases progressively, achieving a 16% change in mass.

### Reversibility Studies of sql-1-Cu—NO₃

Reversibility tests on sql-1-Cu—NO₃ were conducted at 25° C. for ten adsorption-desorption cycles and are summarised in FIG. 20.

### EXAMPLE 6: sql-2-Cu—OTf

### Synthesis of sql-2-Cu—OTf

An ethanol solution (3 ml) containing 1,4-bis(4-pyridyl)benzene (11.6 mg, 0.05 mmol) was slowly layered on top of an aqueous solution (3 ml) copper triflate (9 mg, 0.025 mmol). The light purple crystals were collected by filtration.

### Structure of sql-2-Cu—OTf

sql-2-Cu—OTf forms a two-dimensional layered network with Cu²⁺ ions connected in one and two dimensions by 1,4-bis(4-pyridyl)benzene to form a square lattice shown in FIG. 21. There are ethanol and water molecules present in the lattice, as well as one coordinated water molecule. The square lattice frameworks are stacked above each other with an interlayer separation of 4.634 Å. The guest accessible volume was found to be 20%.

### Water Vapour Sorption Studies of sql-2-Cu—OTf

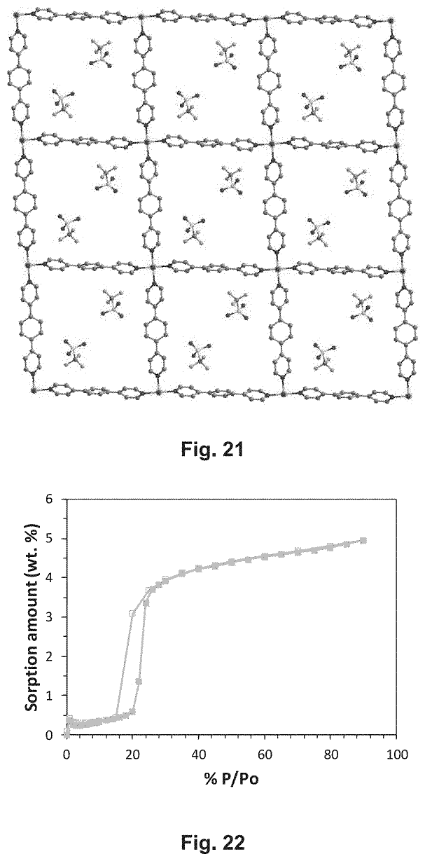

The water vapour sorption isotherm for sql-2-Cu—OTf was collected at 25° C. and is shown in FIG. 22. Below 18% relative humidity, the material almost behaves as a non-porous material, demonstrating little water adsorption. The isotherm shows a dramatic increase in mass between 18% and 30% relative humidity, giving rise to the theory of a closed phase at 0% relative humidity with the ability to reach an open phase at 20% relative humidity. This isotherm closely resembles the Type F-II isotherm with a mild hysteresis gap between 15% and 25% partial pressure.

### Kinetic Studies of sql-2-Cu—OTf

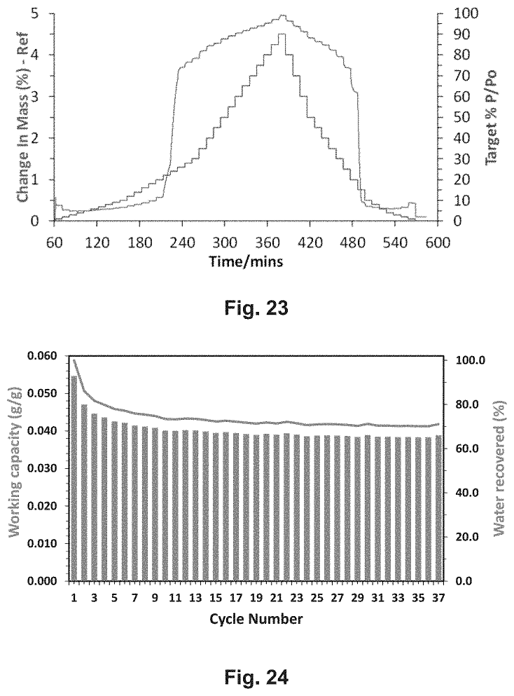

Water sorption and desorption kinetics for sql-2-Cu—OTf were obtained at 25° C. The kinetic data in FIG. 23 demonstrates that all steps reach equilibrium.

### Reversibility Studies of sql-2-Cu—OTf

sql-2-Cu—OTf was subjected to a 0% to 30% to 0% relative humidity sequence 37 times, with isotherms collected on the same sample. Following 37 cycles, sql-2-Cu—OTf is able to uptake 71% of the initial water uptake compared to the first cycle. There is no significant change in the measured water content after the first seven cycles. This demonstrates that sql-2-Cu—OTf is able to reversibly transform its structural framework from a closed phase to an open phase. The results are summarised in FIG. 24.

### EXAMPLE 7: sql-A14-Cu—NO₃

### Synthesis of sql-A14-Cu—NO₃

A buffer of isopropanol and water (2 ml, v/v=1:1) was layered over an aqueous solution of Cu(NO₃).3H₂O (3 mg, 0.012 mmol). An isopropanol solution of 4,4′-(2,5-dimethyl-1,4-phenylene)dipyridine (7.8 mg, 0.03 mmol) was layered over the buffer layer at room temperature.

The resulting blue crystals were isolated with a calculated yield of 55%.

### Structure of sql-A14-Cu—NO₃

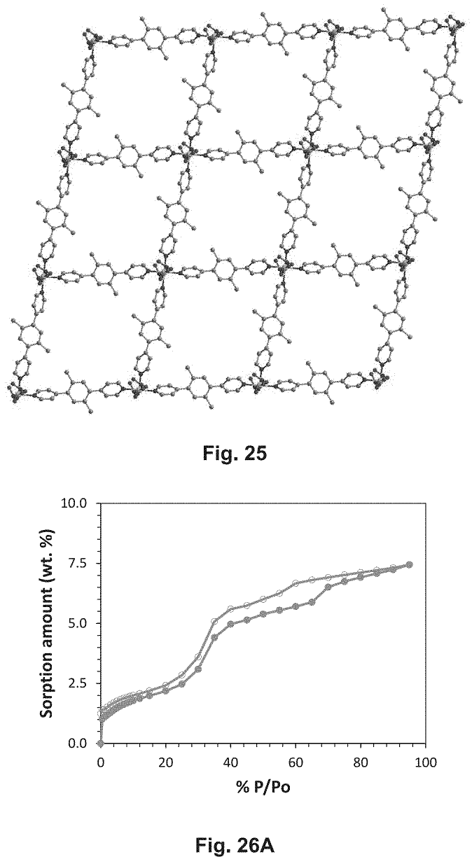

sql-2-Cu—OTf forms a two-dimensional layered network with Cu²⁺ ions connected in one and two dimensions by 4,4′-(2,5-dimethyl-1,4-phenylene)dipyridine to form a square lattice shown in FIG. 25. Terminal NO₃⁻ ions are also coordinated at the axial positions. The guest accessible volume was found to be 17%.

### Water Vapour Sorption Studies of sql-A14-Cu—NO₃

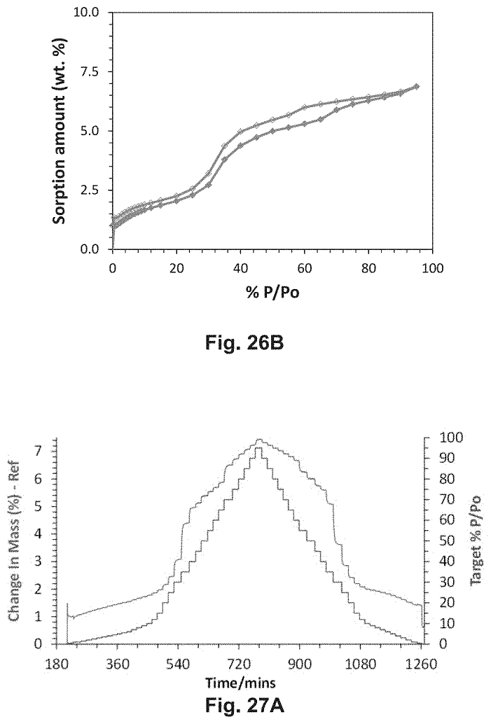

Water vapour sorption studies for sql-A14-Cu—NO₃ were performed at 25° C. and 30° C., shown in FIG. 26A and 26B, respectively. The sample has a narrow hysteresis in the region between 15% and 80% relative humidity. FIG. 26A suggests an adsorption mechanism dominated by Type F-I behaviour, illustrating a gradual mechanism from an open phase to a more open phase.

### Kinetic Studies of sql-A14-Cu—NO₃

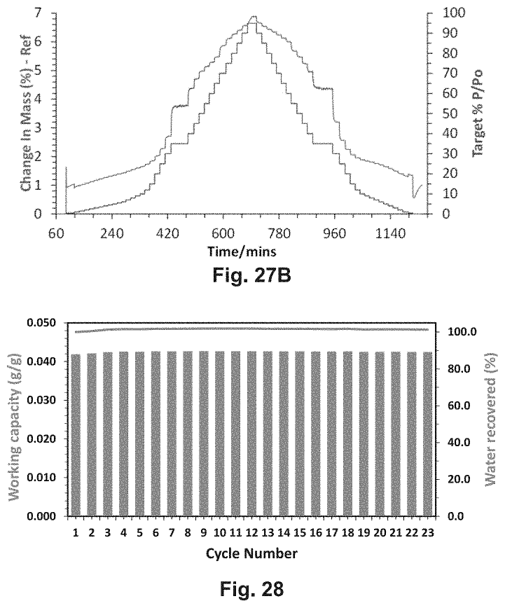

Water sorption and desorption kinetics for sql-A14-Cu—NO₃ were obtained at 25° C. and 30° C. The kinetic data is summarised in FIGS. 27A and 27B for 25° C. and 30° C., respectively.

### Reversibility Studies of sql-A14-Cu—NO₃

Twenty-three cycles of adsorption and desorption at 25° C. were performed in total. The adsorption and desorption branch show good agreement, suggest no significant hysteresis. As demonstrated in FIG. 28, the material retains constant working capacity across all of the cycles. The material sql-A14-Cu—NO₃ has a high stability against repeated relative humidity cycles.

### EXAMPLE 8: [Cu₂(glutarate)₂(4,4′-bipyridinen)]

### Synthesis of [Cu₂(glutarate)₂(4,4′-bipyridine)]

Cu(NO₃).3H₂O (242 mg, 1 mmol), glutaric acid (132.1 mg, 1 mmol), and 4,4′-bipyridine (78 mg, 0.5 mmol) were mixed in water (100 ml). NaOH was added dropwise with swirling to the solution to prevent precipitation. The blue solution was placed in an oven preheated to 85° C. Green powder was obtained after 24 to 48 hours. This compound may also be referred to as ROS037. FIGS. 29A and 29B shows the crystallographic structure of this compound.

### Water Vapour Sorption studies of [Cu₂(glutarate)₂(4,4′-bipyridine)]

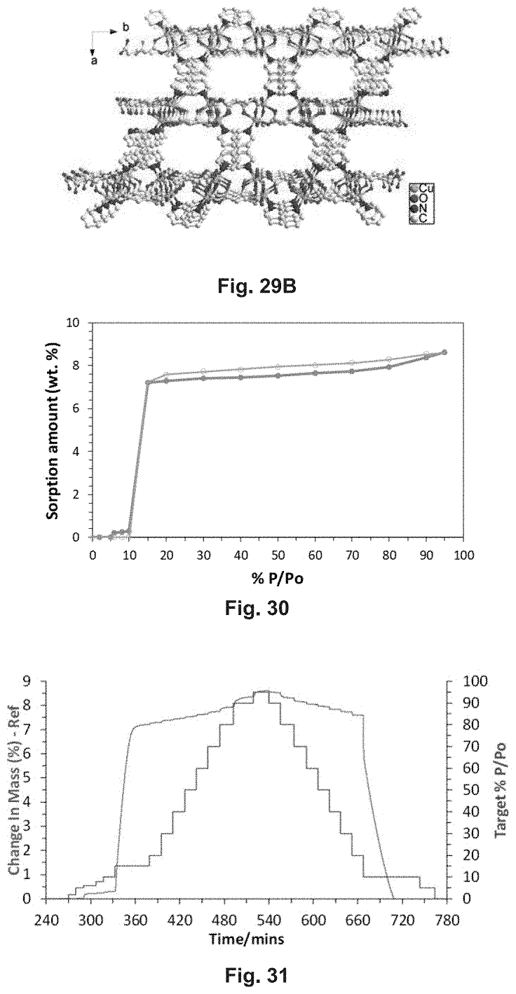

Water vapour sorption studies for [Cu₂(glutarate)₂(4,4′-bipyridine)] were performed at 25° C., shown in FIG. 30. The sample shows a very narrow hysteresis gap, indicating that water desorption is not restricted.

### Kinetic Studies of [Cu₂(glutarate)₂(4,4′-bipyridine)]

Water sorption and desorption kinetics for [Cu₂(glutarate)₂(4,4′-bipyridine)] were obtained at 25° C., demonstrated in FIG. 31. The kinetics data in FIG. 31 show that all steps reach equilibrium over a range of temperatures. The removal of water from the structure does not require any additional heating or vacuum, as evidenced by the mass returning to its original value at 0% relative humidity.

### Reversibility Studies of [Cu₂(glutarate)₂(4,4′-bipyridine)]

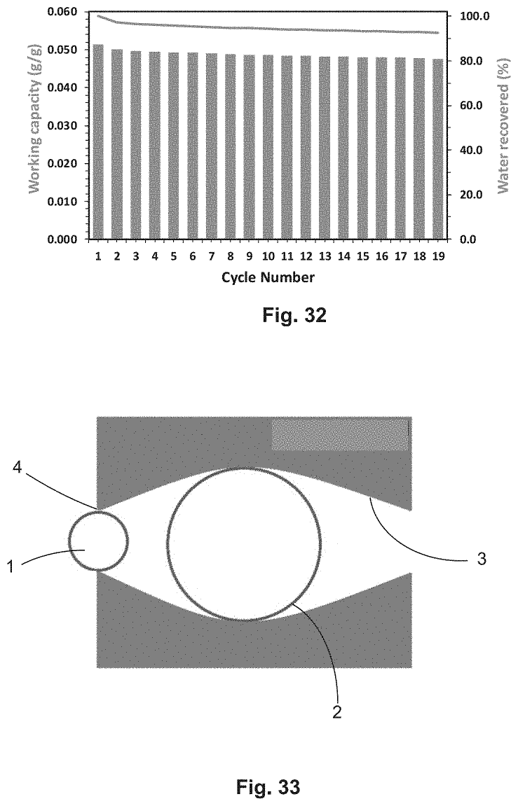

Nineteen cycles of adsorption and desorption at 25° C. were performed in total. Reversible switching isotherms are observed and no hysteresis gap is detected, indicating water desorption is not restricted. [Cu₂(glutarate)₂(4,4′-bipyridine)] shows a high working adsorption capacity in the low partial pressure range (≤30% P/Po), as demonstrated in FIG. 32.

### EXAMPLE 9: ALTERNATIVE SYNTHESIS OF [Cu₂(glutarate)₂(4,4′-bipyridine)]

In a beaker, Cu(OH)₂ (488 mg, 5 mmol) was suspended in 100 mL of water with stirring for 5 minutes. Glutaric acid (1.32 g, 10 mmol) was added and allowed to stir for 5 minutes. The solution became clear and dark blue in colour. 4,4′-bypyridyl (390.5 mg, 2.5 mmol) was added and a green precipitate was formed in 10 minutes. The mixture was filtered and washed with 50 mL of water to obtain the solid product, Yield, 1.332 g, >94%.

Characterisation of the product confirmed this to be identical to the product obtained in Example 8.

### EXAMPLE 10: LAB-SCALE SYNTHESIS OF [Cu₂(glutarate)₂(4,4′-bipyridine)]

ROS-037 was synthesized in lab scale by a modified literature protocol as follows: 350 mL of water was taken in a 500 mL conical flask and glutaric acid (24.3 g, 0.184 mol) was added followed by the addition of NaOH (14.7 g, 0.368 mol) and stirred until a clear solution was obtained. Cu(NO₃)₂.2.5H₂O (42.7 g, 0.184 mol) was added and allowed to stir for 10 minutes.

4,4′-bypyridyl (14.4 g, 0.092 mol) was added and the mixture was allowed to stir for 1 hour at 70° C. Once the reaction was completed, the solution was filtered to obtain the solid product, and further washed with water to remove any traces of unreacted reactants and air dried. Yield, ˜48 g, >98%.

Characterisation of the product confirmed this to be identical to the product obtained in Example 8.

### EXAMPLE 11: SCALE-UP SYNTHESIS OF [Cu₂(glutarate)₂(4,4′-bipyridine)]

ROS-037 can be scaled up to mini-plant scale by water slurry method as follows. 3.5 L of water was added to the 5 L reactor and the stirrer was set to 750 rpm. Glutaric acid (243 g, 1.84 mol) was added and allowed to dissolve for 10 minutes. NaOH (147 g, 3.68 mol) was added and the temperature of the reactor was set to 70° C. (Note: Reaction can be carried out at room temperature also, however more reaction time is required). Once a clear solution is obtained, Cu(NO₃)₂.2.5H₂O (427 g, 1.84 mol) was added and allowed to stir for 15 minutes. 4,4′-bypyridyl (144 g, 0.92 mol) was added and the mixture was allowed to stir for 6 hours. Once the reaction was complete, the solution was filtered to obtain the solid product, which was further washed to remove any traces of NaOH and unreacted reactants and air dried. Yield, 481 g, >98%.

Characterisation of the product confirmed this to be identical to the product obtained in Example 8.

### EXAMPLE 12: SYNTHESIS OF [Co₃(μ₃-OH₁₂(btca)₂]

A mixture of benzotriazole-5-carboxylic acid (H₂btca; 0.3 mmol, 48 mg), Co(NO3)2.6 H₂O (0.5 mmol, 145 mg), CH₃CN (3 mL), and H₂O (2 mL) was sealed in a 15-mL Teflon-lined stainless reactor, which was heated to 150° C. and held at that temperature for 5 days. After cooling to room temperature, red-pink crystals were separated by decanting and washed with water. Yield: 28 mg, 31%.

The composition of the material was confirmed by PXRD.

The vapour sorption isotherm for this material is shown in FIG. 36.

### EXAMPLE 13: SYNTHESIS OF [Mo₃(μ₃-OH)₂(2,4-pyridinedicarboxylate)₂]

Pale yellow solution of 2,4-pyridinedicarboxylic acid (167 mg, 1 mmol) and 2 mL of 2M KOH (4 mmol) in 2 mL of HO was prepared. Mg(NO₃)₂.6H₂O (384 mg, 1.5 mmol) was dissolved in 3 mL of HO in a Teflon lined steel autoclave (˜23 mL). The solution of 2,4-pyridinedicarboxylic acid was added to a solution of Mg(NO3)2 6H20 under stirring, the formation of white suspension was observed. The reactor was sealed and heated at 210° C. for 15 hours. After cooling over 6 hours, the white crystals were filtered off and washed with water. The solid was then dried in air at ambient conditions. Yield: 130-180 mg, 43-60%.

The composition of the material was confirmed by PXRD.

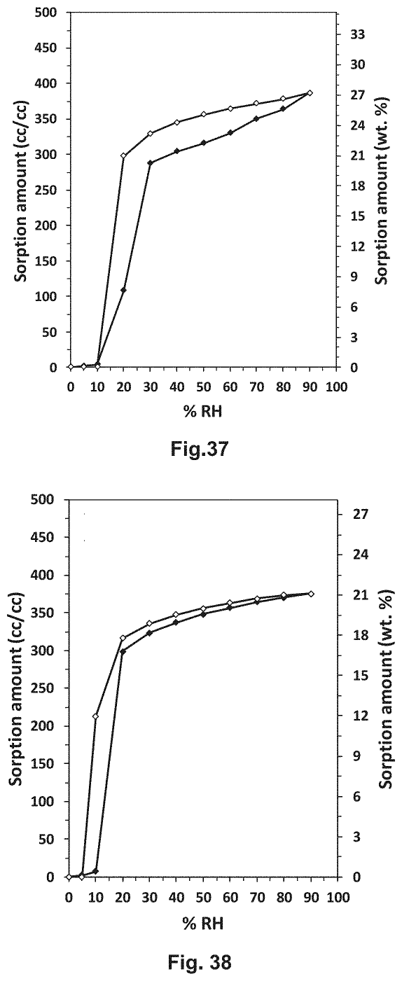

The vapour sorption isotherm for this material is shown in FIG. 37.

### EXAMPLE 14: SYNTHESIS OF [Co₃(μ₃-OH)₂(2,4-pyridinedicarboxylate)₂]

A solution of 2,4-pyridinedicarboxylic acid (185 mg, 1.0 mmol) and KOH (1.0 M, 3.0 mL) in H₂O (3.0 mL) was added to a stirred aqueous solution (4.0 mL) of CoCl₂.6H₂O (357 mg, 1.5 mmol).

The resulting viscous, opaque mixture was heated to 200° C. in a Teflon-lined steel autoclave over 15 h, and then cooled to room temperature over 6 h. The crystalline solid was purified by cycles (3×30 min) of ultrasonic treatment in H₂O (20 mL), followed by decanting of the cloudy supernatant. The solid was then dried in air at ambient conditions. Yield: 210 mg (46%).

The vapour sorption isotherm for this material is shown in FIG. 38.

### EXAMPLE 15: SYNTHESIS OF [Cu₂(glutarate)₂(1,2-di(pyridine-4-yl)-ethene)]

Glutaric acid (198.0 mg, 1.5 mmol) was dissolved in 10 mL of water in a glass bottle. The solution was heated to 70° C. on a hot plate while stirring. NaOH (120 mg, 3 mmol) was dissolved in 5 mL of water and was slowly added to the hot solution of glutaric acid. Cu(NO₃)₂.3H₂O (241.6 mg, 1 mmol) was dissolved in 5 mL of water and added to the hot reaction mixture. A light blue precipitate was formed. After letting the reaction to stir for 10 min, 1,2-di(pyridine-4-yl)-ethene (91.1 mg, 0.5 mmol) was added to the reaction mixture. The precipitate turned to a rich green colour. The reaction mixture was left stirring for 24 h at 80° C. After cooling, the precipitate was filtered, washed with water and oven-dried at 85° C. This material may also be known as AMK-059.

The composition of the material was confirmed by PXRD.

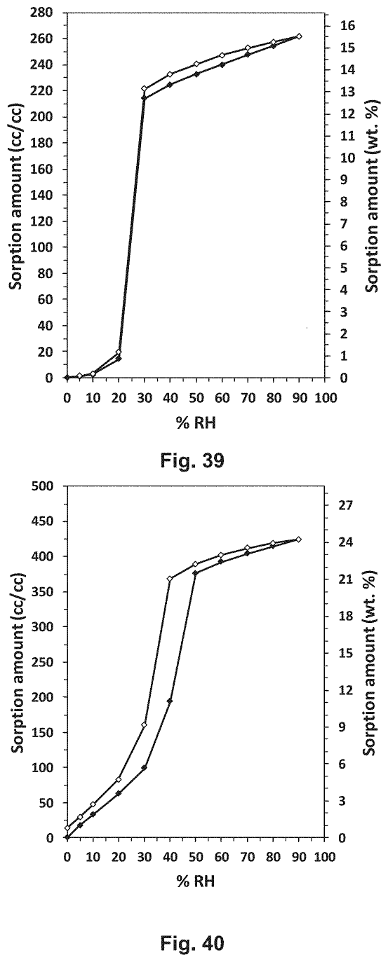

The vapour sorption isotherm for this material is shown in FIG. 39.

### EXAMPLE 16: SYNTHESIS OF [Zr₁₂O₈(μ₃-OH)₈(μ₂-OH)₆(benzene-1,4-dicarboxylate)₉]

In a Teflon lined steel autoclave (23 mL), ZrOCl₂8H₂O (97 mg, 0.3 mmol), H₂O (2 mL) and acetic acid (3 mL) were added and formation of clear solution was observed. Terephthalic acid (50 mg, 0.3 mmol) was added to the reaction mixture. The reaction mixture was heated at 150° C. for 1 day. After cooling, the white precipitate was filtered off and washed with H₂O (yield 90mg), soaked once with 9 mL DMF and soaked three times with H₂O. The solid was then dried in air at ambient conditions.

The composition of the material was confirmed by PXRD.

The vapour sorption isotherm for this material is shown in FIG. 40.

### EXAMPLE 17: LOADING OF [Cu₂(glutarate)₂(4,4′-bipyridine)] (ROS-037) ON A POLYMER SUPPORT

In a beaker, binder (Acrylic Polymer: HYCAR® 26410 from Lubrizol) was taken and water was added, stirred for 5 minutes. Isopropanol was added and the mixture stirred for a further 5 more and, while stirring continuously, [Cu₂(glutarate)₂(4,4′-bipyridine)] in powder form was added slowly to the solution. The stir bar was removed and blended for 1 minute using a hand blender with short bursts at high speed. Approximately 2 mL of slurry was taken from the beaker by using a dropper and drop casted onto a Teflon petridish before being placed in an oven for 1 hour at 120° C. and transferred to desiccator. The resulting thin film type was tested for its water sorption properties.

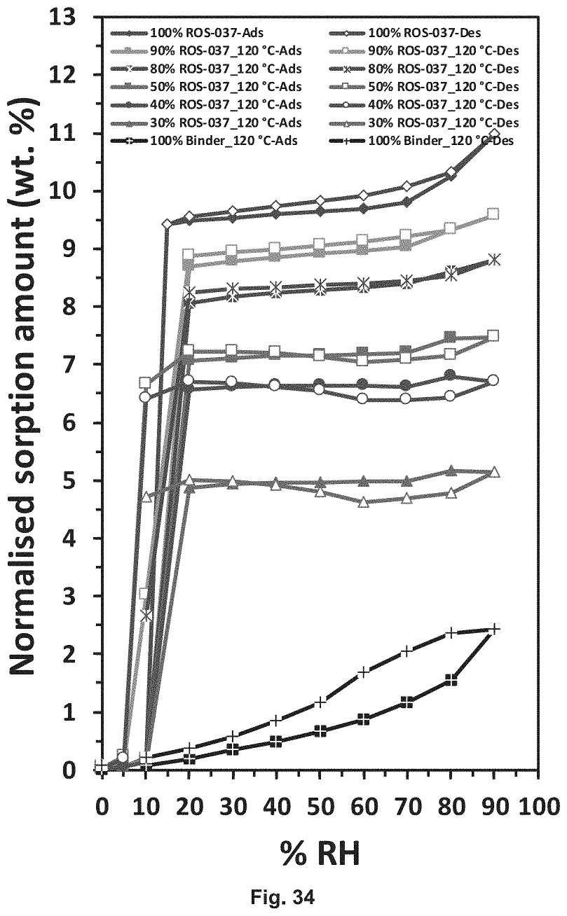

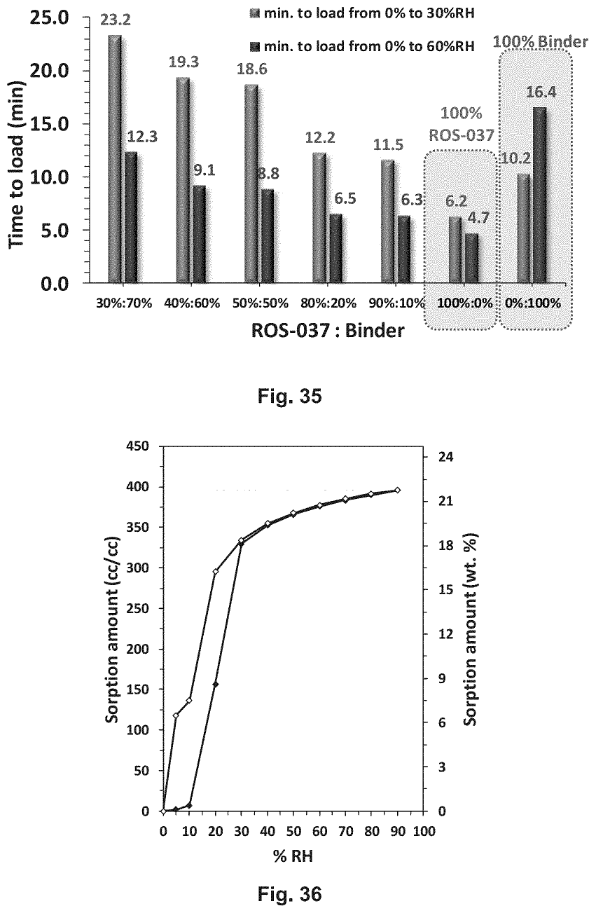

Films were prepared comprising 0, 30, 40, 50, 80, 90 and 100% ROS-037. Adsorption and desorption isotherms were measured at 27° C. and these are shown in FIG. 34. The top curve is for the composition comprising 100% ROS-037 and the bottom one is for the composition comprising 100% binder.

FIG. 35 shows the kinetics of adsorption.

These results show that the greater the amount of [Cu₂(glutarate)₂(4,4′-bipyridine)] present in the composite, the faster the kinetics of adsorption and the higher the water uptake.

### EXAMPLE 18: LOADING OF [Cu₂(glutarate)₂(4,4′-bipyridine)] (ROS-037) ON A PAPER SUPPORT

[Cu₂(glutarate)₂(4,4′-bipyridine)] powder was added in a standard cellulose paper making process that anyone skilled in the art could perform. Cellulose fiber was first dispersed in water at approximately 3-5% solids. [Cu₂(glutarate)₂(4,4′-bipyridine)] powder was added to the fiber mixture and agitated in order to disperse. The blend was then diluted to very low solids content (1% or less) to provide an attraction between the fibers and the desiccant powder. The evenly dispersed mixture was drained through a screen. The remaining water was removed from the wet sheet of fibers/powder through vacuum, pressing, and drying. Good adsorption and desorption properties were recorded for the resulting material.

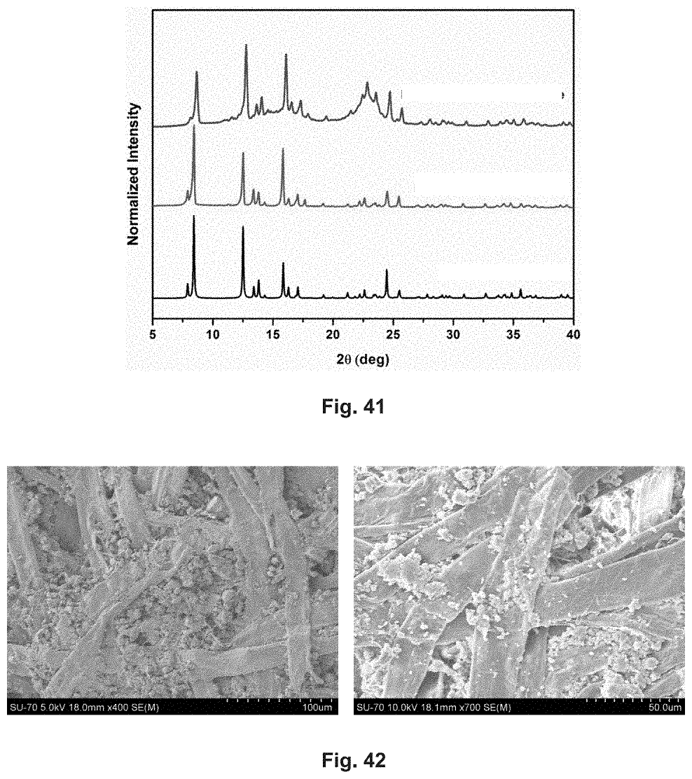

FIG. 41 shows the Powder X-ray diffraction spectrum of the paper composite (top line) in comparison with as synthesized powder (middle line) and calculated powder (bottom line).

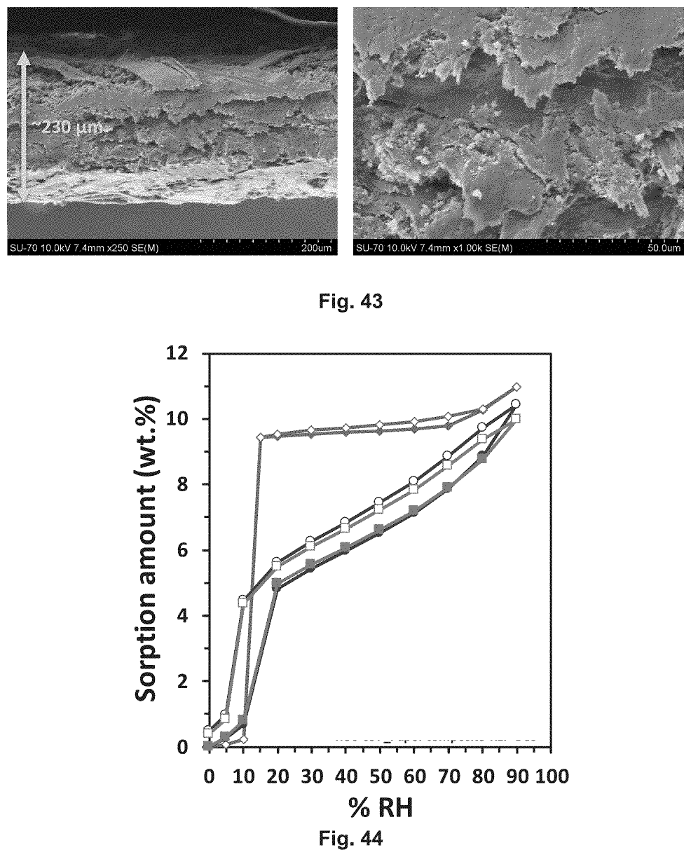

FIGS. 42 and 43 show respectively flat section and cross section SEM images of the paper composite.

FIG. 44 shows experimental isotherms for water vapour sorption at 27° C. on [Cu₂(glutarate)₂(4,4′-bipyridine)] powder and its paper composite, respectively from the top down. In-situ pre-treatment (intrinsic-DVS) before collecting isotherm at 40° C. for 120 min. Isotherm collected at 27° C. (Intrinsic-DVS). dm/dt<0.01%/min.

### EXAMPLE 19: DESALINATION TESTING USING [Cu₂(glutarate)₂(4,4′-bipyridine)]

[Cu₂(glutarate)₂(4,4′-bipyridine)] samples were placed in an oven for 12 h at 80° C. Afterwards, the container was sealed and kept under nitrogen flow for 2 h. Adsorbent-solution (solution of 30 mL of saline (NaCl) aqueous solution in a concentration range from 0.0 to 111.1 g/L exposed to 1 g/L, 50 g/L or 500 g/L of adsorbent) were studied at 25° C. Suspensions were stirred using a magnetic stirrer for 8 h. The resulting slurry was filtered with a syringe filter (0.22 pm pore size) and the residual saline solution was collected. NaCl concentration in all aqueous solution (before and after soaking [Cu₂(glutarate)₂(4,4′-bipyridine)] at different concentrations) was analysed by using a conductivity meter (model: JENWAY 4510). Measurements were performed three times and the mean was calculated. The concentration of NaCl (g/L) was determined by correlating the conductivity (mS) and a [NaCl] calibration curve. The results indicate that [Cu₂(glutarate)₂(4,4′-bipyridine)] increased NaCl concentration by the expected amount in every experiment.

### Characterisation Examples

The porous metal-organic framework materials useful in the present invention have a number of common characteristics and the properties of these materials were tested according to the following methods.

The properties of the porous metal-organic framework materials of the invention were also compared to silica and mesoporous silica. These materials are the current commercially available materials which can be used in the same applications as the inventive materials.

Metal-organic materials useful in the present invention preferably satisfy the following criteria:

1. Favourable kinetics of adsorption: materials that reach greater than 80% of full loading in less than 10 minutes at 27° C. and 30% RH can be used.

2. Water sorption capacity: materials that offer a water sorption capacity of cm³ water vapour/cm³ material under ambient conditions of temperature and humidity (27° C., 1 atm) as determined by vacuum, temperature, humidity or temperature/humidity swing tests can be used.
2.1. Vacuum swing tests were conducted using materials that were first fully loaded with water at 97% RH and ambient pressure and subjected to 3 torr of vacuum for 15 minutes.
2.2. Temperature swing tests were conducted by first loading materials at 27° C. and 30% RH for 14 minutes followed by heating at 60° C. for 15 minutes.
2.3. Humidity swing tests were conducted by first loading activated sorbents at 30% RH at 27° C. for 14 minutes followed by exposure to a 0% humidity dry gas stream for 40 minutes.
2.4. Temperature and humidity swing tests that simulate direct air water capture (DAWC) in desert conditions were conducted through 17 adsorption/desorption cycles which involved loading the sorbent at 30% RH at 25° C. for 14 minutes and unloading the sorbent by heating at 49° C. for 20 minutes.

3. Thermodynamics of desorption tests were conducted by first loading the porous material at ambient conditions and ˜30-40% RH. Sorbents that offer a desorption temperature <75° C. (determined by the position of the water desorption endotherm minimum when collected using differential scanning calorimetry (DSC)), and a heat of desorption <50 kJ/mol (as measured by combining thermogravimetric analysis (TGA), DSC and intrinsic Dynamic Vapour Sorption isotherm (DVS) measurements) are preferred.

### EXAMPLE 20: SORPTION KINETICS TESTING

Intrinsic dynamic vapour sorption measurements were carried out on a number of materials at 27° C. and 30% relative humidity. The level of uptake capacity achieved after 10 minutes is shown in Table 1:

TABLE 1
Uptake Capacity

| Metal-organic material | % Water loading after 10 minutes |
|---|---|
| ROS-037 (Example 8) | 99.9 |
| ROS-037 Paper Composite (Example 18) | 82.4 |
| Silica Gel | 74.6 |

### EXAMPLE 21: WORKING CAPACITY

The working capacity is the difference in water vapour uptake between conditions of adsorption and desorption.

Adsorption/desorption was induced in various materials under conditions of a vacuum swing, a temperature swing or a humidity swing (see 2.1, 2.2 and 2.3 above for conditions). The results are shown in Tables 2, 3 and 4.

Following the procedure of section 2.1, a 3 torr vacuum was used and the working capacity was recorded after 15 minutes, as shown below in Table 2:

TABLE 2
Vacuum Swing Testing

| | Working capacity |
|---|---|
| Metal-organic material | (cm³ water vapour/cm³ material) |
| sql-2-Cu-BF₄ (Example 1) | 306.8 |
| AMK-059 (Example 15) | 200.8 |
| ROS-037 (Example 8) | 150.8 |
| Mesoporous Silica | 39.9 |
| Silica Gel | 36.4 |

Following the procedure of section 2.2, the working capacity was recorded after 15 minutes, as shown below in Table 3:

TABLE 3
Temperature Swing Testing

| | Working capacity |
|---|---|
| Metal-organic material | (cm³ water vapour/cm³ material) |
| Co-CUK-1 (Example 14) | 204.0 |
| ROS-037 (Example 8) | 174.0 |
| Mg-CUK-1 (Example 13) | 135.1 |
| hcp-UiO-66 (Example 16) | 123.6 |
| [Co₃(μ₃-OH)₂(btca)₂] (Example 12) | 133.9 |
| sql-2-Cu-BF₄ (Example 1) | 139.9 |
| Silica Gel | 27.8 |
| Mesoporous Silica | 2.5 |

Following the procedure of section 2.3, the working capacity was recorded after 40 minutes, as shown below in Table 4:

TABLE 4
Humidity Swing Testing

| | Working capacity |
|---|---|
| Metal-organic material | (cm³ water vapour/cm³ material) |
| Co-CUK-1 (Example 14) | 202.9 |
| ROS-037 (Example 8) | 185.3 |
| Mg-CUK-1 (Example 13) | 131.5 |
| hcp-UiO-66 (Example 16) | 102.4 |
| [Co₃(μ₃-OH)₂(btca)₂] (Example 12) | 121.1 |
| sql-2-Cu-BF₄ (Example 1) | 139.2 |
| Silica Gel | 21.0 |
| Mesoporous Silica | 3.6 |

### EXAMPLE 22: THERMODYNAMICS OF DESORPTION

As mentioned above, heat of desorption was calculated by combining measurements taken by thermogravimetric analysis, differential scanning calorimetry and intrinsic dynamic vapour sorption isotherm measurements. The results are shown in Table 5 below:

TABLE 5
Heat of Desorption

| Metal-organic material | Heat of desorption (kJ/mol) |
|---|---|
| ROS-037 | 43.3 |
| Mg-CUK-1 | 51.7 |
| Silica Gel | 59.4 |
| Syloid AL-1 | 76.1 |
| Zeolite 13X | 203.8 |

1.-43. (canceled)

44. A method of capturing water from a gaseous composition, the method comprising:
providing a metal-organic material configured to capture water from the gaseous composition;
contacting the metal-organic material with the gaseous composition;
wherein the gaseous composition comprises one or more of water or water vapor; and
wherein the metal-organic material adsorbs water from the gaseous composition.

45. The method of claim 44, further comprising storing the metal-organic material after the metal-organic material adsorbs water from the gaseous composition.

46. The method of claim 45, further comprising applying a stimulus to the metal-organic material at a time after storage to effect desorption of water retained therein.

47. The method of claim 46, further comprising collecting desorbed water.

48. The method of claim 44, wherein the metal-organic material comprises metal species and one or more ligands.

49. The method of claim 48, wherein the metal species is selected from copper, cobalt, nickel, iron, zinc, cadmium, zirconium, magnesium, calcium and aluminium.

50. The method of claim 48, wherein the one or more ligands are selected from bidentate nitrogen ligands, nitrogen-carboxylate ligands and polycarboxylate ligands.

51. The method of claim 50, wherein the one or more ligands are selected from 4,4′ -bipyridine (L1), 1,4-bis(4-pyridyl)benzene (L2), 4,4′ -(2,5 -dimethyl-1,4-phenylene)dipyridine (L3), 1,4-bis(4-pyridyl)biphenyl (L4), 1,2-di(pyridine-4-yl)-ethene (L5), benzotriazole-5-carboxylic acid (L128), 2,4-pyridinedicarboxylic acid (L80), glutaric acid (L141), and benzene-1,4-dicarboxylic acid (L156).

52. A metal organic material comprising:
a metal species; and
one or more ligands;
wherein the metal organic material is configured to capture water from a gaseous composition comprising one or more of water vapour or water.

53. The metal organic material of claim 52, wherein the metal species is selected from copper, cobalt, nickel, iron, zinc, cadmium, zirconium, magnesium, calcium and aluminium.

54. The metal organic material of claim 53, wherein the one or more ligands are selected from bidentate nitrogen ligands, nitrogen-carboxylate ligands and polycarboxylate ligands.

55. The metal organic material of claim 54, wherein the one or more ligands are selected from 4,4′-bipyridine (L1), 1,4-bis(4-pyridyl)benzene (L2), 4,4′-(2,5-dimethyl-1,4-phenylene)dipyridine (L3), 1,4-bis(4-pyridyl)biphenyl (L4), 1,2-di(pyridine-4-yl)-ethene (L5), benzotriazole-5-carboxylic acid (L128), 2,4-pyridinedicarboxylic acid (L80), glutaric acid (L141), and benzene-1,4-dicarboxylic acid (L156).

56. The metal organic material of claim 53, wherein the metal-organic material further comprises one or more anions.

57. The metal organic material of claim 56, wherein the one or more anions are selected from BF₄⁻, NO₃⁻, CF₃SO₃^{'} and glutarate.

58. The metal organic material of claim 52, wherein the metal organic material is configured to switch from a first state to a second state when a threshold humidity is reached.

59. The metal organic material of claim 52, wherein the metal-organic material is a porous metal-organic framework material comprising pores having a hydrophobic pore window and a hydrophilic internal pore surface.

60. The metal organic material of claim 59, wherein the porous metal-organic framework material is a microporous material.

61. The metal organic material of claim 59, wherein the porous metal-organic framework material is selected from [Cu₂(glutarate)₂(4,4′-bipyridine)], [Cu₂(glutarate)₂(1,2-di(pyridine-4-yl)-ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)_{2]} and [Zr₁₂O₈(μ₃-OH)₈(μ₂-OH)₆(benzene-1,4-dicarboxylate)₉].

62. The metal organic material of claim 52, wherein the metal-organic material is a two-dimensional layered material.

63. A device comprising the metal organic material of claim 52.
